(19) United States
(12) Patent Application Publication
(10) Pub. No.: US 2020/0182335 A1
(43) Pub. Date: Jun. 11, 2020

(54) CVT CONES THAT USE COMMERCIALLY AVAILABLE TRANSMISSION BELTS

(71) Applicant: Armin Sebastian Tay, Rowland Heights, CA (US)

(72) Inventor: Armin Sebastian Tay, Rowland Heights, CA (US)

(21) Appl. No.: 16/706,769

(22) Filed: Dec. 8, 2019

Related U.S. Application Data
(63) Continuation-in-part of application No. 16/618,789.
(60) Provisional application No. 62/777,764, filed on Dec. 11, 2018.
(60) Provisional application No. 62/824,335, filed on Mar. 27, 2019.
(60) Provisional application No. 62/824,519, filed on Mar. 27, 2019.
(60) Provisional application No. 62/859,728, filed on Jun. 11, 2019.
(60) Provisional application No. 62/887,173, filed on Aug. 15, 2019.
(60) Provisional application No. 62/891,658, filed on Aug. 26, 2019.
(60) Provisional application No. 62/906,363, filed on Sep. 26, 2019.
(60) Provisional application No. 62/928,358, filed on Oct. 31, 2019.
(60) Provisional application No. 62/929,124, filed on Nov. 1, 2019.
(60) Provisional application No. 62/929,860, filed on Nov. 2, 2019.
(60) Provisional application No. 62/933,343, filed on Nov. 8, 2019.
(60) Provisional application No. 62/938,262, filed on Nov. 20, 2019.

(51) Int. Cl. F16H 9/08; F16H 9/24

(52) U.S. Cl. CPC F16H 9/08; F16H 55/54; F16H 9/24

(57) ABSTRACT

A “Cone with One Torque Transmitting Member and One Non-Torque Transmitting Member” for CVT's that can be used with a commercially available Transmission Belt, which is Transmission Belt for which the teeth of said Transmission Belt are shaped below the belt of said Transmission Belt. In order to provide a Level Resting Place for its Transmission Belt on the conical (sloped) surfaces of its Cone, which are surfaces that are not covered by its Torque Transmitting Member or its Non-Torque Transmitting Member, its Torque Transmitting Member and its Non-Torque Transmitting Member each have a Leveling Extension. The Leveling Extension of its Torque Transmitting Member can enter and exit its Non-Torque Transmitting Member as required; and the Leveling Extension of its Non-Torque Transmitting Member can enter and exit its Torque Transmitting Member as required.

### CROSS-REFERENCE TO RELATED APPLICATIONS

This invention is a Continuation-in-part (CIP) of U.S. patent application Ser. No. 16/618,789, which was filed on 2 Dec. 2019; in addition, this invention is entitled to the benefits of:
Provisional Patent Application (PPA) Ser. No. 62/777,764 filed on 11 Dec. 2018
Provisional Patent Application (PPA) Ser. No. 62/824,335 filed on 27 Mar. 2019
Provisional Patent Application (PPA) Ser. No. 62/824,519 filed on 27 Mar. 2019
Provisional Patent Application (PPA) Ser. No. 62/859,728 filed on 11 Jun. 2019
Provisional Patent Application (PPA) Ser. No. 62/887,173 filed on 15 Aug. 2019
Provisional Patent Application (PPA) Ser. No. 62/891,658 filed on 26 Aug. 2019
Provisional Patent Application (PPA) Ser. No. 62/906,363 filed on 26 Sep. 2019
Provisional Patent Application (PPA) Ser. No. 62/928,358 filed on 31 Oct. 2019
Provisional Patent Application (PPA) Ser. No. 62/929,124 filed on 1 Nov. 2019
Provisional Patent Application (PPA) Ser. No. 62/929,860 filed on 2 Nov. 2019
Provisional Patent Application (PPA) Ser. No. 62/933,343 filed on 8 Nov. 2019
Provisional Patent Application (PPA) Ser. No. 62/938,262 filed on 20 Nov. 2019

### BACKGROUNG—FIELD OF INVENTION

This invention relates to torque/speed transmissions, specifically to improvements for a Cone Assembly that can be used to construct Continuously Variable Transmissions (CVT's).

### BACKGROUNG—DESCRIPTION OF PRIOR ART

The inventions of this disclosure are primarily for a “cone with one torque transmitting member” described in U.S. Pat. No. 8,628,439.

A “cone with one torque transmitting member” of U.S. Pat. No. 8,628,439 (which is referred to as a front pin belt cone assembly 520A) is described in column 90 line 64 to column 99 line 11; and shown in FIGS. 91A, 91B, 92A, 92B, 93 to 101 of the Published Patent.

A “cone with one torque transmitting member” is basically a cone that has a “torque transmitting member” that is rotatably fixed relative to the surface of its cone, but can slide axially relative to the surface of its cone. The “torque transmitting member” is used for torque transmission and can be made toothed. Preferably (although not absolutely necessary), a “cone with one torque transmitting member” also has a “non-torque transmitting member”, which is primarily used to maintain the alignment of the transmission belt of its cone and balance-out the centrifugal forces of the “torque transmitting member”. For the cone with one torque transmitting member of U.S. Pat. No. 8,628,439, which is referenced in the previous paragraph, the a “torque transmitting member” is labeled as “pin belt torque transmitting member 590” and the “non-torque transmitting member” is labeled as “pin belt non-torque transmitting member 690”.

An example of CVT that is constructed of out of two “cone with one torque transmitting member”, which are labeled as Cone 1A and Cone 1B, is shown in FIGS. 1 to 4. This CVT comprises of Cone 1A mounted on one spline that is coupled by a Transmission Belt 2 (which can be replaced with a chain in an alternate configuration) to a Cone 1B mounted on another spline. A Tensioning Pulley 3, positioned on the slack side of Transmission Belt 2, is used to maintain proper tension in Transmission Belt 2 as the axial position of the cones are changed independent of each other. And a Support Pulley 4 is used to ensure that for each cone at least a portion of its torque transmitting member is engaged with Transmission Belt 2 for torque transmission at all times.

Cones 1A and 1B are each a “cone with one torque transmitting member”. Cone 1A has a Torque Transmitting Member 1A-M1, Non-Torque Transmitting Member 1A-M2, and a Leveling Loop 1A-M3. Cone 1B has a Torque Transmitting Member 1B-M1, Non-torque Transmitting Member 1B-M2, and a Leveling Loop 1B-M3. Torque transmitting members 1A-M1 and 1B-M1 have teeth so that toothed torque transmission can be used, although friction torque transmitting members can also be used.

A leveling loop, such as Leveling Loop 1A-M3 and Leveling Loop 1B-M3, is a flexible loop with a tapered bottom surface that provides a level top resting surface for a transmission belt. It is recommended that each leveling loop is made out of a low friction flexible material that can expand and contract accordingly with the expansion and contraction of its cone; otherwise the CVT needs to be configured so that the leveling loops do not get in the way as the transmission ratio of their CVT is changed.

Tensioning Pulley 3 acts as a support pulley and tensioning pulley. Tensioning Pulley 3 and Support Pulley 4 are mounted so that they can freely move sideways in the horizontal direction. And Tensioning Pulley 3 is pushed upwards in the vertical direction so that it can maintain proper tension in Transmission Belt 2 for all operating conditions of the CVT.

### Listing of Prior Arts

U.S. Pat. No.: 7,713,153; Issue Date: 11 May 2010; Patentee: Naude.
U.S. Pat. No. 6,656,070; Issue Date: 2 Dec. 2003; Patentee: Tay.
U.S. Pat. No. 7,722,490; Issue Date: 25 May 2010; Patentee: Tay.
U.S. Pat. No. 8,628,439; Issue Date: 14 Jan. 2014; Patentee: Tay.
U.S. Pat. No. 9,651,123; Issue Date: 16 May 2017; Patentee: Tay.
U.S. Pat. No. 9,958,064; Issue Date: 1 May 2018; Patentee: Tay.
U.S. Pat. No. 9,964,209; Issue Date: 8 May 2018; Patentee: Tay.
European Patent EP2764279; Issue Date: 17 Jan. 2018; Patentee: Tay.
European Patent EP1311777; Issue Date: 6 Oct. 2010; Patentee: Tay.
U.S. patent application Ser. No. 15/965,948 (Pub. # US 2018/0335107 A1); Filing Date: 29 Apr. 2018; Applicant: Tay.

### BRIEF SUMMARY OF THE INVENTION

In this disclosure, Cones, Cone Assemblies, Torque Transmitting Members, and Non-Torque Transmitting Members for “slightly modified commercially available” and “commercially available” Transmission Belts are described. Using a commercially available Transmission Belt instead of a custom Transmission Belt can significantly increase performance and reduce cost.

The Torque Transmitting Members and Non-Torque Transmitting Members described in the prior art (such as in U.S. Pat. No. 8,628,439) use a custom designed Transmission Belt in order to allow for the usage a Leveling Loop, which allows for a Level Resting Place for its Transmission Belt on the conical (sloped) surface of its cone.

The Torque Transmitting Members and Non-Torque Transmitting Members of prior art do not allow for the usage of a commercially available Transmission Belt, which is a Transmission Belt for which the teeth of said Transmission Belt are shaped below the belt of said Transmission Belt.

For the Torque Transmitting Members and Non-Torque Transmitting Members of prior art, a Leveling Loop has to be positioned beneath the bottom surface of its Transmission Belt in order to provide a Level Resting Place for its Transmission Belt.

A Leveling Loop of fixed length has to be able sit on the surface of its Cone on sections of its Cone where it needs to provide a Level Resting Place, and expand-out from the surface of its Cone as needed on sections of its Cone where it does not need to provide a Level Resting Place.

The Torque Transmitting Members of prior art allow for the usage of a Leveling Loop of fixed length; since their teeth, which are positioned on its side surfaces, will not prevent a Leveling Loop from expanding-out from the surface of its Cone. The teeth of the Torque Transmitting Member for a commercially available Transmission Belt will prevent a Leveling Loop from expanding-out from the surface of its cone. Also, a Leveling Loop that stretches as needed as the Transmission Diameter of its Cone is changed is undesirable, since this Leveling Loop will have a very small lateral stiffness, which is required in order to maintain the axial alignment and straightness of the Leveling Loop.

For a Torque Transmitting Member for a commercially available Transmission Belt, in order to provide a Level Resting Place for its Transmission Belt on the conical (sloped) surfaces of its Cone, which are surfaces that are not covered by its Torque Transmitting Member or its Non-Torque Transmitting Member, its Torque Transmitting Member and its Non-Torque Transmitting Member each have a Leveling Extension. The Leveling Extension of its Torque Transmitting Member can enter and exit its Non-Torque Transmitting Member as required; and the Leveling Extension of its Non-Torque Transmitting Member can enter and exit its Torque Transmitting Member as required.

### BRIEF DESCRIPTION OF THE SEVERAL VIEWS OF THE DRAWING

FIG. 1 shows a front-view of a CVT that is constructed of out of two “cone with one torque transmitting member”.

FIG. 2 shows a partial top-view of a CVT that is constructed of out of two “cone with one torque transmitting member”.

FIG. 3 shows another front-view of a CVT that is constructed of out of two “cone with one torque transmitting member”.

FIG. 4 shows another partial top-view of a CVT that is constructed of out of two “cone with one torque transmitting member”.

FIG. 5 shows a side-view of Joiner Plate 5.

FIG. 6 shows a top-view of Joiner Plate 5.

FIG. 7 shows a side-view of Alternate Joiner Plate 5A.

FIG. 8 shows a top-view of Alternate Joiner Plate 5A.

FIG. 9 shows a top-view of Alternate Joiner Plate 5A for which its Pin 5A-M1 has been removed.

FIG. 10 shows a top-view of Pin 5A-M1.

FIG. 11 shows a rear-view of Link 6A.

FIG. 12 shows a side-view of Link 6A.

FIG. 13 shows a top-view of Link 6A.

FIG. 14 shows a rear-view of Link 6B.

FIG. 15 shows a side-view of Link 6B.

FIG. 16 shows a top-view of Link 6B.

FIG. 17 shows a rear-view of Leading End Torque Transmitting Chain Member 7.

FIG. 18 shows a side-view of Leading End Torque Transmitting Chain Member 7.

FIG. 19 shows a top-view of Leading End Torque Transmitting Chain Member 7.

FIG. 20 shows a rear-view of Trailing End Link 8.

FIG. 21 shows a side-view of Trailing End Link 8.

FIG. 22 shows a top-view of Trailing End Link 8.

FIG. 23 shows a rear-view of Trailing End Joiner Plate 5B.

FIG. 24 shows a side-view of Trailing End Joiner Plate 5B.

FIG. 25 shows a top-view of Trailing End Joiner Plate 5B.

FIG. 26 shows a side-view of Torque Transmitting Chain Member 9.

FIG. 27 shows a top-view of Torque Transmitting Chain Member 9.

FIG. 28 shows a side-view of Torque Transmitting Chain Member 11.

FIG. 29 shows a top-view of Torque Transmitting Chain Member 11.

FIG. 30 shows a rear-view of Link 12A.

FIG. 31 shows a side-view of Link 12A.

FIG. 32 shows a top-view of Link 12A.

FIG. 33 shows a rear-view of Link 12B.

FIG. 34 shows a side-view of Link 12B.

FIG. 35 shows a top-view of Link 12B.

FIG. 36 shows a side-view of Link 12C.

FIG. 37 shows a top-view of Link 12C.

FIG. 38 shows a rear-view of Leading End Non-Torque Transmitting Chain Member 13.

FIG. 39 shows a side-view of Leading End Non-Torque Transmitting Chain Member 13.

FIG. 40 shows a top-view of Leading End Non-Torque Transmitting Chain Member 13.

FIG. 41 shows a rear-view of Trailing End Link 14.

FIG. 42 shows a side-view of Trailing End Link 14.

FIG. 43 shows a top-view of Trailing End Link 14.

FIG. 44 shows a side-view of Non-Torque Transmitting Chain Member 15.

FIG. 45 shows a top-view of Non-Torque Transmitting Chain Member 15.

FIG. 46 shows a side-view of Non-Torque Transmitting Chain Member 16.

FIG. 47 shows a top-view of Non-Torque Transmitting Chain Member 16.

FIG. 48 shows a side-view of Leveling Loop 16.

FIG. 49 shows a sectional-view of Leveling Loop 16 as cut per FIG. 48.

FIG. 50 shows another sectional-view of Leveling Loop 16 as cut per FIG. 48.

FIG. 51 shows a side-view of a section of Leveling Loop 16 that is positioned between a section of Torque Transmitting Chain Member 9.

FIG. 52 shows a sectional-view of Leveling Loop 16 that is positioned between Torque Transmitting Chain Member 9 as cut per FIG. 51.

FIG. 53 shows another sectional-view of Leveling Loop 16 that is positioned between Torque Transmitting Chain Member 9 as cut per FIG. 51.

FIG. 54 shows a side-view of Leveling Loop 16A.

FIG. 55 shows a sectional-view of Leveling Loop 16A as cut per FIG. 54.

FIG. 56 shows another sectional-view of Leveling Loop 16A as cut per FIG. 54.

FIG. 57 shows the cross-section of Leveling Loop 16A of FIG. 56 on which a Chain Section (which is not labeled and not hatched) rests.

FIG. 58 shows a side-view of Transmission Belt 17.

FIG. 59 shows a front-view of Transmission Belt 17.

FIG. 60 shows a rear-view of Reinforcement Plate 18.

FIG. 61 shows a side-view of Reinforcement Plate 18.

FIG. 62 shows a top-view of Reinforcement Plate 18.

FIG. 63 shows a rear-view of Leading End Reinforcement Plate 18A.

FIG. 64 shows a side-view of Leading End Reinforcement Plate 18A.

FIG. 65 shows a top-view of Leading End Reinforcement Plate 18A.

FIG. 66 shows a rear-view of Trailing Sleeve Reinforcement Plate 18B.

FIG. 67 shows a side-view of Trailing Sleeve Reinforcement Plate 18B.

FIG. 68 shows a top-view of Trailing Sleeve Reinforcement Plate 18B.

FIG. 69 shows a rear-view of Trailing Sleeve Reinforcement Plate 18D.

FIG. 70 shows a side-view of Trailing Sleeve Reinforcement Plate 18D.

FIG. 71 shows a top-view of Trailing Sleeve Reinforcement Plate 18D.

FIG. 72 shows a rear-view of Trailing Sleeve Reinforcement Plate 18E.

FIG. 73 shows a side-view of Trailing Sleeve Reinforcement Plate 18E.

FIG. 74 shows a top-view of Trailing Sleeve Reinforcement Plate 18E.

FIG. 75 shows a rear-view of Trailing End Reinforcement Plate 18C.

FIG. 76 shows a side-view of Trailing End Reinforcement Plate 18C.

FIG. 77 shows a top-view of Trailing End Reinforcement Plate 18C.

FIG. 78 shows a side-view of Torque Transmitting Member 19.

FIG. 79 shows a top-view of Torque Transmitting Member 19.

FIG. 80 shows a sectional-view of Torque Transmitting Member Section 19-M1.

FIG. 81 shows a partial sectional-view of Torque Transmitting Member Section 19-M1.

FIG. 82 shows another sectional-view of Torque Transmitting Member Section 19-M1.

FIG. 83 shows a rear-view of Leveling Extension 19-M2.

FIG. 84 shows a rear-view of Reinforcement Plate 21-M1 and a Reinforcement Plate 21-M2.

FIG. 85 shows a side-view of Reinforcement Plate 21-M1.

FIG. 86 shows a side-view of Reinforcement Plate 21-M2.

FIG. 87 shows a top-view of Reinforcement Plate 21-M1 and a Reinforcement Plate 21-M2.

FIG. 88 shows a rear-view of Leading End Reinforcement Plate 21A.

FIG. 89 shows a side-view of Leading End Reinforcement Plate 21A.

FIG. 90 shows a top-view of Leading End Reinforcement Plate 21A.

FIG. 91 shows a rear-view of Trailing Sleeve Reinforcement Plate 21B.

FIG. 92 shows a side-view of Trailing Sleeve Reinforcement Plate 21B.

FIG. 93 shows a top-view of Trailing Sleeve Reinforcement Plate 21B.

FIG. 94 shows a rear-view of Trailing End Reinforcement Plate 21C.

FIG. 95 shows a side-view of Trailing End Reinforcement Plate 21C.

FIG. 96 shows a top-view of Trailing End Reinforcement Plate 21C.

FIG. 97 shows a side-view of Non-Torque Transmitting Member 22.

FIG. 98 shows a top-view of Non-Torque Transmitting Member 22.

FIG. 99 shows a sectional-view of Non-Torque Transmitting Member Section 22-M1.

FIG. 100 shows another sectional-view of Non-Torque Transmitting Member Section 22-M1

FIG. 101 shows another sectional-view of Non-Torque Transmitting Member Section 22-M1

FIG. 102 shows a rear-view of Leveling Extension 22-M2.

FIG. 103 shows the sectional-view of FIG. 100 with the Leveling Extension of its Torque Transmitting Member (which is labeled as Leveling Extension 19-M2) and its Transmission Belt 17.

FIG. 104 shows the sectional-view of FIG. 101 with its Transmission Belt 17.

FIG. 105 shows a side-view of a Cone 24.

FIG. 106 shows a front-view of a Cone 24.

FIG. 107 shows a rear-view of Reinforcement Plate 25.

FIG. 108 shows a side-view of Reinforcement Plate 25.

FIG. 109 shows a top-view of Reinforcement Plate 25.

FIG. 110 shows a side-view Transmission Belt 26.

FIG. 111 shows a front-view Transmission Belt 26.

FIG. 112 shows a rear-view of Leading End Reinforcement Plate 25A.

FIG. 113 shows a rear-view of Trailing Sleeve Reinforcement Plate 25B.

FIG. 114 shows a rear-view of Trailing End Reinforcement Plate 25C.

FIG. 115 shows a rear-view of a Trailing Sleeve Reinforcement Plate 25B that is attached to its Cone 27 using a Dome Shaped Nut 28 and Locking Ring 29.

FIG. 116 shows a rear-view of a Trailing End Reinforcement Plate 25C that is attached to its Cone 27 using a Dome Shaped Nut 28 and Locking Ring 29.

FIG. 117 shows a side-view of Torque Transmitting Member 31.

FIG. 118 shows a top-view of Torque Transmitting Member 31.

FIG. 119 shows a sectional-view of Torque Transmitting Member 31.

FIG. 120 shows another sectional-view of Torque Transmitting Member 31.

FIG. 121 shows another sectional-view of Torque Transmitting Member 31.

FIG. 122 shows a rear-view of a Reinforcement Plate that has an Alignment Pin 33.

FIG. 123 shows a rear-view of Reinforcement Plate 34.

FIG. 124 shows a side-view of Reinforcement Plate 34.

FIG. 125 shows a top-view of Reinforcement Plate 34.

FIG. 126 shows a rear-view of Leading End Reinforcement Plate 34A.

FIG. 127 shows a rear-view of Trailing Sleeve Reinforcement Plate 34B.

FIG. 128 shows a rear-view of Trailing End Reinforcement Plate 34C.

FIG. 129 shows a side-view of Non-Torque Transmitting Member 35.

FIG. 130 shows a top-view of Non-Torque Transmitting Member 35.

FIG. 131 shows a sectional-view of Non-Torque Transmitting Member 35.

FIG. 132 shows another sectional-view of Non-Torque Transmitting Member 35.

FIG. 133 shows another sectional-view of Non-Torque Transmitting Member 35.

FIG. 134 shows a rear-view of Elastomers Insert 37.

FIG. 135 shows a side-view of Elastomers Insert 37.

FIG. 136 shows a side-view of two Reinforcement Plates 25, for which an Elastomers Insert 37 is placed between them.

FIG. 137 shows a sectional-view of FIG. 136.

FIG. 138 shows a side-view of Elastomers Insert 37A.

FIG. 139 shows a top-view of Elastomers Insert 37A.

FIG. 140 shows a top-view of two Left Reinforcement Wires Holes Plate 25-S1A, for which an Elastomers Insert 37A is placed between them.

FIG. 141 shows a side-view of a Cone 38, which uses two oppositely positioned Leveling Extension Raising Sheets 39.

FIG. 142 shows a front-view of a Cone 42, which has two oppositely positioned Extension Raising Surfaces 42-S2.

FIG. 143 shows a side-view of Torque Transmitting Member 43.

FIG. 144 shows a top-view of Torque Transmitting Member 43.

FIG. 145 shows a sectional-view of Torque Transmitting Member 43.

FIG. 146 shows a side-view of Leveling Extension Ramp 44.

FIG. 147 shows a rear-view of Leveling Extension Ramp 44.

FIG. 148 shows a side-view of a Leveling Extension Ramp 44 that is positioned on Leveling Extension Ramp Clearance 42-S1 so as to guide the “Leveling Extension inserted into Torque Transmitting Member 31 (which here is Leveling Extension 46-M2)” from an unraised surface of its Cone (which here has an infinite diameter) to Extension Raising Surface 42-S2.

FIG. 149 shows a side-view of Non-Torque Transmitting Member 46.

FIG. 150 shows a top-view of Non-Torque Transmitting Member 46.

FIG. 151 shows a sectional-view of Non-Torque Transmitting Member 46.

FIG. 152 shows a front-view of two oppositely positioned Locking Ring Pins which normality is maintained by Slider Rods 48 and Insertion Sleeves 49.

FIG. 153 shows a front-view of a Locking Ring 18C-S3 to which two Slider Rods 48 are attached.

FIG. 154 shows a front-view of a Locking Ring 21C-S3 to which two Insertion Sleeves 49 are attached.

FIG. 155 shows a front-view of two oppositely positioned Locking Ring Pins which normality is maintained by Slider Rods 48 and Insertion Sleeves 49; and a Spline Sleeve 52 into which Insertion Sleeves 49 and Spline 51 are slideably inserted.

FIG. 156 shows a side-view of Spline Sleeve 52, which axially position relative to Spline 51 is maintained by two Shaft Collars 53.

FIG. 157 shows a top-view of Spline Sleeve 52.

FIG. 158 shows a side-view of a two oppositely positioned Locking Ring Pins which normality is maintained by two oppositely positioned telescopes that are fixed to a Spline Sleeve 58.

FIG. 159 shows a front-view of Spline Sleeve 58, which axially position relative to its Spline 51 is maintained by two Shaft Collars 53.

FIG. 160 shows a side -view of a Top Member 54.

FIG. 161 shows a top-view of a Top Member 54.

FIG. 162 shows a side -view of an Intermediate Member 55.

FIG. 163 shows a top-view of an Intermediate Member 55.

FIG. 164 shows a side -view of a Bottom Member 56.

FIG. 165 shows a top-view of a Bottom Member 56.

FIG. 166 shows a side -view of a Telescope 59, which uses Intermediate Members 60 and 61.

FIG. 167 shows a front-view of a Locking Ring Pin 18C-S3 that is connected to a Top Member 54 of a telescope through the use of an Offset Bar 62.

FIG. 168 shows a rear-view of “Leading End Torque Transmitting Member Reinforcement Plate 63”.

FIG. 169 shows a side-view of “Leading End Torque Transmitting Member Reinforcement Plate 63”.

FIG. 170 shows a top-view of “Leading End Torque Transmitting Member Reinforcement Plate 63”.

FIG. 171 shows a rear-view of “Leading End Non-Torque Transmitting Member Reinforcement Plate 67”.

FIG. 172 shows a side-view of “Leading End Non-Torque Transmitting Member Reinforcement Plate 67”.

FIG. 173 shows a side-view of a Cone 68 to which “Leading End Torque Transmitting Member Reinforcement Plate 63” and “Leading End Non-Torque Transmitting Member Reinforcement Plate 67” are assembled.

FIG. 174 shows a sectional-view of FIG. 173.

FIG. 175 shows another sectional-view of FIG. 173.

FIG. 176 show a partial rear-view of Spline Sleeve 69.

FIG. 177 shows a side-view of Flanged Transmission Belt 71.

FIG. 178 shows a sectional-view of Flanged Transmission Belt 71.

FIG. 179 shows a rear-view of Reinforcement Plate 72.

FIG. 180 shows a side-view of Reinforcement Plate 72.

FIG. 181 shows a side-view of Leveling Extension 73.

FIG. 182 shows a sectional-view of Leveling Extension 73.

FIG. 183 shows a top-view of Leveling Extension 73.

FIG. 184 shows a rear-view of Supporting Plate 74-M1.

FIG. 185 shows a side-view of Supporting Plate 74-M1.

FIG. 186 shows a side-view of Transmission Belt Rest 75.

FIG. 187 shows a sectional-view of Transmission Belt Rest 75.

FIG. 188 shows a top-view of Transmission Belt Rest 75.

FIG. 189 shows a side-view of a section of a Leveling Extension 73 that is exiting its Leading End Torque Transmitting Member Reinforcement Plate (which is labeled as Reinforcement Plate 72), and is guided by Ramp Surface 76-S3 from Base Surface 76-S1 to Raised Surface 76-S2.

FIG. 190 shows a partial rear-view of FIG. 189.

FIG. 191 shows a side-view of a section of a Leveling Extension 73 that is exiting its Leading End Torque Transmitting Member Reinforcement Plate (which is labeled as Reinforcement Plate 72); and all other visible (not covered) parts of Leveling Extension Ramp Guide 81.

FIG. 192 shows a sectional-view of FIG. 191.

FIG. 193 shows a side-view of a section of a Leveling Extension 73 that is exiting its Leading End Torque Transmitting Member Reinforcement Plate (which is labeled as Reinforcement Plate 72); also shown are Ramp Leveling Base 77 and Left Flange Filler 79.

FIG. 194 shows a sectional-view of FIG. 193.

FIG. 195 shows the sectional-view of FIG. 193 for which Ramp Leveling Base 77 is replaced with Ramp Leveling Base 77A, and Supporting Plate 74-M1 is replaced with Supporting Plates 74A-M1.

FIG. 196 shows a side-view of a section of a Leveling Extension 73 that is exiting its Leading End Torque Transmitting Member Reinforcement Plate (which is labeled as Reinforcement Plate 72); also shown is Ramp Tooth Resting Filler 78.

FIG. 197 shows a side-view of Ramp Tooth Resting Filler 78.

FIG. 198 shows a front-view of Ramp Tooth Resting Filler 78.

FIG. 199 shows a side-view of Ramp Tooth Resting Filler 78A.

FIG. 200 shows a front-view of Ramp Tooth Resting Filler 78A.

FIG. 201 shows a side-view of Ramp Tooth Resting Filler 78B.

FIG. 202 shows a front-view of Ramp Tooth Resting Filler 78B.

FIG. 203 shows a side-view of Ramp Tooth Resting Filler 78C.

FIG. 204 shows a front-view of Ramp Tooth Resting Filler 78C.

FIG. 205 shows a side-view of Leveling Extension 73A.

FIG. 206 shows a sectional-view of Leveling Extension 73A.

FIG. 207 shows a side-view of Left Flange Filler 79.

FIG. 208 shows a front-view of Left Flange Filler 79.

FIG. 209 shows a side-view of Right Flange Filler 80.

FIG. 210 shows a front-view of Right Flange Filler 80.

FIG. 211 shows a side-view of Left Flange Filler 79A.

FIG. 212 shows a front-view of Left Flange Filler 79A.

FIG. 213 shows a side-view of Right Flange Filler 80A.

FIG. 214 shows a front-view of Right Flange Filler 80A.

FIG. 215 shows a front-view of a Cone 76.

FIG. 216 shows a side-view of a section of a Leveling Extension 73 that is exiting its Leading End Torque Transmitting Member Reinforcement Plate (which is labeled as Reinforcement Plate 72); and all other visible (not covered) parts of Leveling Extension Ramp Guide 82.

FIG. 217 shows a rear-view of Guiding Member 83.

FIG. 218 shows a right-view of Guiding Member 83.

FIG. 219 shows a left-view of Guiding Member 83

FIG. 220 shows a front-view of a section of Cone 76, which has an infinite diameter (straight surface).

FIG. 221 shows a front-view of a section of Cone 76A, which has an infinite diameter (straight surface).

FIG. 222 shows a rear-view of Ramp Tooth Resting Filler 78D.

FIG. 223 shows a side-view of Ramp Tooth Resting Filler 78D.

FIG. 224 shows a side-view of a Ramp Tooth Resting Filler 78D that is fixed to its Leading End Torque Transmitting Member Reinforcement Plate (which is labeled as Reinforcement Plate 72), and held in place by a Leveling Extension 73A.

FIG. 225 shows a rear-view of Rear Member 78D-M1.

FIG. 226 shows a side-view of Rear Member 78D-M1.

FIG. 227 shows a rear-view of Front Member 78D-M2.

FIG. 228 shows a side-view of Front Member 78D-M2.

FIG. 229 shows a side-view of a section of Non-Torque Transmitting Member Section 35A-M1.

FIG. 230 shows a sectional-view of Non-Torque Transmitting Member Section 35A-M1.

FIG. 231 show as side-view of a section of a Transmission Belt, for which its teeth are properly positioned between Bumps 35A-M1-S3.

FIG. 232 show as side-view of a section of Transmission Belt 87.

FIG. 233 shows a top-view of a Transmission 99 that comprises of two CVTs.

FIG. 234 shows another top-view of a Transmission 99 that comprises of two CVTs.

FIG. 235 shows a top-view of a Transmission 111 that comprises of two CVTs.

FIG. 236 shows another top-view of a Transmission 111 that comprises of two CVTs.

FIG. 237 shows a side-view of Torque Transmitting Member 112.

FIG. 238 shows a side-view of Non-Torque Transmitting Member 113.

FIG. 239 shows a front-view of Cone Assembly 115.

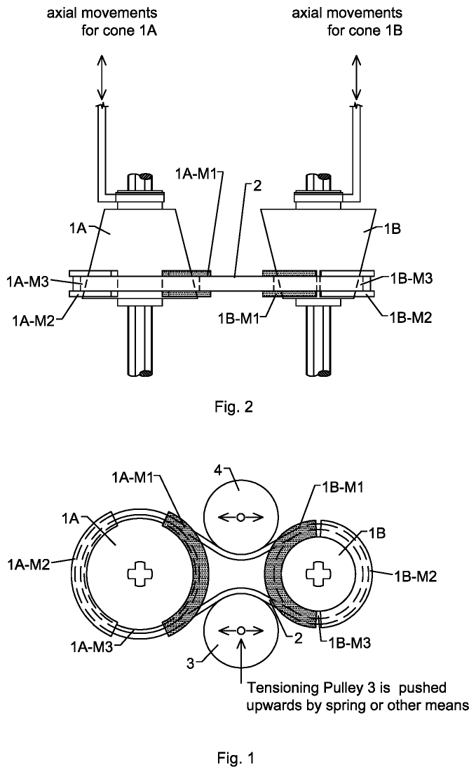

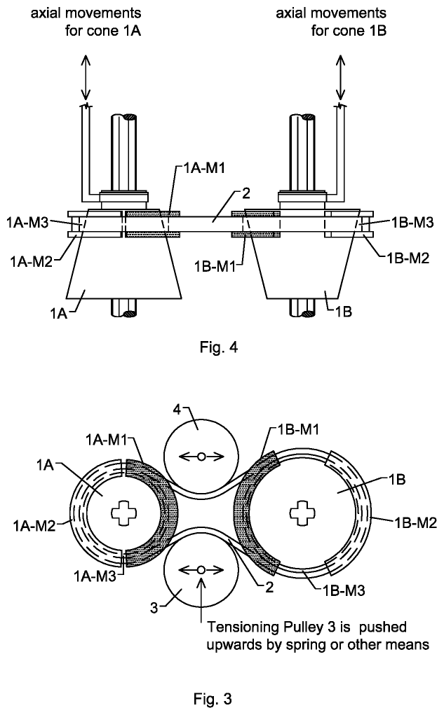

### REFERENCE NUMERALS IN DRAWINGS

For the reference numerals in this disclosure, the label M(number) after a reference numeral, where (number) is a number, such as M2 for example, is used to label different members of a part that is given one reference numeral but consist of more than one member. And the label S(number) after a reference numeral, where (number) is a number, such as S2 for example, is used to label the different shapes of a part that is given one reference numeral. Furthermore, same parts that are used in different location might have a different labeling letter after their reference numeral, or a different reference numeral altogether if this is helpful in describing the invention. If two parts have the same reference numeral then they are identical unless otherwise described.

### DETAILED DESCRIPTION OF THE INVENTION

### Torque Transmitting Chain Member, Non-Torque Transmitting Chain Member, and Leveling Loop for Cone

In this section, a Torque Transmitting Chain Member, Non-Torque Transmitting Chain Member, and Leveling Loop for a Cone is described.

The Torque Transmitting Chain Member of this section is mainly formed by alternating Links 6A and 6B that are held together by Pins or Joiner Plates 5.

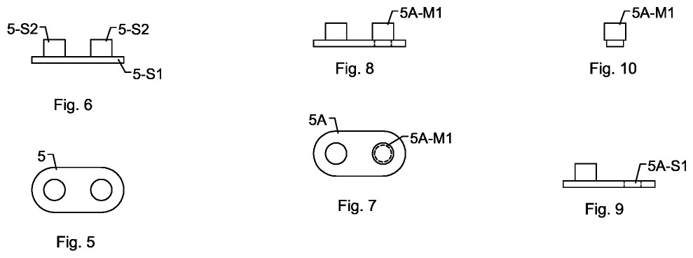

A Joiner Plate 5, which is shown in FIGS. 5 to 6, is a Plate 5-S1 that has two Pins 5-S2. Pins 5-S2 have the same function as a regular Pins that used for joining links of a chain. Unlike a regular chain, a Torque Transmitting Chain Member preferably has a high lateral stiffness; the purpose of Plate 5-S1 is to increase its lateral stiffness of its Torque Transmitting Chain Member.

FIGS. 7 to 8 show an alternate Joiner Plate, which is labeled as Joiner Plate 5A. For Joiner Plate 5A one pin is removable; the removable pin is labeled as Pin 5A-M1. FIG. 9 shows Joiner Plate 5A for which its Pin 5A-M1 has been removed; and FIG. 10 shows the removed Pin 5A-M1. The designated hole for Pin 5A-M1 of an Joiner Plate 5A, which in FIG. 9 is labeled as Hole 5A-S1, should be small enough so that Pin 5A-S1 can be tightly and securely inserted into it. Joiner Plate 5A can be used to reduce the distance between the sleeves of a Leading End Torque Transmitting Member, which will be described below.

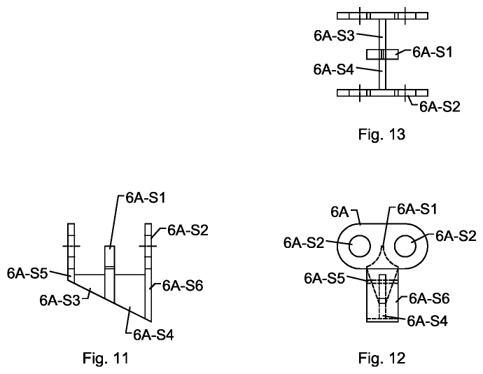

A Link 6A is shown in FIGS. 11 to 13. Link 6A has a Tooth 6A-S1, four Holes 6A-S2 (two on each side), a Tooth-to-Side Connector 6A-S3, a Tooth-to-Side Connector 6A-S4, a Side Connector-Extension 6A-S5, and a Side Connector-Extension 6A-S6.

Tooth-to-Side Connector 6A-S3 and Tooth-to-Side Connector 6A-S4 are used to connect Tooth 6A-S1 to the sides of Link 6A, through Side Connector-Extension 6A-S5, and Side Connector-Extension 6A-S6 (see FIGS. 11 to 12).

Link 6A has two “narrow inner base portions”. One “narrow inner base portion” is formed by Tooth-to-Side Connector 6A-S3, and the other “narrow inner base portion” is for formed by Tooth-to-Side Connector 6A-S4 (see FIG. 13). These “narrow inner base portions” allow for a resting places on the surface of a cone for sections of a leveling loop. If desired instead of a Link 6A, a link with more or less “narrow inner base portions” can be used, as long as the link has at least one “narrow inner base portion” that allows for a resting place on the surface of a cone for a section of a leveling loop.

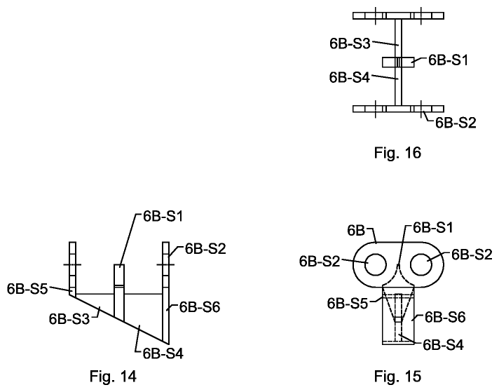

Link 6B is basically identical to Link 6A except that it is wider. A Link 6B is shown in FIGS. 14 to 16. Link 6B has a Tooth 6B-S1, four Holes 6B-S2 (two on each side), a Tooth-to-Side Connector 6B-S3, a Tooth-to-Side Connector 6B-S4, a Side Connector-Extension 6B-S5, and a Side Connector-Extension 6B-S6.

Tooth-to-Side Connector 6B-S3 and Tooth-to-Side Connector 6B-S4 are used to connect Tooth 6B-S1 to the sides of Link 6B, through Side Connector-Extension 6B-S5, and Side Connector-Extension 6B-S6 (see FIGS. 14 to 15).

Link 6B has two “narrow inner base portions”. One “narrow inner base portion” is formed by Tooth-to-Side Connector 6B-S3, and the other “narrow inner base portion” is for formed by Tooth-to-Side Connector 6B-S4 (see FIG. 16). These “narrow inner base portions” allow for a resting places on the surface of a cone for sections of a leveling loop. If desired instead of a Link 6B, a link with more or less “narrow inner base portions” can be used, as long as the link has at least one “narrow inner base portion” that allows for a resting place on the surface of a cone for a section of a leveling loop.

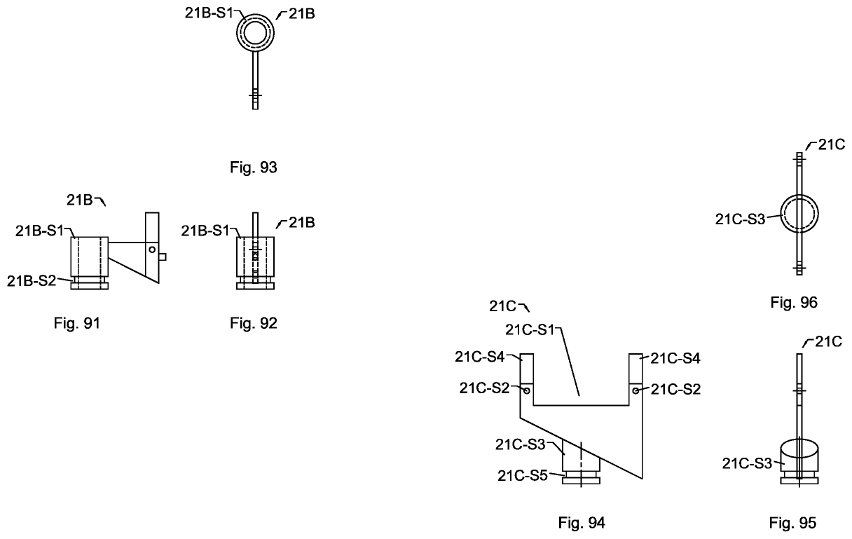

In order to attach the leading-end of a Torque Transmitting Chain Member of this section to a “cone with one torque transmitting member” that is referred to as a front pin belt cone assembly 520A in U.S. Pat. No. 8,628,439 (refer to column 90 line 64 to column 99 line 11; and FIGS. 91A, 91B, 92A, 92B, 93 to 101 of U.S. Pat. No. 8,628,439), a Leading End Torque Transmitting Chain Member 7 will be used.

And in order to secure the trailing-end of a Torque Transmitting Chain Member of this section to a “cone with one torque transmitting member”, a Trailing End Link 8 will be used.

And in order to connect a Trailing End Slide (which is used to move and maintain the axial alignment of the trailing-end portion of a Torque Transmitting Chain Member) to a Torque Transmitting Chain Member, a Trailing End Joiner Plate 5B will be used.

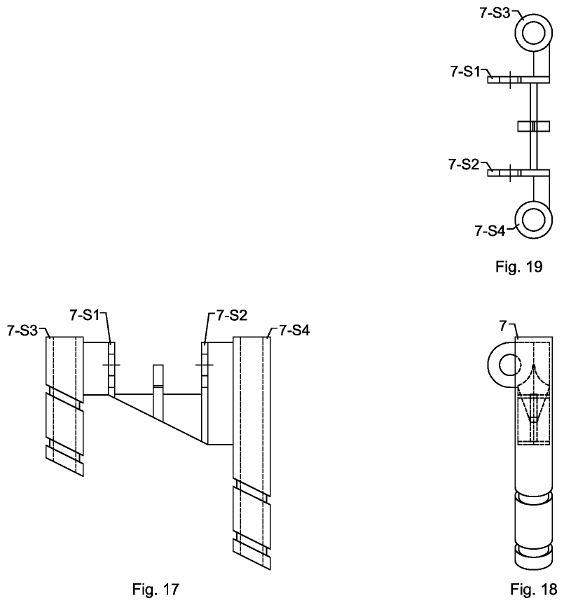

FIGS. 17 to 19 show Leading End Torque Transmitting Chain Member 7. Leading End Torque Transmitting Chain Member 7 is identical to Link 6B, except for its sides, which are labeled as Side 7-S1 and Side 7-S2. Unlike Link 6B, the sides of Leading End Torque Transmitting Chain Member 7 are shorter and as such have only 1 hole each instead of two; and unlike the sides of Link 6B, the sides of Leading End Torque Transmitting Chain Member 7 have Attachment Sleeves attached to them; these Attachment Sleeves are labeled as Attachment Sleeves 7-S3 and 7-S4.

Depending on the alternating-links arrangement of the Torque Transmitting Chain Member, in some configuration (such as Link 6B to Link 6A to Link 6B, instead of Link 6A to Link 6B to Link 6A for example), a Leading End Torque Transmitting Chain Member that is identical as described in the previous paragraph, except that its partial Link 6B portion is replaced with a partial Link 6A portion, has to be used.

Attachment Sleeves 7-S3 and 7-S4 are used to attach Leading End Torque Transmitting Chain Member 7 of a Torque Transmitting Chain Member to a torque transmitting member carriage 550A of a front pin belt cone assembly 520A of U.S. Pat. No. 8,628,439; using the same method that the sleeves of a leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

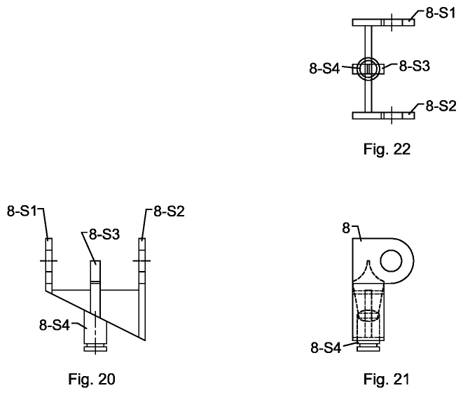

FIGS. 20 to 22 show Trailing End Link 8. Trailing End Link 8 is identical to Link 6B, except for: a) its sides, which are labeled as Side 8-S1 and Side 8-S2. Unlike Link 6B, the sides of Trailing End Link 8 are shorter and as such have only 1 hole each instead of two.

And b) unlike Link 6B, Trailing End Link 8 has a Slot Engagement Pin 8-S4, and the base of its tooth (which is labeled as Tooth 8-S3) is wider than the base of the tooth of Link 6B (which is labeled as Tooth 6B-S1) in order to better accommodate Slot Engagement Pin 8-S4. Trailing End Link 8 is used as the trailing end link of its Torque Transmitting Chain Member, and Slot Engagement Pin 8-S4 is used to secure the trailing end of its Torque Transmitting Chain Member to its cone.

Depending on the alternating-links arrangement of the Torque Transmitting Chain Member, in some configuration (such as Link 6B to Link 6A to Link 6B, instead of Link 6A to Link 6B to Link 6A for example), a Trailing End Link 8 that is identical as described in the previous paragraph, except that its partial Link 6B portion is replaced with a partial Link 6A portion, has to be used.

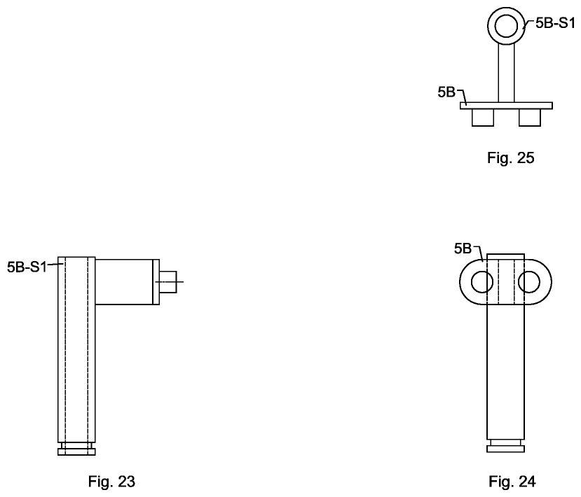

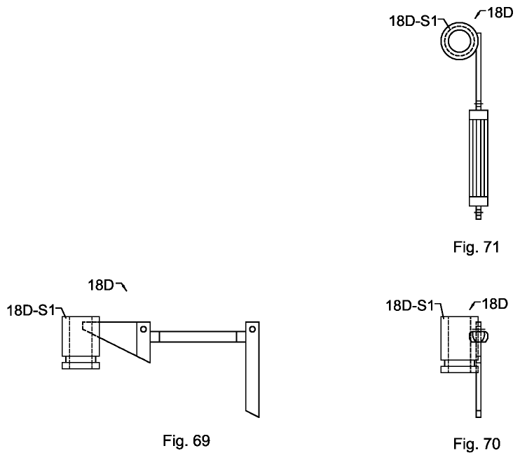

FIGS. 23 to 25 show a Trailing End Joiner Plate 5B. Trailing End Joiner Plate 5B is identical to Joiner Plate 5, except that the outer surface of Trailing End Joiner Plate 5B has an Attachment Sleeve, which is labeled as Attachment Sleeve 5B-S1, attached to it. Trailing End Joiner Plate 5B should be positioned on the larger cone dimeter resting side of its Torque Transmitting Chain Member. If necessary for alignment with Slot Engagement Pin 8-S4 in their Trailing End Cut (see below for details), Attachment Sleeve 5B-S1 can be positioned to the left or to the right from the position shown in FIGS. 24 and 25 (Attachment Sleeve 5B-S1 does not have to be positioned at the mid-length of Trailing End Joiner Plate 5B as shown). An analogous comparison for this for a Torque Transmitting Member 19 is that Attachment Sleeve 18B-S1 can be positioned behind (to the left) or in-front (to the right) of its Reinforcement Plate (see FIGS. 69 to 74).

Attachment Sleeve 5B-S1 is used to connect the trailing end portion of a Torque Transmitting Chain Member to a Trailing End Slide (which is used to move and maintain the axial alignment of the trailing-end-portion of a Torque Transmitting Chain Member) of its cone; using the same method that trailing plate sleeve 593-S1 of a pin belt torque transmitting member 590 is connected to a trailing end slide 565-S1 of its front pin belt cone assembly 520A of U.S. Pat. No. 8,628,439 (refer to column 92 line 54 to column 93 line 32 of U.S. Pat. No. 8,628,439).

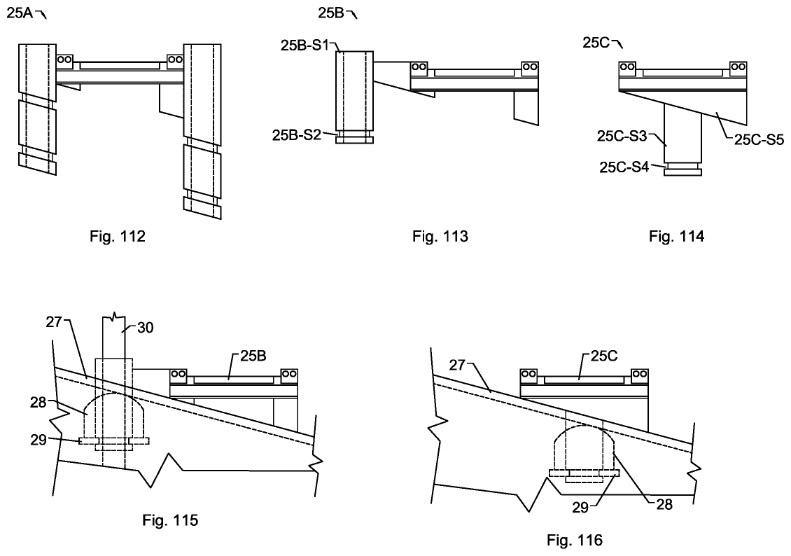

A Torque Transmitting Chain Member should be designed so that its Slot Engagement Pin 8-S4 and its Attachment Sleeve 5B-S1 can slide in the same Trailing End Cut (the Trailing End Cuts for a cone are shown and labeled as trailing end cuts 540-S6 in FIG. 112B of U.S. Pat. No. 8,628,439), in a manner so that Slot Engagement Pin 8-S4 can engage with its Trailing End Cut surface that prevents its Torque Transmitting Chain Member from moving towards its Leading End Cut, so that Slot Engagement Pin 8-S4 can transfer torque in the direction that pulls from the Trailing End towards the Leading End of its cone; and preferably (but not necessarily) also prevents its Torque Transmitting Chain Member from moving away from its Leading End. If necessary, some play between Attachment Sleeve 5B-S1 and its Trailing End Cut is allowed. And if there are interferences between the fastener for Slot Engagement Pin 8-S4 and the fastener for Attachment Sleeve 5B-S1, then it is not necessary to use the fastener of Attachment Sleeve 5B-S1.

The Leading End Cuts for a cone are shown and labeled as leading end cuts 540-S1 in FIG. 112B of U.S. Pat. No. 8,628,439. The Leading End Cuts are used to insert the Attachment Sleeves of a Leading End Torque Transmitting Chain Member.

The proper location of Attachment Sleeve 5B-S1 relative to Slot Engagement Pin 8-S4, as well as the shape and size of all cuts on a cone can be determined through trial-and-error and experimentation (such as tracing for example).

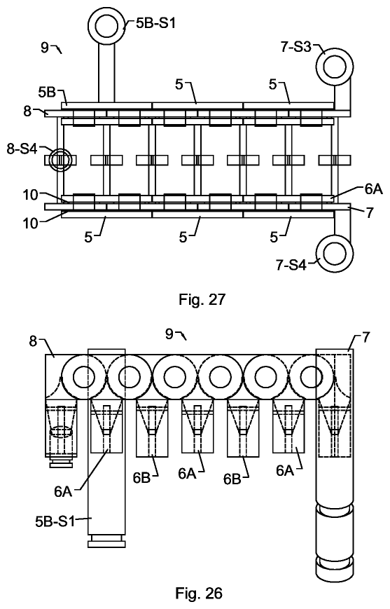

FIGS. 26 to 27, show a Torque Transmitting Chain Member of this section. This Torque Transmitting Chain Member, which is labeled as Torque Transmitting Chain Member 9, comprises of a Leading End Torque Transmitting Chain Member 7, alternating Links 6A and Links 6B, and a Trailing End Link 8 that are linked together by Joiner Plates 5 and a Trailing End Joiner Plate 5B.

The Joiner Plates 5 have Pins 5-S2 (see FIG. 6), and each Pin 5-S2 is inserted through the holes of two adjacent links (here the links are: Leading End Torque Transmitting Chain Member 7, Links 6A, Links 6B, and Trailing End Link 8), so as to link them together. In FIGS. 26 to 27, each Pin 5-S2 is secured due to the friction between it and its hole of a Link 6A; because of this, it is recommended that the holes of Links 6A are smaller than the holes of the other links. Trailing End Joiner Plate 5B is identical to Joiner Plates 5, except that it also has an Attachment Sleeve 5B-S1.

In order to reduce friction, Washers 10, which should be made out of a low friction material, can be placed between all engaging side surfaces of two links, and between all engaging side surfaces of a link with a Joiner Plates 5 or Trailing End Joiner Plate 5B; however, this is not absolutely necessary, since the chain member can be used where it is submerged or coated in lubricants.

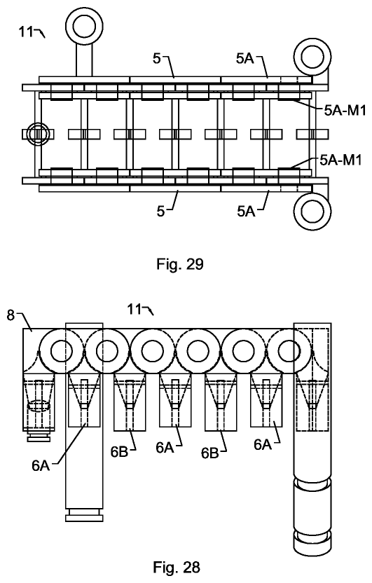

For Leading End Torque Transmitting Chain Member 7, the distance between Attachment Sleeves 7-S3 and 7-S4 can be reduced by using Joiner Plates 5A instead of Joiner Plates 5 in order to connect Leading End Torque Transmitting Chain Member 7 to its Link 6A (Joiner Plate 5A was described earlier and shown in FIGS. 7 to 10). Here the removable-pin-ends of Joiner Plates 5A can be linked to Leading End Torque Transmitting Chain Member 7 and a Link 6A, by placing Joiner Plates 5A on both outside surfaces of Leading End Torque Transmitting Chain Member 7 in such a manner such that Pins 5A-M1 can be pressed-in through the exposed-end holes of said Link 6A, the holes of Leading End Torque Transmitting Chain Member 7, and the Holes 5A-S1 of Joiner Plate 5A, and then securely pressing in the Pins 5A-M1. If this is desired, then for FIG. 27, the Joiner Plates 5 that are used to connect Leading End Torque Transmitting Chain Member 7 to its Link 6A have to be replaced with Joiner Plates 5A accordingly. FIGS. 28 to 29 show a Torque Transmitting Chain Member 11 for which the distance between the Attachment Sleeves of the Leading End Torque Transmitting Chain Member are reduced through the use of Joiner Plates 5A.

The Non-Torque Transmitting Chain Member of this section is mainly formed by alternating Links 12A and 12B that are held together by Pins or Joiner Plates 5.

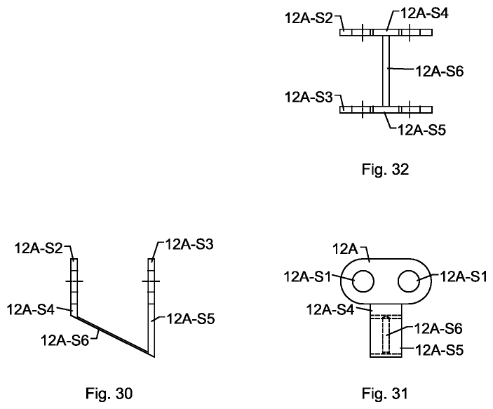

A Link 12A is shown in FIGS. 30 to 32. Link 12A is basically identical to Link 6A, except that it doesn't have Tooth 6A-S1, a Tooth-to-Side Connector 6A-S3, and a Tooth-to-Side Connector 6A-S4; in addition, unlike Link 6A, Link 11A has a Base 12A-S6.

A Link 12A has a Side 12A-S2 and a Side 12-S3, which each have two holes 12A-S1. Side 12A-S2 and Side 12-S3 are connected by Base 12A-S6 through Side Connector-Extension 12A-S4 and Side Connector-Extension 12A-S5, which extend below Side 12A-S2 and Side 12-S3 and are narrower than said Sides in order to allow for sufficient bending of its Non-Torque Transmitting Chain Member

Base 12A-S6 of Link 12A is very narrow; this allows for a resting place for a section of a leveling loop. In addition, Base 12A-S6 is shaped so that the “cone surface resting base” of its leveling loop can slide over it during transmission ratio change.

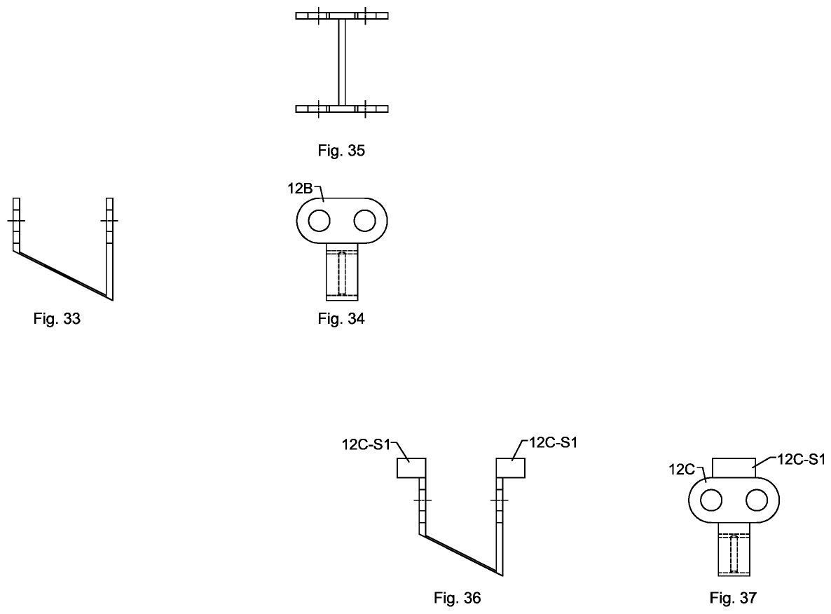

A Link 12B is shown in FIGS. 33 to 35. Link 12B is basically identical to Link 12A except that it is wider.

Furthermore, in order to prevent excessive vibration due to centrifugal forces, it is recommended that each link of a Torque Transmitting Chain Member has the same weight as the corresponding (oppositely positioned) link of its Non-Torque Transmitting Chain Member; so that the centrifugal forces of the Chain Members cancel each other out. This can be ensured through the selection of material or by adding weight increasing shapes to the links of the Non-Torque Transmitting Chain Member if necessary.

FIGS. 36 to 37 show a link of a Non-Torque Transmitting Chain Member to which balancing weights have been added, so that the weight of this link is identical to the weight of the corresponding link of its Torque Transmitting Chain Member. This link is labeled as Link 12C, and it is basically identical to Link 12A, except that it has Balancing Weights 12C-S1. In a similar manner, Link 41B can also be modified in order to have Balancing Weights.

In order to attach the leading-end of a Non-Torque Transmitting Chain Member of this section to a “cone with one torque transmitting member” that is referred to as a front pin belt cone assembly 520A in U.S. Pat. No. 8,628,439 (refer to column 90 line 64 to column 99 line 11; and FIGS. 91A, 91B, 92A, 92B, 93 to 101 of U.S. Pat. No. 8,628,439), a Leading End Non-Torque Transmitting Chain Member 13 will be used.

And in order to secure the trailing-end of a Non-Torque Transmitting Chain Member of this section to a “cone with one torque transmitting member”, a Trailing End Link 14 will be used.

And in order to connect a Trailing End Slide (which is used to move and maintain the axial alignment of the trailing-end portion of a Non-Torque Transmitting Chain Member) to a Torque Transmitting Chain Member, a Trailing End Joiner Plate 5B will be used.

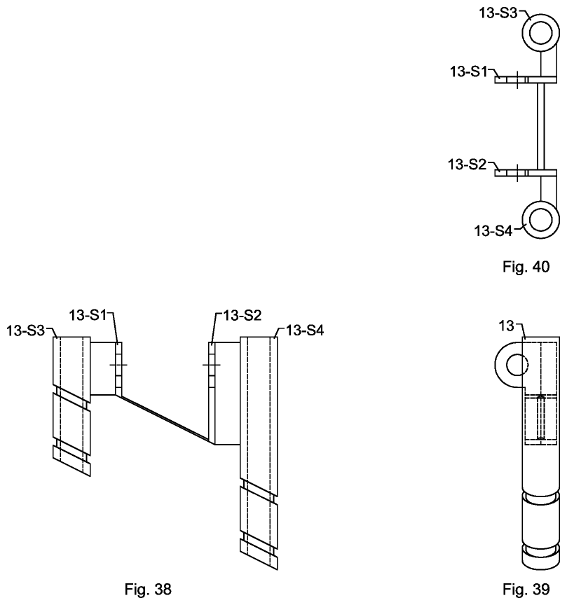

FIGS. 38 to 40 show Leading End Non-Torque Transmitting Chain Member 13. Leading End Non-Torque Transmitting Chain Member 13 is identical to Link 12B, except for its sides, which are labeled as Side 13-S1 and Side 13-S2. Unlike Link 12B, the sides of Leading End Non-Torque Transmitting Chain Member 13 are shorter and as such have only 1 hole each instead of two; and unlike the sides of Link 12B, the sides of Leading End Non-Torque Transmitting Chain Member 13 have Attachment Sleeves attached to them; these Attachment Sleeves are labeled as Attachment Sleeves 13-S3 and 13-S4.

Depending on the alternating-links arrangement of the Non-Torque Transmitting Chain Member, in some configuration (such as Link 12B to Link 12A to Link 12B, instead of Link 12A to Link 12B to Link 12A for example), a Leading End Non-Torque Transmitting Chain Member that is identical as described in the previous paragraph, except that its partial Link 12B portion is replaced with a partial Link 12A portion, has to be used.

Attachment Sleeves 13-S3 and 13-S4 are used to attach Leading End Non-Torque Transmitting Chain Member 13 of a Non-Torque Transmitting Chain Member to a torque transmitting member carriage 550A of a front pin belt cone assembly 520A of U.S. Pat. No. 8,628,439; using the same method that the sleeves of a leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

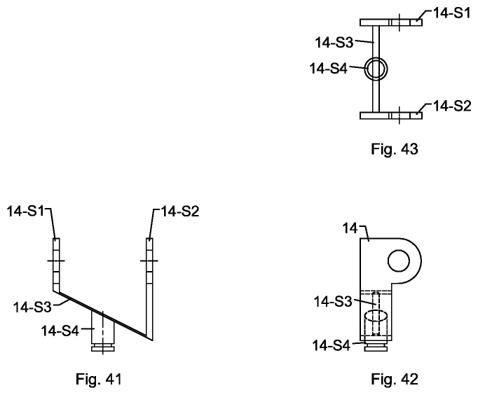

FIGS. 41 to 43 show Trailing End Link 14. Trailing End Link 14 is identical to Link 12B, except for: a) its sides, which are labeled as Side 14-S1 and Side 14-S2. Unlike Link 12B, the sides of Trailing End Link 14 are shorter and as such have only 1 hole each instead of two.

And b) unlike Link 12B, Trailing End Link 14 has a Slot Engagement Pin 14-S4 attached its base. The base of Trailing End Link 14 is labeled as Base 14-S3.

Trailing End Link 14 is used as the trailing end link of its Non-Torque Transmitting Chain Member, and Slot Engagement Pin 14-S4 is used to secure the trailing end of its Non-Torque Transmitting Chain Member to its cone.

Depending on the alternating-links arrangement of the Non-Torque Transmitting Chain Member, in some configuration (such as Link 6B to Link 6A to Link 6B, instead of Link 6A to Link 6B to Link 6A for example), a Trailing End Link 14 that is identical as described in the previous paragraph, except that its partial Link 12B portion is replaced with a partial Link 12A portion, has to be used.

FIGS. 23 to 25 show a Trailing End Joiner Plate 5B (which was described previously for a Torque Transmitting Chain Member). Trailing End Joiner Plate 5B is identical to Joiner Plate 5, except that the outer surface of Trailing End Joiner Plate 5B has an Attachment Sleeve, which is labeled as Attachment Sleeve 5B-S1, attached to it. Trailing End Joiner Plate 5B should be positioned on the larger cone dimeter resting side of its Non-Torque Transmitting Chain Member. If necessary for alignment with Slot Engagement Pin 14-S4 in their Trailing End Cut (see paragraphs below for details), Attachment Sleeve 5B-S1 can be positioned to the left or to the right from the position shown in FIGS. 24 and 25 (Attachment Sleeve 5B-S1 does not have to be positioned at the mid-length of Trailing End Joiner Plate 5B as shown).

Attachment Sleeve 5B-S1 is used to connect the trailing end portion of a Non-Torque Transmitting Chain Member to a Trailing End Slide (which is used to move and maintain the axial alignment of the trailing-end-portion of a Non-Torque Transmitting Chain Member) of its cone; using the same method that trailing plate sleeve 593-S1 of a pin belt torque transmitting member 590 is connected to a trailing end slide 565-S1 of its front pin belt cone assembly 520A of U.S. Pat. No. 8,628,439 (refer to column 92 line 54 to column 93 line 32 of U.S. Pat. No. 8,628,439).

A Non-Torque Transmitting Chain Member should be designed so that its Slot Engagement Pin 14-S4 and its Attachment Sleeve 5B-S1 can slide in the same Trailing End Cut (the Trailing End Cuts for a cone are shown and labeled as trailing end cuts 540-S6 in FIG. 112B of U.S. Pat. No. 8,628,439), in a manner so that Slot Engagement Pin 14-S4 can engage with its Trailing End Cut surface that prevents its Non-Torque Transmitting Chain Member from moving towards its Leading End Cut, so that Slot Engagement Pin 14-S4 can transfer torque in the direction that pulls from the Trailing End towards the Leading End of its cone; and preferably (but not necessarily) also prevents its Non-Torque Transmitting Chain Member from moving away from its Leading End. If necessary, some play between Attachment Sleeve 5B-S1 and its Trailing End Cut is allowed. And if there are interferences between the fastener for Slot Engagement Pin 14-S4 and the fastener for Attachment Sleeve 5B-S1, then it is not necessary to use the fastener of Attachment Sleeve 5B-S1.

The Leading End Cuts for a cone are shown and labeled as leading end cuts 540-S1 in FIG. 112B of U.S. Pat. No. 8,628,439. The Leading End Cuts are used to insert the Attachment Sleeves of a Leading End Non-Torque Transmitting Chain Member.

The proper location of Attachment Sleeve 5B-S1 relative to Slot Engagement Pin 14-S4, as well as the shape and size of all cuts on a cone can be determined through trial-and-error and experimentation (such as tracing for example).

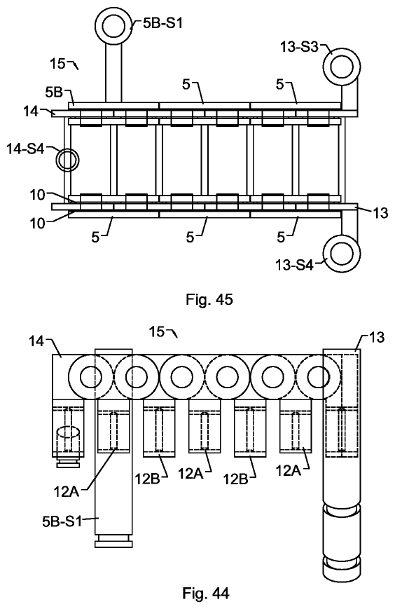

FIGS. 44 to 45, show a Non-Torque Transmitting Chain Member of this section. This Non-Torque Transmitting Chain Member, which is labeled as Non-Torque Transmitting Chain Member 15, comprises of a Leading End Non-Torque Transmitting Chain Member 13, alternating Links 12A and Links 12B, and a Trailing End Link 14 that are linked together by Joiner Plates 5 and a Trailing End Joiner Plate 5B.

The Joiner Plates 5 have Pins 5-S2 (see FIG. 6), and each Pin 5-S2 is inserted through the holes of two adjacent links (here the links are: Leading End Torque Transmitting Chain Member 13, Links 12A, Links 12B, and Trailing End Link 14), so as to link them together. In FIGS. 44 to 45, each Pin 5-S2 is secured due to the friction between it and its hole of a Link 12A; because of this, it is recommended that the holes of Links 12A are smaller than the holes of the other links. Trailing End Joiner Plate 5B is identical to Joiner Plates 5, except that it also has an Attachment Sleeve 5B-S1.

In order to reduce friction, Washers 10, which should be made out of a low friction material, can be placed between all engaging side surfaces of two links, and between all engaging side surfaces of a link with a Joiner Plates 5 or Trailing End Joiner Plate 5B; however, this is not absolutely necessary, since the chain member can be used where it is submerged or coated in lubricants.

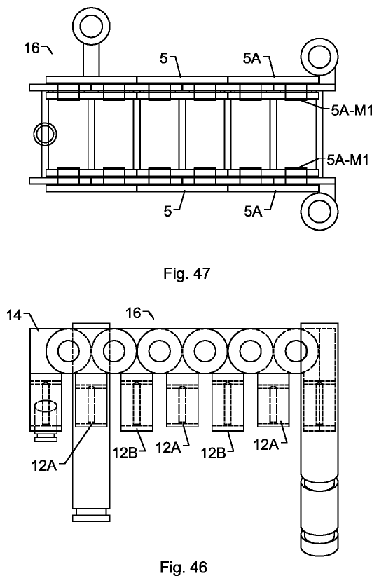

For Leading End Non-Torque Transmitting Chain Member 13, the distance between Attachment Sleeves 13-S3 and 13-S4 can be reduced by using Joiner Plates 5A instead of Joiner Plates 5 in order to connect Leading End Non-Torque Transmitting Chain Member 13 to its Link 12A (Joiner Plate 5A was described earlier and shown in FIGS. 7 to 10). Here the removable-pin-ends of Joiner Plates 5A can be linked to Leading End Non-Torque Transmitting Chain Member 13 and a Link 12A, by placing Joiner Plates 5A on both outside surfaces of Leading End Non-Torque Transmitting Chain Member 13 in such a manner such that Pins 5A-M1 can be pressed-in through the exposed-end holes of said Link 12A, the holes of Leading End Non-Torque Transmitting Chain Member 13, and the Holes 5A-S1 of Joiner Plate 5A, and then securely pressing in the Pins 5A-M1. If this is desired, then for FIG. 45, the Joiner Plates 5 that are used to connect Leading End Non-Torque Transmitting Chain Member 13 to its Link 12A have to be replaced with Joiner Plates 5A accordingly. FIGS. 46 to 47 show a Non-Torque Transmitting Chain Member 16 for which the distance between the Attachment Sleeves of the Leading End Torque Transmitting Chain Member are reduced through the use of Joiner Plates 5A.

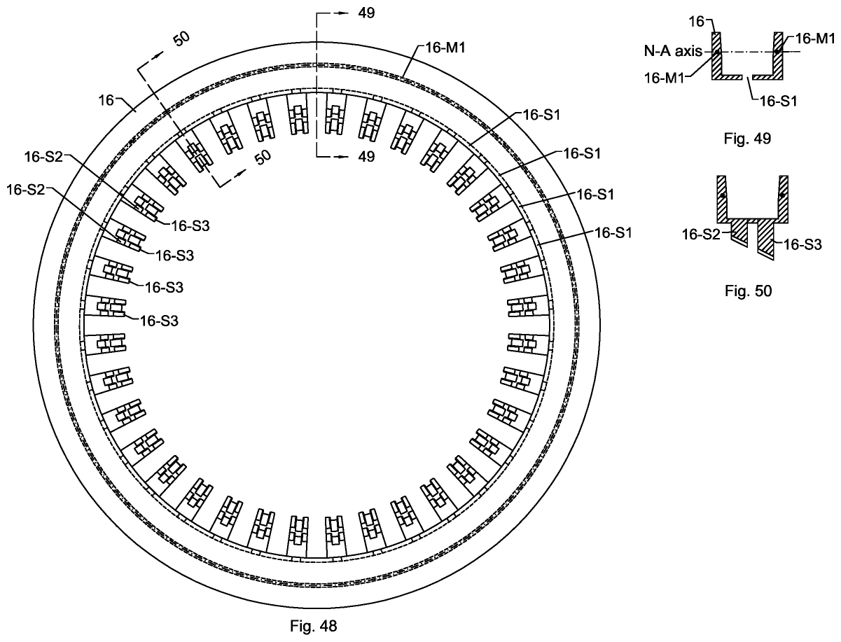

The Leveling Loop of this section is shown in FIGS. 48 to 50; it is labeled as Leveling Loop 16. The cross-section of Leveling Loop 16 is channel-shaped with two sides and a horizontal base (see FIG. 49); said horizontal base has cut-outs for teeth, which are labeled as Cut-outs 16-S1 (see FIGS. 48 and 49). It is recommended that Cut-outs 16-S1 are slightly wider than the width of the teeth of its Torque Transmitting Chain Member in order to allow for some leeway. The Cut-outs 16-S1 should have the “same” or “almost the same” pitch as the pitch of the teeth of its Torque Transmitting Chain Member for all transmission diameters of its cone. In order to ensure this, the Neutral-Axis of Leveling Loop 16 should “coincide” or “almost coincide” with the Bending-Axis of its Torque Transmitting Chain Member. It is recommended that Leveling Loop 16 has Reinforcements 16-M1. This will make it easier to place the Neutral-Axis of Leveling Loop 16, and this will increase the lateral stiffness of Leveling Loop 16.

In addition, Leveling Loop 16 also has Legs 16-S2 and Legs 16-S3 (see FIGS. 48 and 50). The “dimension of Legs 16-S2 and Legs 16-S3” and the “dimension of the links of its Chain Members (which are its Torque Transmitting Chain Member and its Non-Torque Transmitting Chain Member)” should be selected so that there is sufficient clearance for “Legs 16-S2 and Legs 16-S3” to smoothly enter and exit its Chain Members.

Furthermore, the bases of each “Leg 16-S2 and Leg 16-53” has a groove at/near its mid-width. The grooves of each “Leg 16-S2 and Leg 16-S3” and the bases of each “Leg 16-S2 and Leg 16-S3” are shaped so that their “Leg 16-S2 and Leg 16-S3” can slide-over the bases of their Non-Torque Transmitting Chain Member when the diameter of their cone is changed, and so that the bases of their Non-Torque Transmitting Chain Member can enter and exit said grooves.

Said grooves are necessary since for each 1-tooth diameter change of a cone, the “Leveling Loop 16 section” between a Torque Transmitting Chain Member and a Non-Torque Transmitting Chain Member only slides ½-tooth length towards or away from said Non-Torque Transmitting Chain Member. This is because there are two said “Leveling Loop 16 sections” oppositely position on said cone, which lengths each change by the amount of ½-tooth length for each 1-tooth diameter increase of said cone. Here said “Leveling Loop 16 sections” refers to the oppositely positioned spaces between a Torque Transmitting Chain Member and a Non-Torque Transmitting Chain Member, which change in length as the transmission diameter of their cone is changed.

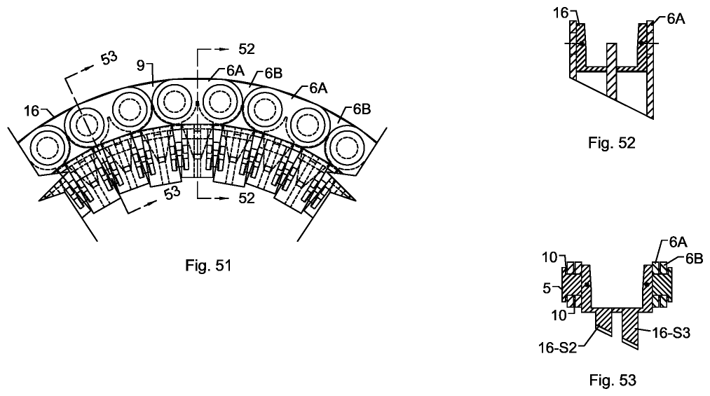

FIG. 51 shows a side-view of a section of Leveling Loop 16 that is positioned between a section of Torque Transmitting Chain Member 9. FIGS. 52 and 53 show sectional-views of a sections of Leveling Loop 16 as cut per FIG. 51.

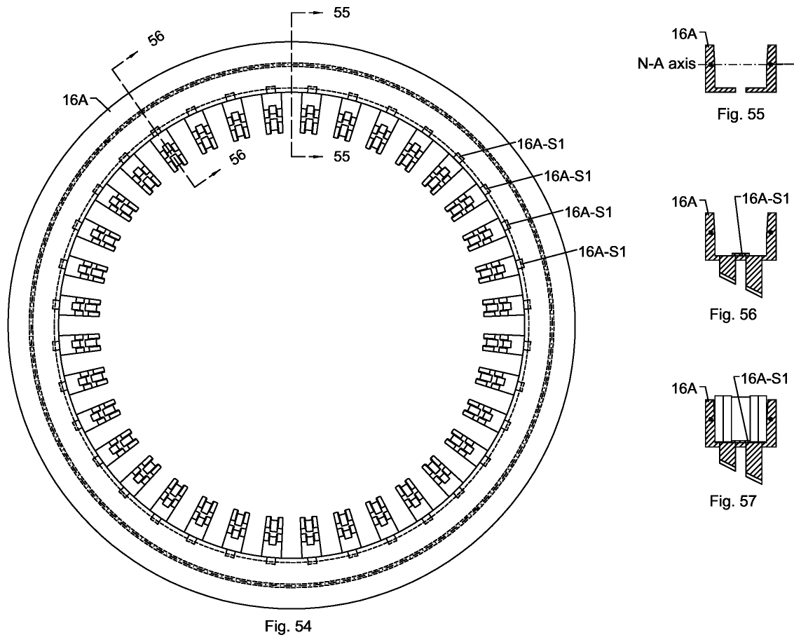

FIGS. 54 to 56 show a Leveling Loop 16A. Leveling Loop 16A is basically identical to Leveling Loop 16, as such it also has a cross-section that it is channel-shaped with two sides and a horizontal base (see FIG. 55); but unlike Leveling Loop 16, for Leveling Loop 16A each surface of said base on which a roller of a chain rests has a Resting Base 16A-S1 (see FIGS. 54 and 56). Each Resting Base 16A-S1 has a “partial roller cut-out” for a roller of the chain with which it is used; the purpose of this is to reduce the contact stresses that occur when a chain rests on a leveling loop.

FIG. 57 shows the cross-section of Leveling Loop 16A on which a Chain Section (which is not labeled and not hatched) rests, here the roller of said Chain Section is resting on Resting Base 16A-S1 in a manner so that the Link Plates of said Chain Section are not resting on said Leveling Loop 16A.

For simplicity and the sake of introducing a concept, the items of this section (Torque Transmitting Chain Members, Non-Torque Transmitting Chain Members, and Leveling Loops) are all shown for a single-stranded chain only; but obviously with some slight modification (such as using two teeth instead of one tooth on a link for example), the items of this section can also be used with multi-stranded chains.

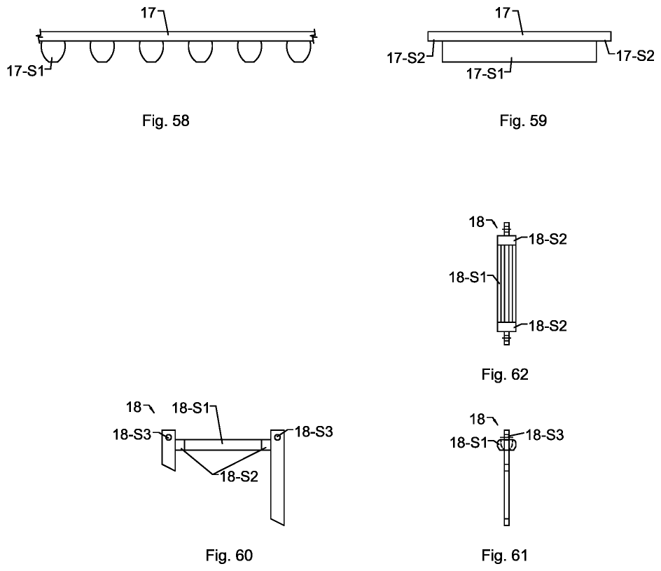

Torque Transmitting Member and Non-Torque Transmitting Member for Usage with a Slightly Modified Commercially Available Transmission Belt (FIGS. 58 to 104)

In this section, a Torque Transmitting Member and Non-Torque Transmitting Member for a Cone is described. The items of this section can be used with a slightly modified commercially available Transmission Belt, which is described in this section.

The Transmission Belt to be used with the items of this section is shown in FIGS. 58 and 59, where it is labeled as Transmission Belt 17. Transmission Belt 17 has Teeth 17-S1, which are used for torque transmission. And Transmission Belt 17 also has Flanges 17-S2, which are used to support Transmission Belt 17 where necessary. Unlike a Transmission Pulley, a Cone Assembly of this section provides less resting surfaces for its Transmission Belt; in order to compensate for this, additional strengthening reinforcements (such as shear strength reinforcements, etc.) can be added to Transmission Belt 17.

The Torque Transmitting Member of this section comprises of an elastomer segment that has reinforcement plates and reinforcement wires.

A reinforcement plate for the Torque Transmitting Member of this section, which is labeled as Reinforcement Plate 18, is shown in FIGS. 60 to 62. Reinforcement Plate 18 is shaped like a flat plate (for which its middle-section has been cut-out) that as Tooth 18-S1 shaped on it. Tooth 18-S1 is shaped similar to a channel with a U-cross-section for which its bottom surface has been removed (see FIG. 61).

Since the middle-section of the flat plate of Reinforcement Plate 18 has been cut-out, the flat plate of Reinforcement Plate 18 has two vertical sides (see FIG. 60). Tooth 18-S1 is connected to these sides through solid Tooth Ends 18-S2 (see FIGS. 60 to 62). Tooth Ends 18-S2 are basically end-walls that connect Tooth 18-S1 to said sides.

Reinforcement Plate 18 also has two Holes 18-S3; these holes are for the reinforcement wires of its Torque Transmitting Member; these holes should be located so that the bending-axis of its Torque Transmitting Member coincides with the bending-axis of its transmission belt.

In order to attach a Torque Transmitting Member of this section to a “cone with one torque transmitting member” that is referred to as a front pin belt cone assembly 520A in US Patent 8,628,439 (refer to column 90 line 64 to column 99 line 11; and FIGS. 91A, 91B, 92A, 92B, 93 to 101 of U.S. Pat. No. 8,628,439), a Leading End Reinforcement Plate 18A, a Trailing Sleeve Reinforcement Plate 18B, and a Trailing End Reinforcement Plate 18C can be used.

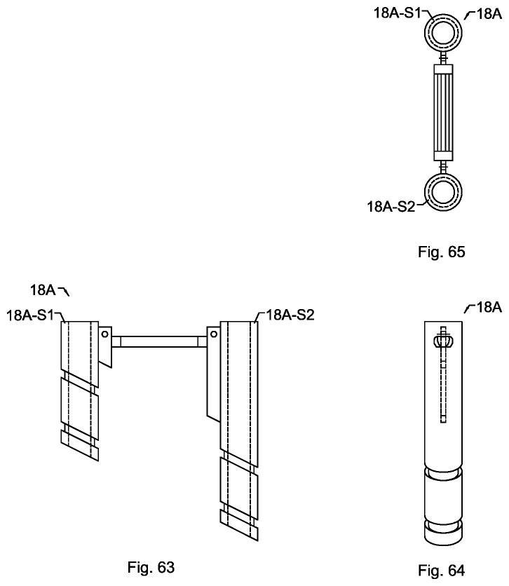

FIGS. 63 to 65 show a Leading End Reinforcement Plate 18A. Leading End Reinforcement Plate 18A is identical to Reinforcement Plate 18, except that Attachment Sleeves are attached to its sides; these Attachment Sleeves are labeled as Attachment Sleeves 18A-S1 and 18A-S2.

Attachment Sleeves 18A-S1 and 18A-S2 are used to attach the Leading End of a Torque Transmitting Member to a torque transmitting member carriage 550A of a front pin belt cone assembly 520A of U.S. Pat. No. 8,628,439; using the same method the sleeves of the leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

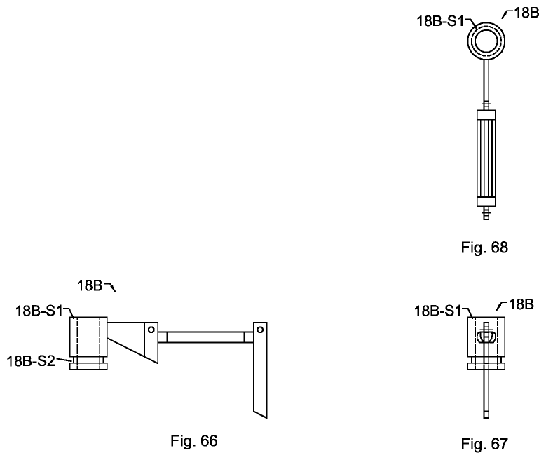

FIGS. 66 to 68 show a Trailing Sleeve Reinforcement Plate 18B. Trailing Sleeve Reinforcement Plate 18B is identical to Reinforcement Plate 18, except that the larger cone diameter resting side of Trailing Sleeve Reinforcement Plate 18B has an Attachment Sleeve, which is labeled as Attachment Sleeve 18B-S1, attached to it. The bottom end of Attachment Sleeve 18B-S1 has a Locking Ring Groove 18B-S2, which is used to secure Attachment Sleeve 18B-S1 to its cone by sliding a fastener such as a Dome Shaped Nut or a Ball Clamp (which is preferred) into Attachment Sleeve 18B-S1, and securing the fastener by inserting a Locking Ring into Locking Ring Groove 18B-S2.

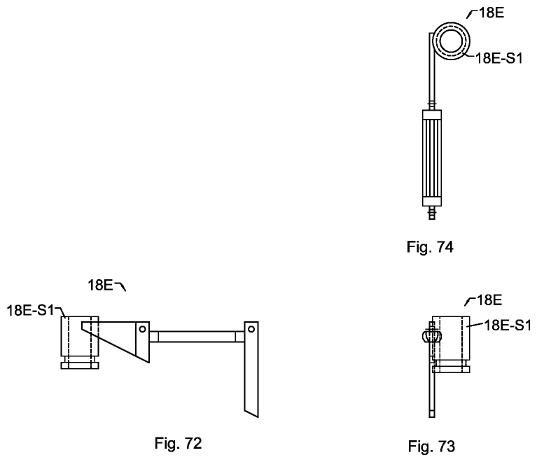

Attachment Sleeve 18B-S1 is used to connect its Torque Transmitting Member to its Trailing End Slide; using the same method used in U.S. Pat. No. 8,628,439 to connect the trailing end of a pin belt torque transmitting member 590 to its trailing end slide 565-S1 (see FIGS. 91A, 91B, 92A, 92B, 93 to 99). If necessary for alignment with Locking Ring Pin 18C-S3 in their Trailing End Cut (see paragraphs below for details), Attachment Sleeve 18B-S1 can be positioned behind or in-front of its Reinforcement Plate. FIGS. 69 to 71 show a Trailing Sleeve Reinforcement Plate 18D for which its Attachment Sleeve 18D-S1 is positioned behind its Reinforcement Plate; and FIGS. 72 to 74 show a Trailing Sleeve Reinforcement Plate 18E for which its Attachment Sleeve 18E-S1 is positioned in-front of its Reinforcement Plate.

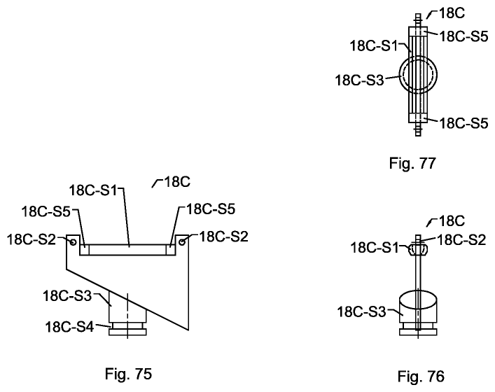

FIGS. 75 to 77 show a Trailing End Reinforcement Plate 18C. Trailing End Reinforcement Plate 18C is shaped like a flat plate that as Tooth 18C-S1 shaped on it. Tooth 18C-S1 is shaped similar to a channel with a U-cross-section (see FIG. 76). Here the bottom surface of the U-cross-section is formed by the “top surface of the middle-section” of the flat plate (see FIGS. 75 and 76). Tooth 18C-S1 is shaped like Tooth 18-S1; and like Tooth 18-S1, Tooth 18C-S1 also has two Tooth Ends (which are labeled as Tooth Ends 18C-S5, and are identical to Tooth Ends 18-S2).

Trailing End Reinforcement Plate 18C also has two holes 18C-S2; these holes are for the reinforcement wires of its Torque Transmitting Member; these holes should be located so that the bending-axis of its Torque Transmitting Member coincides with the bending-axis of its transmission belt.

In addition, Trailing End Reinforcement Plate 18C also has a Locking Ring Pin 18C-S3. Locking Ring Pin 18C-S3 is used to secure the Trailing End of its Torque Transmitting Member to its cone by sliding a fastener such as a Dome Shaped Nut or a Ball Clamp (which is preferred) into Locking Ring Pin 18C-S3, and securing the fastener by inserting a Locking Ring into Locking Ring Groove 18C-S4 of Locking Ring Pin 18C-S3.

The Torque Transmitting Member using the Trailing Sleeve Reinforcement Plate (such as Trailing Sleeve Reinforcement Plate 18B, 18D or 18E) and Trailing End Reinforcement Plate 18C should be designed so that its Locking Ring Pin 18C-S3 and its “Attachment Sleeve of its Trailing Sleeve Reinforcement Plate” (such as Attachment Sleeve 18B-S1, 18D-S1 or 18E-S1) can slide in the same Trailing End Cut (the Trailing End Cuts for a cone are shown and labeled as trailing end cuts 540-S6 in FIG. 112B of U.S. Pat. No. 8,628,439), in a manner so that Locking Ring Pin 18C-S3 can engage with its Trailing End Cut surface that prevents its Torque Transmitting Member from moving towards its Leading End Cut, so that Locking Ring Pin 18C-S3 can transfer torque in the direction that pulls from the Trailing End towards the Leading End of its cone; and preferably (but not necessarily) also prevents its Torque Transmitting Member from moving away from its Leading End. If necessary, some play between the “Attachment Sleeve of the Trailing Sleeve Reinforcement Plate” and its Trailing End Cut is allowed. And if there are interferences between the fastener of Locking Ring Pin 18C-S3 and the fastener of the “Attachment Sleeve of the Trailing Sleeve Reinforcement Plate”, then it is not necessary to use the fastener for the “Attachment Sleeve of the Trailing Sleeve Reinforcement Plate”.

Although this is not preferred, but if it is too impractical to place Attachment Sleeve 18B-S1, 18D-S1 or 18E-S1 and Locking Ring Pin 18C-S3 in the same Trailing End Cut; then Locking Ring Pin 18C-S3 and its Trailing End Reinforcement Plate 18C do not have to be used. For this configuration, Attachment Sleeve 18B-S1, 18D-S1 or 18E-S1 should be secured to its cone using a fastener.

The Leading End Cuts for a cone are shown and labeled as leading end cuts 540-S1 in FIG. 112B of U.S. Pat. No. 8,628,439. For a said cone that uses a Torque Transmitting Member of this section, the Leading End Cuts are used to insert the Attachment Sleeves of a Leading End Reinforcement Plate.

The proper location of the “Attachment Sleeve of the Trailing Sleeve Reinforcement Plate” relative to Locking Ring Pin 18C-S3 as well as the shape and size of all cuts on a cone can be determined through trial-and-error and experimentation (such as tracing for example).

A Torque Transmitting Member of this section, which is labeled as Torque Transmitting Member 19, is shown in FIGS. 78 to 83. It comprises of a Torque Transmitting Member Section 19-M1 and a Leveling Extension 19-M2. The purpose of Leveling Extension 19-M2 is to provide a base of for Teeth 17-S1 of Transmission Belt 17.

When assembled on its cone, Leveling Extension 19-M2 is inserted into its Non-Torque Transmitting Member from which it will telescope in-and-out as the transmission diameter of its cone is changed. The previous sentence applies to a “Cone with One Torque Transmitting Member”, if a “Cone with Two Opposite Torque Transmitting Members” is used, then when assembled on its cone, Leveling Extension 19-M2 is inserted into the Torque Transmitting Member 19 that is positioned opposite of its Torque Transmitting Member 19, from which it will telescope in-and-out as the transmission diameter of its cone is changed.

Torque Transmitting Member Section 19-M1 comprises of a Leading End Reinforcement Plate 18A, a Trailing Sleeve Reinforcement Plate 18B, a Trailing End Reinforcement Plate 18C, and several Reinforcement Plates 18 that are joined together by two Reinforcement Wires 20 and encased by elastomer members as shown in FIGS. 78 to 83 and as described below.

Between all teeth of the reinforcement plates, an elastomer Belt Resting Section 19-M1-S1 is fixed (see FIGS. 79 and 80). Belt Resting Section 19-M1-S1 is used to provide a resting place for Transmission Belt 17 and its Flanges 17-S2 on Torque Transmitting Member 19.

It is recommended that Transmission Belt 17 has Teeth 17-S1 that can wedge into the teeth their Torque Transmitting Member Section 19-M1. Through this wedging action the teeth of Torque Transmitting Member Section 19-M1 will also support Transmission Belt 17; so that if desired, Belt Resting Section 19-M1-S1 can be omitted.

If Belt Resting Sections 19-M1-S1 prevent Teeth 17-S1 from properly wedging into the teeth of Torque Transmitting Member Section 19-M1, then Belt Resting Sections 19-M1-S1 should be redesigned or omitted. And if the Tooth Ends (such as Tooth Ends 18-S2 of Reinforcement Plate 18) of Torque Transmitting Member Section 19-M1 prevent Teeth 17-S1 from properly wedging into the teeth of Torque Transmitting Member Section 19-M1, then Tooth Ends 18-S2 should be redesigned, such as by removing the interfering surfaces for example.

A partial cross-section of Torque Transmitting Member Section 19-M1 as cut per FIG. 78 is shown in FIG. 81; the only item not shown in FIG. 81 is Belt Resting Section 19-M1-S1, since Belt Resting Sections 19-M1-S1 are not part of a continues elastomer member that joins the reinforcement plates of Torque Transmitting Member Section 19-M1 along its length (from front to rear). The elastomer portions of said cross-section (which are sections of elastomer members) and the Reinforcement Wires 20 are shown in hatching; these left side (labeled as Left Elastomer Member 19-M1-S2) and right side (labeled as Right Elastomer Member 19-M1-S3) elastomer members join the reinforcement plates of Torque Transmitting Member Section 19-S1 along its length.

Left Elastomer Member 19-M1-S2 and Right Elastomer Member 19-M1-S3, which are shown in hatching in FIG. 81, run through the entire length of Torque Transmitting Member Section 19-M1, except for the rear-end (see FIG. 79).

The rear-end of Torque Transmitting Member Section 19-M1, which is shown as a sectional-view in FIG. 82, has a different cross-section than the rest of Torque Transmitting Member Section 19-M1, this is because Leveling Extension 19-M2 needs to be attached to it. The elastomer portion of this cross-section (which is labeled as Rear Elastomer Member 19-M1-S4) and the Reinforcement Wires 20 are shown in hatching. Rear Elastomer Member 19-M1-S4 is also shown in FIGS. 78 and 79. If instead of Leveling Extensions, a Leveling Loop that can expand and contract is used, then this cross-section as well as Leveling Extension 19-M2 are not needed.

FIG. 82 also shows a Transmission Belt 17 which is currently not engaged with its Torque Transmitting Member Section 19-M1. When engaged, the Teeth 17-S1 of Transmission Belt 17 are inside of the Teeth of Torque Transmitting Member Section 19-M1 (FIG. 82 shows a tooth of Torque Transmitting Member Section 19-M1, which is labeled as Tooth 18C-S1); and Flanges 17-S2 of Transmission Belt 17 are resting on the Tooth Ends of Torque Transmitting Member Section 19-M1 (FIG. 82 shows two Tooth Ends of Torque Transmitting Member Section 19-M1, which are labeled as Tooth Ends 18C-S5).

A rear-view of Leveling Extension 19-M2 is shown in FIG. 83. In its assembled state, Leveling Extension 19-M2 will be inserted into a Non-Torque Transmitting Member Section 22-M1 (described in the paragraphs below) or a Torque Transmitting Member Section 19-M1 of the Torque Transmitting Member 19 that is positioned opposite of its Torque Transmitting Member 19.

Leveling Extension 19-M2 has a Locking Ring Pin 19-M2-S1. Locking Ring Pin 19-M2-S1 is used to secure the rear-end of Leveling Extension 19-M2 to its cone using fasteners such as a Dome Shaped Nut or Ball Clamp (which is preferred) for example, and a Locking Ring. The shape and size of the cut for Locking Ring Pin 19-M2-S1 on its cone can be determined through trial-and-error and experimentation (such as tracing for example).

The Non-Torque Transmitting Member of this section has two separate elastomer side members that are joined at the leading end and trailing end (see FIG. 98 for a top-view and FIG. 100 for a sectional-view of said two separate elastomer side members). One elastomer side member has Reinforcement Plates 21-M1 and a Trailing Sleeve Reinforcement Plate 21B (see FIG. 98); and the other elastomer side member has Reinforcement Plates 21-M2 (see FIG. 98). The two sides are then joined at the leading end and trailing end using Leading End Reinforcement Plate 21A and Trailing End Reinforcement Plate 21C (see FIG. 98).

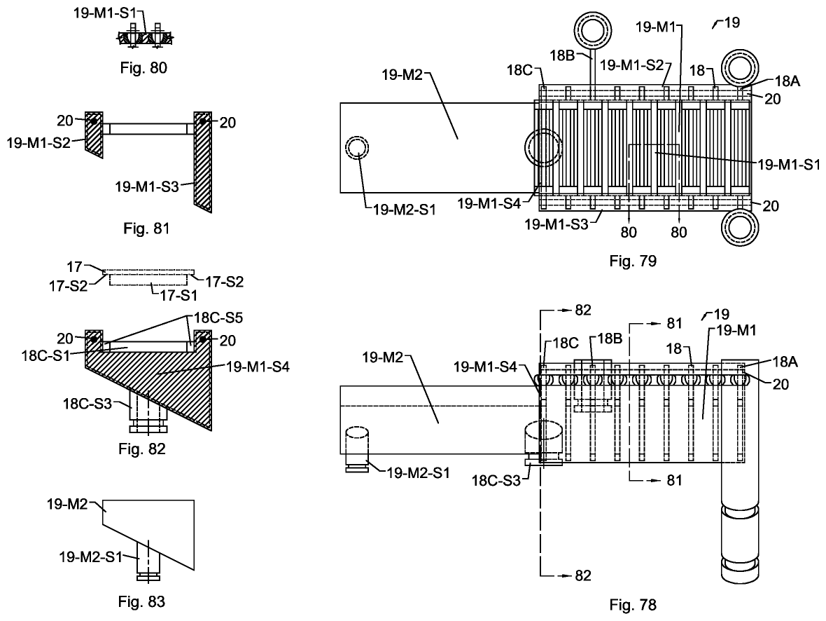

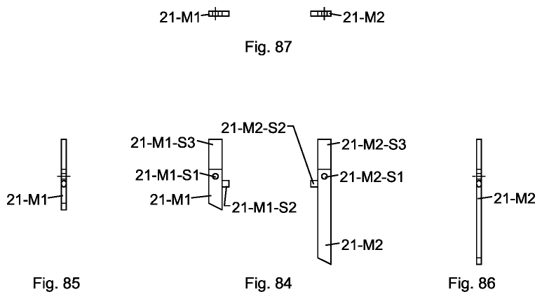

A Reinforcement Plate 21-M1 and a Reinforcement Plate 21-M2 are shown in FIGS. 84 to 87. Reinforcement Plate 21-M1 has a Hole 21-M1-S1, and Reinforcement Plate 21-M2 has a Hole 21-M2-S1; these holes are for the reinforcement wires of its Non-Torque Transmitting Member; these holes should be located so that the bending-axis of its Non-Torque Transmitting Member coincides with the bending-axis of its transmission belt.

Reinforcement Plate 21-M1 also has a Rail Reinforcement 21-M1-S2, and Reinforcement Plate 21-M2 also has a Rail Reinforcement 21-M2-S2. Rail Reinforcements 21-M1-S2 and 21-M2-S2 are used as reinforcements for rails that are used to hold-in-place and guide the Leveling Extension that is inserted into its Non-Torque Transmitting Member and used to provide a resting place for Flanges 17-S2 of Transmission Belt 17 (see FIG. 103).

In addition, in order to prevent excessive vibration due to centrifugal forces, it is recommended that each “Reinforcement Plate Pair” or “Reinforcement Plate” of a Non-Torque Transmitting Member has the same weight as the corresponding (oppositely positioned) Reinforcement Plate of its Torque Transmitting Member; so that the centrifugal forces of the Torque Transmitting Member and Non-Torque Transmitting Member cancel each other out. For this purpose Reinforcement Plate 21-M1 also has a Balancing Weight 21-M1-S3, and Reinforcement Plate 21-M2 also has a Balancing Weight 21-M2-S3. These Balancing Weights are not necessary if other means for balancing the weight of the Reinforcement Plates are used; such as through the selection of material, adjusting the thickness of the plates, etc.

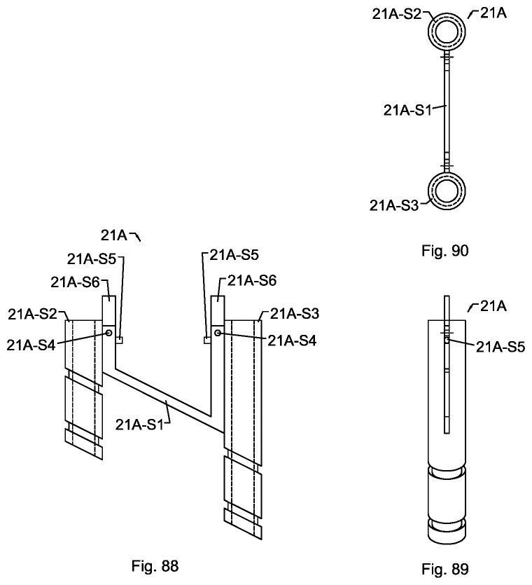

Leading End Reinforcement Plate 21A is shown in FIGS. 88 to 90. It has two vertical sides and an angled Base 21A-S1. When attached to its cone, Base 21A-S1 is positioned beneath the surface of its cone so that it is not in the way of the Leveling Extension that is inserted into its Non-Torque Transmitting Member, which is resting on the surface of its cone.

In addition, Attachment Sleeves are attached to the sides of Leading End Reinforcement Plate 21A; these Attachment Sleeves are labeled as Attachment Sleeves 21A-S2 and 21A-S3.

Attachment Sleeves 21A-S2 and 21A-S3 are used to attach the Leading End of a Non-Torque Transmitting Member to a torque transmitting member carriage 550A of a front pin belt cone assembly 520A of U.S. Pat. No. 8,628,439; using the same method the sleeves of the leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

Leading End Reinforcement Plate 21A also has two Holes 21A-S4; these holes are for the reinforcement wires of its Non-Torque Transmitting Member; these holes should be located so that the bending-axis of its Non-Torque Transmitting Member coincides with the bending-axis of its transmission belt.

Leading End Reinforcement Plate 21A also has two Rail Reinforcements 21A-S5. Rail Reinforcements 21A-S5 are used as reinforcements for rails that are used to hold-in-place and guide the Leveling Extension that is inserted into its Non-Torque Transmitting Member and used to provide a resting place for Flanges 17-S2 of Transmission Belt 17 (see FIG. 103).

In addition, in order to prevent excessive vibration due to centrifugal forces, it is recommended that each “Reinforcement Plate Pair” or “Reinforcement Plate” of a Non-Torque Transmitting Member has the same weight as the corresponding (oppositely positioned) Reinforcement Plate of its Torque Transmitting Member; so that the centrifugal forces of the Torque Transmitting Member and Non-Torque Transmitting Member cancel each other out. For this purpose Leading End Reinforcement Plate 21A also has a Balancing Weights 21A-S6. These Balancing Weights are not necessary if other means for balancing the weight of the Reinforcement Plates are used; such as through the selection of material, adjusting the thickness of the plates, etc.

FIGS. 91 to 93 show a Trailing Sleeve Reinforcement Plate 21B. Trailing Sleeve Reinforcement Plate 21B is identical to Reinforcement Plate 21-M1, except that it has an Attachment Sleeve, which is labeled as Attachment Sleeve 21B-S1, attached to it. The bottom end of Attachment Sleeve 21B-S1 has a Locking Ring Groove 21B-S2, which is used to secure Attachment Sleeve 21B-S1 to its cone by sliding a fastener such as a Dome Shaped Nut or a Ball Clamp (which is preferred) into Attachment Sleeve 21B-S1, and securing the fastener by inserting a Locking Ring into Locking Ring Groove 21B-S2.

Attachment Sleeve 21B-S1 is used to connect its Non-Torque Transmitting Member to its Trailing End Slide; using the same method used in U.S. Pat. No. 8,628,439 to connect the trailing end of a pin belt torque transmitting member 590 to its trailing end slide 565-S1 (see FIGS. 91A, 91B, 92A, 92B, 93 to 99). If necessary for alignment with Locking Ring Pin 21C-S3 in their Trailing End Cut (see paragraphs below for details), Attachment Sleeve 21B-S1 can be positioned behind or in-front of its Reinforcement Plate; in the same manner as Attachment Sleeve 18B-S1 can be positioned behind or in-front of its Reinforcement Plate (see FIGS. 69 to 74).

FIGS. 94 to 96 show a Trailing End Reinforcement Plate 21C. Trailing End Reinforcement Plate 21C is shaped like a flat plate that as a Cut-out Section 21C-S1 shaped on it. When its Non-Torque Transmitting Member is encased in elastomer (such as rubber, polyurethane, viton, etc.), the base of the elastomer that is covering Cut-out Section 21C-S1 will provide a level resting base for Teeth 17-S1 of Transmission Belt 17, and the sides of the elastomer that is covering Cut-out Section 21C-S1 are used to maintain the lateral alignment of Transmission Belt 17 within Trailing End Reinforcement Plate 21C (see FIG. 104).

Trailing End Reinforcement Plate 21C also has two holes 21C-S2; these holes are for the reinforcement wires of its Non-Torque Transmitting Member; these holes should be located so that the bending-axis of its Non-Torque Transmitting Member coincides with the bending-axis of its Transmission Belt 17.

In addition, Trailing End Reinforcement Plate 21C also has a Locking Ring Pin 21C-S3. Locking Ring Pin 21C-S3 is used to secure the Trailing End of its Non-Torque Transmitting Member to its cone by sliding a fastener such as a Dome Shaped Nut or a Ball Clamp (which is preferred) into Locking Ring Pin 21C-S3, and securing the fastener by inserting a Locking Ring into Locking Ring Groove 21C-S5 of Locking Ring Pin 21C-S3.

In order to prevent excessive vibration due to centrifugal forces, it is recommended that each “Reinforcement Plate Pair” or “Reinforcement Plate” of a Non-Torque Transmitting Member has the same weight as the corresponding (oppositely positioned) Reinforcement Plate of its Torque Transmitting Member; so that the centrifugal forces of the Torque Transmitting Member and Non-Torque Transmitting Member cancel each other out. For this purpose Trailing End Reinforcement Plate 21C also has a Balancing Weights 21C-S4. These Balancing Weights are not necessary if other means for balancing the weight of the Reinforcement Plates are used; such as through the selection of material, adjusting the thickness of the plates, etc.

Preferably, the Non-Torque Transmitting Member using Trailing Sleeve Reinforcement Plate 21B and Trailing End Reinforcement Plate 21C is designed so that its Locking Ring Pin 21C-S3 and its Attachment Sleeve 21B-S1 can slide in the same Trailing End Cut, in a manner so that Locking Ring Pin 21C-S3 can engage with its Trailing End Cut surface that prevents its Non-Torque Transmitting Member from moving towards its Leading End Cut, so that Locking Ring Pin 21C-S3 can transfer torque in the direction that pulls from the Trailing End towards the Leading End of its cone; and to a lesser preferable extent, also so as to prevents its Non-Torque Transmitting Member from moving away from its Leading End. If necessary, some play between Attachment Sleeve 21B-S1 and its Trailing End Cut is allowed. And if there are interferences between the fastener of Locking Ring Pin 21C-S3 and the fastener of Attachment Sleeve 21B-S1, then it is not necessary to use the fastener of Attachment Sleeve 21B-S1.

Although this is not preferred, but if it is too impractical to place Attachment Sleeve 21B-S1 and Locking Ring Pin 21C-S3 in the same Trailing End Cut; then Locking Ring Pin 21C-S3 and its Trailing End Reinforcement Plate 21C do not have to be used. For this configuration, Attachment Sleeve 21B-S1 should be secured to its cone using a fastener.

The proper location of Attachment Sleeve 21B-S1 relative to Locking Ring Pin 21C-S3 as well as the shape and size of all cuts on a cone can be determined through trial-and-error and experimentation (such as tracing for example).

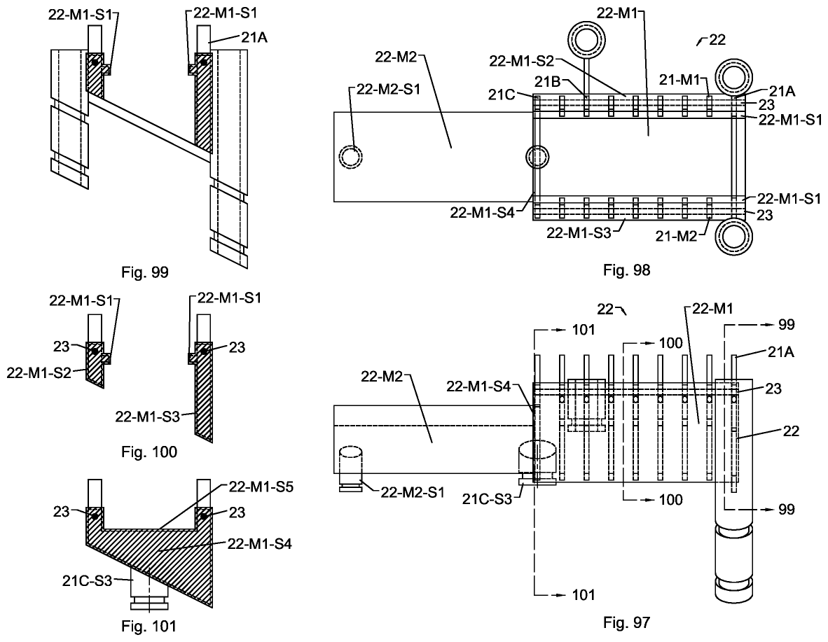

A Non-Torque Transmitting Member of this section, which is labeled as Non-Torque Transmitting Member 22, is shown in FIGS. 97 to 104. It comprises of a Non-Torque Transmitting Member Section 22-M1 and a Leveling Extension 22-M2. The purpose of Leveling Extension 22-M2 is to provide a base of for Teeth 17-S1 of Transmission Belt 17.

In its assembled state, Leveling Extension 22-M2 is inserted into its Torque Transmitting Member from which it will telescope in-and-out as the transmission diameter of its cone is changed. The purpose of Leveling Extension 22-M2 is to provide a base of for Teeth 17-S1 of Transmission Belt 17.

When assembled on its cone, Leveling Extension 22-M2 is inserted into its Torque Transmitting Member from which it will telescope in-and-out as the transmission diameter of its cone is changed.

The Non-Torque Transmitting Member of this section has two separate elastomer side members that are joined at the leading end and trailing end (see FIG. 98 for a top-view and FIG. 100 for a sectional-view). One elastomer side member has Reinforcement Plates 21-M1 and a Trailing Sleeve Reinforcement Plate 21B (see FIG. 98); and the other elastomer side member has Reinforcement Plates 21-M2 (see FIG. 98). The two sides are then joined at the leading end and trailing end using Leading End Reinforcement Plate 21A and Trailing End Reinforcement Plate 21C (see FIG. 98). Each elastomer side member has a Reinforcement Wire 23.

A cross-section of Non-Torque Transmitting Member Section 22-M1 is shown in FIG. 100. In FIG. 100, the elastomer portions of said cross-section (which are sections of elastomer members) and the Reinforcement Wires 23 are shown in hatching. The left side elastomer member (labeled as Left Elastomer Member 22-M1-S2), “encases in elastomer”, and as such joins, the left side of Leading End Reinforcement Plate 21A, Reinforcement Plates 21-M1, Trailing Sleeve Reinforcement Plate 21B, and the left side of Trailing End Reinforcement Plate 21C (see FIG. 98). The right side elastomer member (labeled as Right Elastomer Member 22-M1-S3), “encases in elastomer”, and as such joins, the right side of Leading End Reinforcement Plate 21A, Reinforcement Plates 21-M2, and the right side of Trailing End Reinforcement Plate 21C (see FIG. 98).

The cross-section of Non-Torque Transmitting Member Section 22-M1 shown in FIG. 100 also has two Male Rails 22-M1-S1, which are shown in hatching, and as such are encased in elastomer. The bottom surfaces of Male Rails 22-M1-S1 are used to guide the Leveling Extension of its Torque Transmitting Member (which is inserted into Non-Torque Transmitting Member Section 22-M1). And the top surfaces of Male Rails 22-M1-S1 are used to provide a resting place for Flanges 17-S2 of Transmission Belt 17. As according to the previous sentences of this paragraph, FIG. 103 shows the cross-section of FIG. 100, with the Leveling Extension of its Torque Transmitting Member (which is labeled as Leveling Extension 19-M2) and its Transmission Belt 17.

The cross-section shown in FIG. 100 (which is used to provide support for Flanges 17-S2 of Transmission Belt 17 and guide the Leveling Extension inserted into it) runs through the entire length of Non-Torque Transmitting Member Section 22-M1, except for the rear-end. Although the cross-section of Non-Torque Transmitting Member Section 22-M1 cut-through Leading End Reinforcement Plate 21A is also not identical, the “elastomer in-cased portions” of this cross-section (which are used to provide support for Flanges 17-S2 of Transmission Belt 17 and guide their Leveling Extension inserted into them) are identical. FIG. 99, shows a cross-section of Non-Torque Transmitting Member Section 22-M1 that is cut near Leading End Reinforcement Plate 21A.

The rear-end of Non-Torque Transmitting Member Section 22-M1, which is shown in FIG. 101, has a different cross-section than the rest of Non-Torque Transmitting Member Section 22-M1, this is because Leveling Extension 22-M2 needs to be attached to it. The elastomer portion of this cross-section (which is labeled as Rear Elastomer Member 22-M1-S4) and the Reinforcement Wires 23 are shown in hatching.

Rear Elastomer Member 22-M1-S4, shown in FIG. 101, has a Transmission Belt Base 22-M1-S5, which is used to provide a base for Teeth 17-S1 of Transmission Belt 17. As according to the previous sentence, FIG. 104 shows the cross-section of FIG. 101, with its Transmission Belt 17. For FIGS. 101 and 104, “the elastomer in-cased portions of the cross-sections shown” and “the Reinforcement Wires 23” are shown in hatching. If instead of Leveling Extensions, a Leveling Loop that can expand and contract is used, then this cross-section shown in FIG. 101 as well as Leveling Extension 22-M2 are not needed.

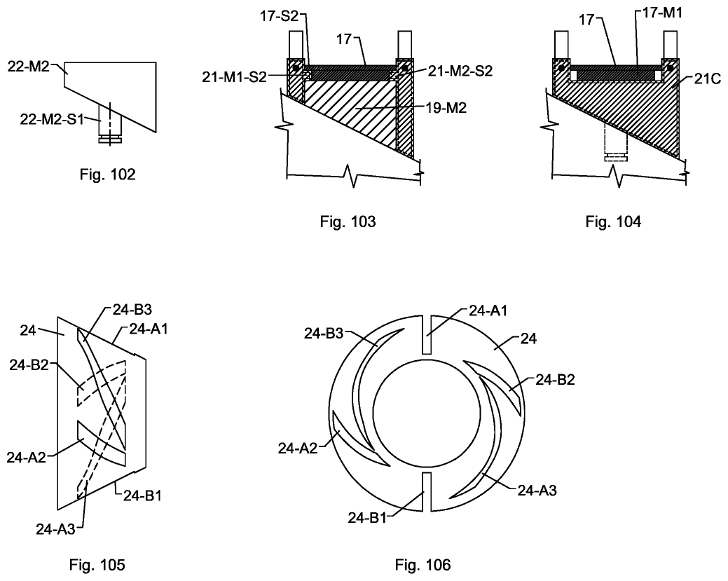

A rear-view of Leveling Extension 22-M2 is shown in FIG. 102. In its assembled state, Leveling Extension 22-M2 will be inserted into Transmitting Member Section 19-M1. Leveling Extension 22-M2 has a Locking Ring Pin 22-M2-S1. Locking Ring Pin 22-M2-S1 is used to secure the rear-end of Leveling Extension 22-M2 to its cone using fasteners such as a Dome Shaped Nut or Ball Clamp (which is preferred) for example, and a Locking Ring. The shape and size of the cut for Locking Ring Pin 22-M2-S1 on its cone can be determined through trial-and-error and experimentation (such as tracing for example).

Cone for Usage with Torque Transmitting Member 19 and Non-Torque Transmitting Member 22 (FIGS. 105 and 106)

FIGS. 105 and 106 show a Cone 24 that can be used with a Torque Transmitting Member 19 and Non-Torque Transmitting Member 22, described in the previous section.

For Torque Transmitting Member 19, Cone 24 has the following cuts: a) Torque Transmitting Member Leading End Cut 24-A1, into which the sleeves of Leading End Reinforcement Plate 18A are inserted; b) Torque Transmitting Member Trailing End Cut 24-A2 (into which Locking Ring Pin 18C-S3 and Attachment Sleeve 18B-S1, 18D-S1, or 18E-S1 are inserted; and c) Torque Transmitting Member Leveling Extension Cut 24-A3, into which Locking Ring Pin 19-M2-S1 is inserted.

For Non-Torque Transmitting Member 22, Cone 24 (see FIGS. 105 and 106) has the following cuts: a) Non-Torque Transmitting Member Leading End Cut 24-1, into which the sleeves of Leading End Reinforcement Plate 21A are inserted; b) Non-Torque Transmitting Member Trailing End Cut 24-B2 (into which Locking Ring Pin 21C-S3 and Attachment Sleeve 21B-S1 are inserted); and c) Non-Torque Transmitting Member Leveling Extension Cut 24-B3, into which Locking Ring Pin 22-M2-S1 is inserted.

The cuts shown in FIGS. 105 and 106 are not to scale and are not accurately drawn, but they represent the actual relative positions (between cuts) where they should be located. Somebody skilled in the art should be able to determine the accurate shape of the cuts through tracing, mathematics, etc.

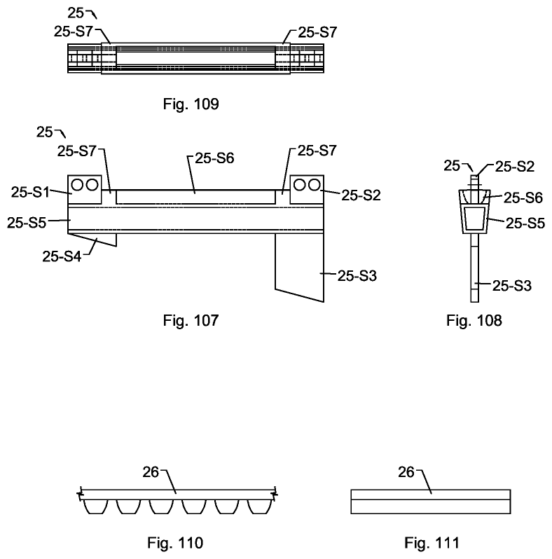

Torque Transmitting Member with Teeth have a Bottom Surface (Base) (FIGS. 107 to 122)

The Torque Transmitting Member 31 described in this section can be used with a Cone 38 described in the “Leveling Extension Raising Sheets” section below.

A Reinforcement Plate for a “Torque Transmitting Member for which its teeth have a bottom surface or Base” is shown in FIGS. 107 to 109, where it is labeled as Reinforcement Plate 25.

Reinforcement Plate 25 is basically identical to Reinforcement Plate 18 of Torque Transmitting Member 19, except that it has a Base. Reinforcement Plate 25 is much preferred over Reinforcement Plate 18, since its Base will increase the strength of its tooth considerably.

The problem with having a Base is that because the Base has some thickness, “the top surface of its Leveling Extension (which is positioned beneath said Base)” and “the bottom surface of the tooth of its Reinforcement Plate” will have different heights. Since both surfaces are used to provide a resting base for the bottom surfaces of the teeth of their Transmission Belt, here the bottom surfaces of the teeth of their Transmission Belt will be resting on surfaces of different height. This problem is addressed in the “Leveling Extension Raising Sheets” and “Cone with Leveling Extension Raising Surfaces” sections below.

Reinforcement Plate 25 is shown in FIGS. 107 to 109. It is shaped like a flat plate for which shapes are added and removed. The flat plate covers the following shapes of Reinforcement Plate 25: Left Reinforcement Wires Holes Plate 25-S1, Right Reinforcement Wires Holes Plate 25-S2, Right Leg 25-S3, and Left Leg 25-S4. The empty space between Left Leg 25-S4 and Right Leg 25-S3 is used for the insertion of a Leveling Extension. And Left Reinforcement Wires Holes Plate 25-S1 and Right Reinforcement Wires Holes Plate 25-S2, each have two Reinforcement Wire Holes.

Added to the flat plate are the following shapes: a Tooth 25-S6, Tooth Ends 25-S7, and a Base 25-S5. Tooth 25-S6 and Tooth Ends 25-S7 are shaped similarly to Tooth 18-S1 and Tooth Ends 18-S2 of Reinforcement Plate 18, and have the same functions. And Base 25-S5 is shaped beneath Tooth 25-S6 as shown; for increased strength and reduced weight Base 25-S5 has the shape of a tube.

Reinforcement Plate 25 can be used with a Transmission Belt that has side flanges, such as Transmission Belt 17; or if desired, Reinforcement Plate 25 can also be used with a regular commercially available Transmission Belt, such as a Transmission Belt 26, shown in FIGS. 110 and 111.

In order to attach a Torque Transmitting Member that uses Reinforcement Plates 25 to its cone, a Leading End Reinforcement Plate 25A (see FIG. 112), a Trailing Sleeve Reinforcement Plate 25B (see FIG. 113), and a Trailing End Reinforcement Plate 25C (see FIG. 114) can be used. Leading End Reinforcement Plate 25A, Trailing Sleeve Reinforcement Plate 25B, and Trailing End Reinforcement Plate 25C modify their Reinforcement Plate 25 in the same manner as, Leading End Reinforcement Plate 18A, Trailing Sleeve Reinforcement Plate 18B, and Trailing End Reinforcement Plate 18C modify their Reinforcement Plate 18. And Leading End Reinforcement Plate 25A, Trailing Sleeve Reinforcement Plate 25B, and Trailing End Reinforcement Plate 25C have the same functions as Leading End Reinforcement Plate 18A, Trailing Sleeve Reinforcement Plate 18B, and Trailing End Reinforcement Plate 18C.

FIG. 115 shows how Trailing Sleeve Reinforcement Plate 25B is attached to its Cone 27 by sliding a Dome Shaped Nut 28 into Attachment Sleeve 25B-S1 (see FIG. 113), and securing Dome Shaped Nut 28 by inserting a Locking Ring 29 into Locking Ring Groove 25B-S2 (see FIG. 113).

FIG. 116 shows how Trailing End Reinforcement Plate 25C is attached to its Cone 27 by sliding a Dome Shaped Nut 28 into Locking Ring Pin 25C-S3 (see FIG. 114), and securing Dome Shaped Nut 28 by inserting a Locking Ring 29 into Locking Ring Groove 25C-S4 (see FIG. 114).

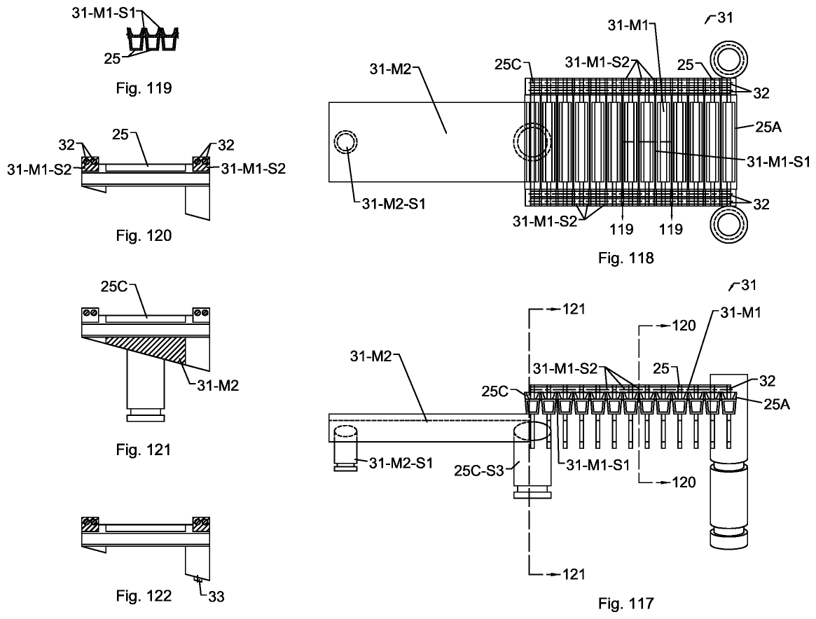

A “Torque Transmitting Member for which its teeth have a bottom surface (Base)” is shown in FIGS. 117 and 118, where it is labeled as Torque Transmitting Member 31. Torque Transmitting Member 31 comprises of a Torque Transmitting Member Section 31-M1 and a Leveling Extension 31-M2. It is basically identical to Torque Transmitting Member 19, except that its Teeth have a bottom surface or Base.

Torque Transmitting Member Section 31-M1 comprises of a Leading End Reinforcement Plate 25A, a Trailing End Reinforcement Plate 25C, and several Reinforcement Plates 25 that are joined together by four Reinforcement Wires 32. Positioned in between two Reinforcement Plates are Longitudinal Elastomer Members 31-M1-S2 (see FIGS. 117, 118, and 120). The purpose of Longitudinal Elastomer Members 31-M1-S2 is to maintain the proper distance and alignment of the Teeth of Torque Transmitting Member Section 31-M1.

Between all teeth of the Reinforcement Plates, a Lateral Elastomer Member 31-M1-S1 is fixed (see FIGS. 117, 118, and 119). Lateral Elastomer Members 31-M1-S1 are used to provide a resting place for its Transmission Belt. Since a Transmission Belt can also purely rests on its Teeth (which are supported by the Teeth of Torque Transmitting Member Section 31-M1), Lateral Elastomer Members 31-M1-S1 are not absolutely necessary.

The front-end of Leveling Extension 31-M2 is fixed/bonded to Trailing End Reinforcement Plate 25C (see FIG. 121). Leveling Extension 31-M2 has a Locking Ring Pin 31-M2-S1. Locking Ring Pin 31-M2-S1 is used to secure the rear-end of Leveling Extension 31-M2 to its cone by using fasteners such as a Dome Shaped Nut or Ball Clamp (which is preferred) for example, and a Locking Ring.

In order to help maintain the proper alignment/normality of a Reinforcement Plate, a Reinforcement Plate can have an Alignment Pin 33 (see FIG. 122), which slides in a slot (preferably non-penetrating) of its cone. The proper shape and dimension of said slot can be obtained through tracing, mathematics, etc.

Furthermore, Torque Transmitting Member Section 31-M1 does not use a Trailing Sleeve Reinforcement Plate 25B. Since here in order to maintain the axial alignment of the rear-end of Torque Transmitting Member Section 31-M1, the axial alignment of Locking Ring Pin 25C-S3 is maintained by using a Telescope of the “Telescopes for maintaining the normality and the axial position of two oppositely positioned Locking Ring Pins” section below.

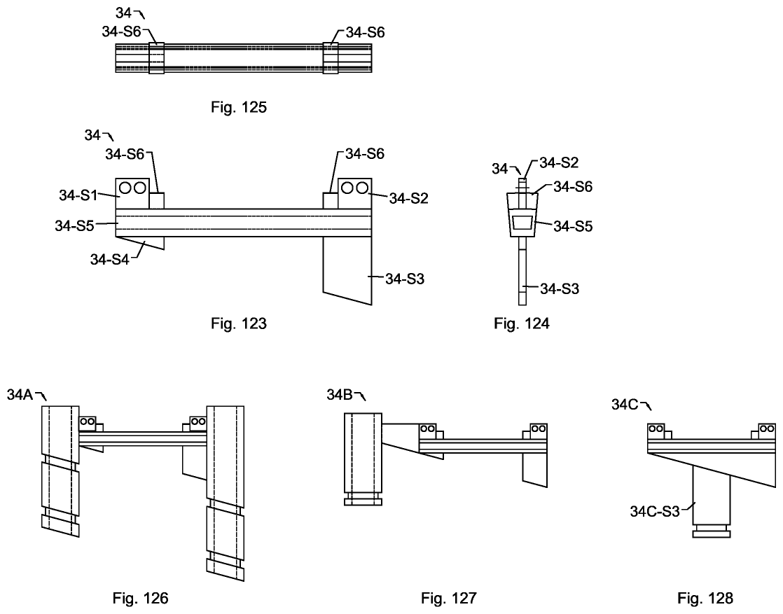

Non-Torque Transmitting Member that has a Bottom Surface for Teeth (Base) (FIGS. 123 to 133)

The Non-Torque Transmitting Member described in this section is to be used with Torque Transmitting Member 31 described in the previous section. In order to prevent excessive vibration due to centrifugal forces, it preferably has the same weight as its Torque Transmitting Member.

A Reinforcement Plate for a “Non-Torque Transmitting Member that has a bottom surface for teeth (Base)” is shown in FIGS. 123 to 125, where it is labeled as Reinforcement Plate 34.

Reinforcement Plate 34 is basically identical to Reinforcement Plates 21-M1 and 21-M2 of Non-Torque Transmitting Member 22, except that it has a Base, which joins the two Reinforcement Plate Pairs (comprising of Reinforcement Plates 21-M1 and 21-M2) into one Reinforcement Plate.

The problem with having a Base is that because the Base has some thickness, “the top surface of its Leveling Extension (which is positioned beneath said Base)” and “the top surface of said Base” will have different heights. Since both surfaces are used to provide a resting base for the bottom surfaces of the teeth of their Transmission Belt, here the bottom surfaces of the teeth of their Transmission Belt will be resting on surfaces of different height. This problem is addressed in the “Leveling Extension Raising Sheets” and “Cone with Leveling Extension Raising Surfaces” sections below.

Reinforcement Plate 34 is shown in FIGS. 123 to 125. It is shaped like a flat plate for which shapes are added and removed. The flat plate covers the following shapes of Reinforcement Plate 34: Left Reinforcement Wires Holes Plate 34-S1, Right Reinforcement Wires Holes Plate 34-S2, Right Leg 34-S3, and Left Leg 34-S4. The empty space between Left Leg 34-S4 and Right Leg 34-S3 is used for the insertion of a Leveling Extension. And Left Reinforcement Wires Holes Plate 34-S1 and Right Reinforcement Wires Holes Plate 34-S2, each have two Reinforcement Wire Holes.

Added to the flat plate are the following shapes: a Base 34-S5, and two Belt Flange Rests 34-S6. Base 25-S5 is shaped like lateral beam, which is used to support the teeth of its Transmission Belt; for increased strength and reduced weight Base 34-S5 has the shape of a tube. Belt Flange Rests 34-S6 are shaped on top of Base 34-S5 as shown; like Tooth Ends 25-S7, Belt Flange Rests 34-S6 can be used to provide a resting base for the flanges of a Transmission Belt that has flanges, such as Transmission Belt 17. If used with a Transmission Belt that does not have flanges, then Belt Flange Rests 34-S6 are not needed.

Reinforcement Plate 34 can be used with a Transmission Belt that has side flanges, such as Transmission Belt 17; or if desired, Reinforcement Plate 34 can also be used with a regular commercially available Transmission Belt, such as a Transmission Belt 26, shown in FIGS. 110 and 111.

In order to attach a Non-Torque Transmitting Member that uses Reinforcement Plates 34 to its cone, a Leading End Reinforcement Plate 34A (see FIG. 126), a Trailing Sleeve Reinforcement Plate 34B (see FIG. 127), and a Trailing End Reinforcement Plate 34C (see FIG. 128) can be used. Leading End Reinforcement Plate 34A, Trailing Sleeve Reinforcement Plate 34B, and Trailing End Reinforcement Plate 34C modify their Reinforcement Plate 34 in the same manner as, Leading End Reinforcement Plate 25A, Trailing Sleeve Reinforcement Plate 25B, and Trailing End Reinforcement Plate 25C modify their Reinforcement Plate 25. The purpose of the modifications for a Reinforcement Plate 34 is identical to the purpose of the same modifications for a Reinforcement Plate 25.

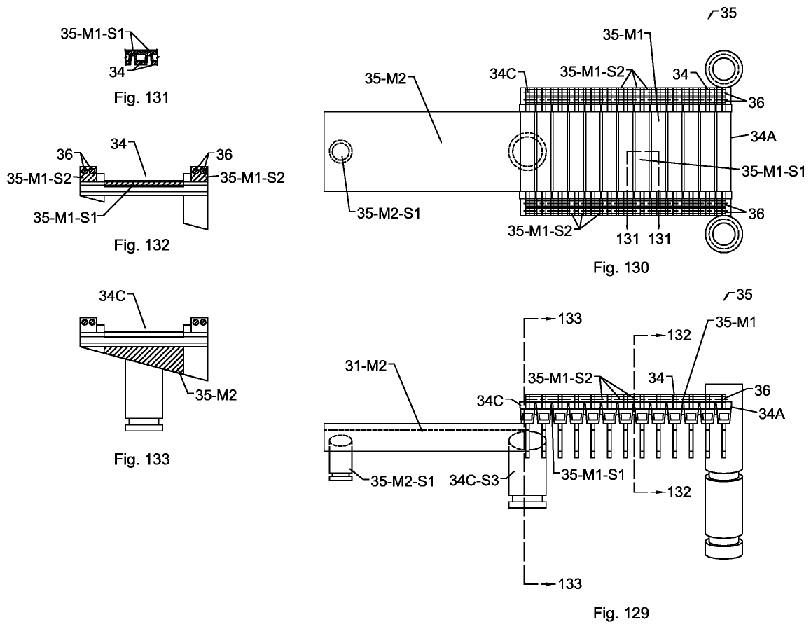

A “Non-Torque Transmitting Member that has a bottom surface for teeth (Base)” is shown in FIGS. 129 and 130, where it is labeled as Non-Torque Transmitting Member 35. Non-Torque Transmitting Member 35 comprises of a Non-Torque Transmitting Member Section 35-M1 and a Leveling Extension 35-M2. It is basically identical to Non-Torque Transmitting Member 22, except that it has a bottom surface for teeth (Base).

Non-Torque Transmitting Member Section 35-M1 comprises of a Leading End Reinforcement Plate 34A, a Trailing End Reinforcement Plate 34C, and several Reinforcement Plates 34 that are joined together by four Reinforcement Wires 36. Positioned in between two Reinforcement Plates are Longitudinal Elastomer Members 35-M1-S2 (see FIGS. 129, 130, and 132). The purpose of Longitudinal Elastomer Members 35-M1-S2 is to maintain the proper distance and alignment of the Reinforcement Plates of Non-Torque Transmitting Member Section 35-M1.

On top of the Bases of the Reinforcement Plates, a Non-Torque Transmitting Member Base Surface 35-M1-S1, which is made out an elastomer (flexible material), is fixed (see FIGS. 129, 130, and 131). It has a Top Surface Shape that extends from the Leading End to the Trailing End of Non-Torque Transmitting Member Section 35-M1. Beneath the Top Surface Shape, Gap Filler Shapes, which are positioned between the gaps of the Bases of the Reinforcement Plates, are shaped (see FIG. 131). Non-Torque Transmitting Member Base Surface 35-M1-S1 is used to provide a resting place for the Teeth its Transmission Belt.

The front-end of Leveling Extension 35-M2 is fixed/bonded to Trailing End Reinforcement Plate 34C (see FIG. 133). Leveling Extension 35-M2 has a Locking Ring Pin 35-M2-S1. Locking Ring Pin 35-M2-S1 is used to secure the rear-end of Leveling Extension 35-M2 to its cone by using fasteners such as a Dome Shaped Nut or Ball Clamp (which is preferred) for example, and a Locking Ring.

Furthermore, Non-Torque Transmitting Member Section 35-M1 does not use a Trailing Sleeve Reinforcement Plate 34B. Since here in order to maintain the axial alignment of the rear-end of Non-Torque Transmitting Member Section 35-M1, the axial alignment of Locking Ring Pin 34C-S3 (see FIGS. 128 and 129) is maintained by using a Telescope of the “Telescopes for maintaining the normality and the axial position of two oppositely positioned Locking Ring Pins” section below.

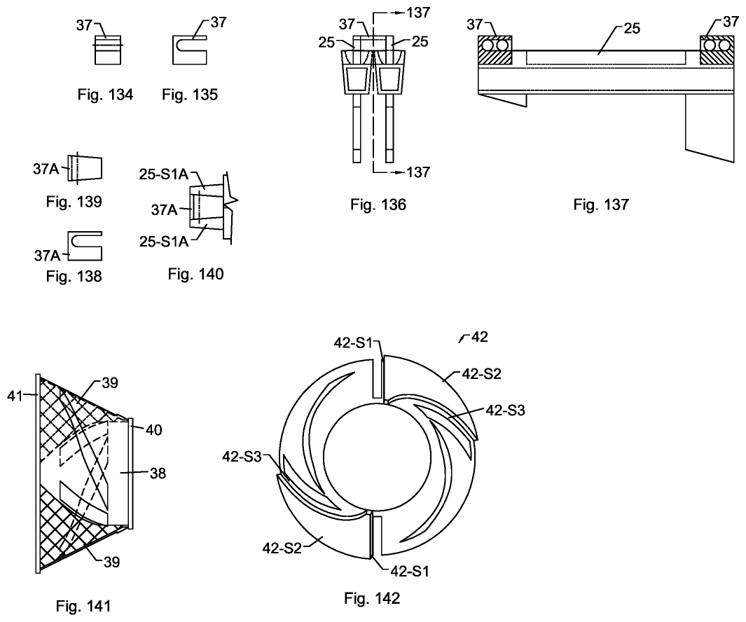

### Elastomer Inserts for Replacing Longitudinal Elastomer Members (FIGS. 134 to 140)

Described in this section are Elastomer Inserts that can be used to replace the Longitudinal Elastomer Members 31-M1-S2 of Torque Transmitting Member 31, and the Longitudinal Elastomer Members 35-M1-S2 of Non-Torque Transmitting Member 35.

An Elastomer Insert 37 is shown in FIGS. 134 and 135, it is shaped like an elastomer block that has a slot for the Reinforcement Wires of its Torque Transmitting Member 31 or Non-Torque Transmitting Member 35.

FIG. 136 shows a pair of Elastomers Insert 37 (only one Elastomer Insert 37 is visible) that are placed between two Reinforcement Plates 25, and FIG. 137 shows a sectional-view of FIG. 137, showing the Elastomers Inserts 37.

FIGS. 138 and 139 show an alternate Elastomer Insert 37A. Elastomer Insert 37A is identical to Elastomer Insert 37, except that it has tapered side surfaces. FIG. 140 shows two alternate Left Reinforcement Wires Holes Plates 25-S1A, which each are identical to a Left Reinforcement Wires Holes Plate 25-S1 except for being modified so that they each have a tapered back surface and a tapered front surface, instead of a flat back surface and a flat front surfaces; this modification makes it easier to bond the side surfaces of Elastomers Inserts 37A to the back and front surfaces of their Left Reinforcement Wires Holes Plates 25-S1A, and other similarly modified Reinforcement Wires Holes Plates.

Also for Torque Transmitting Member 31 and Non-Torque Transmitting Member 35, it is preferable that the Reinforcement Wires are bonded to their Reinforcement Plates (such as by soldering, clamping, etc.), so that the tension from the Reinforcement Wires are transferred directly to their Reinforcement Plates.

### Leveling Extension Raising Sheets (FIG. 141)

In order to be able to use a Torque Transmitting Member 31 and a Non-Torque Transmitting Member 35, which each have a Base; two Leveling Extension Raising Sheets 39 can be used.

FIG. 141 shows a Cone 38, which is identical to Cone 24 except for using two Leveling Extension Raising Sheets 39 (which are shown in hatching), a Sheet Attachment Disk 40, and a Sheet Attachment Disk 41. Note, the hatching of the upper positioned Leveling Extension Raising Sheet 39 is in hidden-lines; in order to show that this Leveling Extension Raising Sheet 39 is positioned behind the surface of its Cone 38, and as such hidden. The lower positioned Leveling Extension Raising Sheet 39 is positioned in-front of the surface of its Cone 38.

When Torque Transmitting Member 31 and a Non-Torque Transmitting Member 35 are assembled on Cone 38, the Leveling Extension Raising Sheets 39 are wrapping around Cone 38, in manner so that one Leveling Extension Raising Sheet 39 is resting on top of the Leveling Extension portion of its Torque Transmitting Member 31 and one Leveling Extension Raising Sheet 39 is resting on top of the Leveling Extension portion of its Non-Torque Transmitting Member 35, for all Transmission Diameters of their cone; so that the thickness of the Leveling Extension Raising Sheets 39 can compensate for the height of the Bases of Torque Transmitting Member 31 and Non-Torque Transmitting Member 35, so that the height of said Bases and the height of the surfaces of said Leveling Extension Raising Sheets 39 which are resting on said Leveling Extensions is equal or almost equal. This will provide level or almost level resting surfaces for the Teeth of their Transmission Belt. Leveling Extension Raising Sheets 39 should be able to flex so that they can rests level on top of their Leveling Extension portions.

For all Transmission Diameters, Leveling Extension Raising Sheets 39 should never cover their Torque Transmitting Member 31 or Non-Torque Transmitting Member 35, so that the Leveling Extension Raising Sheets 39 will never interfere with their Torque Transmitting Member 31 and Non-torque transmitting Member 35.

In order to attach Leveling Extension Raising Sheets 39 to Cone 38, Cone 38 has a Sheet Attachment Disk 40, and a Sheet Attachment Disk 41 fixed to it. To Sheet Attachment Disk 40, the right-ends of the Leveling Extension Raising Sheets 39 are attached by gluing, clamping, etc.; and to Sheet Attachment Disk 41, the left-ends of the Leveling Extension Raising Sheets 39 are attached by gluing, clamping, etc.

Cone with Leveling Extension Raising Surfaces (FIG. 142)

For designs where on a level surface the “Transmission Belt resting surfaces” of the Torque Transmitting Member(s) and/or the Non-Torque Transmitting Member(s) are taller than the “Transmission Belt resting surfaces” of its/their Leveling Extension(s), than Leveling Extension Raising Surface(s) can be shaped on the surface of a cone. This allows for usage of Torque Transmitting Members and Non-Torque Transmitting Members that have a base. The Cone 42 described in this section can be used with Torque Transmitting Member(s) 43 and Non-Torque Transmitting Member 46 described in the section below.

Shown in FIG. 142 is a Cone 42, which identical to Cone 24 except that it has two oppositely positioned Extension Raising Surfaces 42-S2. Extension Raising Surfaces 42-S2 are raised surfaces on the surfaces of Cone 42. Ideally, Extension Raising Surfaces 42-S2 are shaped so that they can raise the maximum lengths of their Leveling Extensions, while not interfering with their Torque Transmitting Member(s) or Non-Torque Transmitting Member. For this simple trial-and-error or geometry can be used.

The height of Extension Raising Surfaces 42-S2 should be selected so that the “resting surfaces for the Transmission Belt Teeth” of its Torque Transmitting Member Section 43-M1 or its Non-Torque Transmitting Member Section 46-M1 (see section below), matches or almost matches “the height of the top-surface of Leveling Extensions 43-M2 and 46-M2 that are resting on Extension Raising Surfaces 42-S2”.

Each Extension Raising Surface 42-S2 has a Leveling Extension Ramp Clearance 42-S1 and a Member Width Clearance 42-S3.

Each Leveling Extension Ramp Clearance 42-S1 is located between the location where its Leveling Extension enters-and exits its Torque Transmitting Member 43 or its Non-Torque Transmitting Member 46 and the adjacent edge of its Extension Raising Surface 42-S2. Leveling Extension Ramp Clearance 42-S1 is for a Leveling Extension Ramp 44 described below.

Each Member Width Clearance 42-S3 is located between the Trailing End of its Torque Transmitting Member 43 or its Non-Torque Transmitting Member 46 and the adjacent edge of its Extension Raising Surfaces 42-S2. The purpose of Member Width Clearance 42-S3 is to ensure that the width of its Torque Transmitting Member 43 or its Non-Torque Transmitting Member 46 will not interfere with its Extension Raising Surfaces 42-S2.

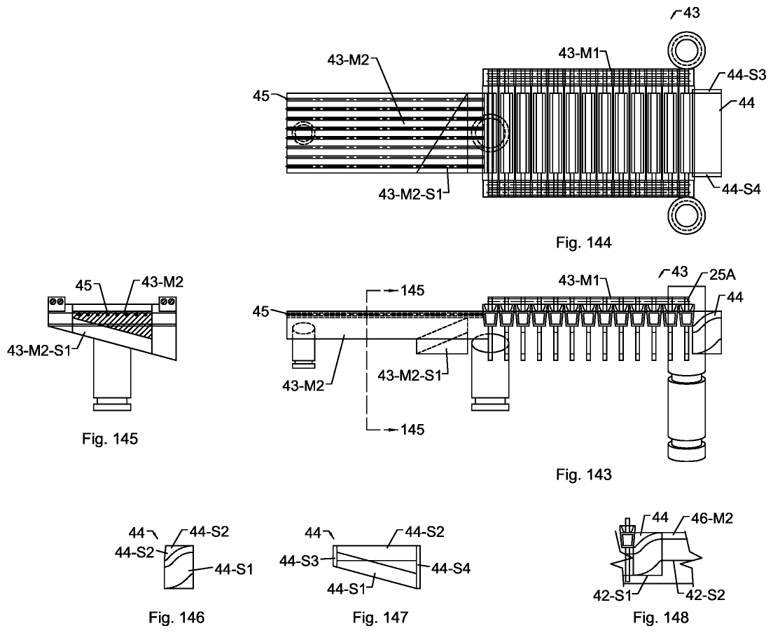

Torque Transmitting Member and Non-Torque Transmitting Member for Cone with Leveling Extension Raising Surfaces (FIGS. 143 to 151)

Described in this section is a Torque Transmitting Member 43 and Non-Torque Transmitting Member 46 that can be used with a Cone 42 described in the previous section.

Torque Transmitting Member 43 is shown in FIGS. 143 and 144; it is identical to Torque Transmitting Member 31 described previously, except for the following: a) a Leveling Extension Ramp 44 is fixed to its Leading Reinforcement Plate 25A (which is the Reinforcement Plate through which a Leveling Extension enters and exits Torque Transmitting Member 43); b) its Leveling Extension (which here is labeled as Leveling Extension 43-M2) is attached so that its top-surface is level with the “resting surfaces for the Transmission Belt Teeth of its Torque Transmitting Member Section (which here is labeled as Torque Transmitting Member Section 43-M1)”; c) its Leveling Extension has Reinforcement Wires 45, so that the Neutral-Axis of said Leveling Extension is almost equal across its width; and d) its Leveling Extension has a Member Width Clearance Support 43-M2-S1.

Regarding item a), Leveling Extension Ramp 44 (which is shown in FIGS. 143 to 148) has a Ramp 44-S1, which is used to guide the “Leveling Extension inserted into Torque Transmitting Member 31” to Extension Raising Surface 42-S2 (see FIG. 148). In addition, Leveling Extension Ramp 44 also has a Leveling Extension Gap Filler 44-S2, which is used to fill the gap that is formed due to the bending of the “Leveling Extension inserted into Torque Transmitting Member 31” as it exists Torque Transmitting Member 31. Ramp 44-S1 and Leveling Extension Gap Filler 44-S2 are held together by Sidewalls 44-S3 and 44-S4. The shape of Ramp 44-S1 and Leveling Extension Gap Filler 44-S2 can be determined through experimentation, by bending and inserting a Leveling Extension into Torque Transmitting Member 31.

FIG. 148 shows how Leveling Extension Ramp 44 is positioned on Leveling Extension Ramp Clearance 42-S1 so as to guide the “Leveling Extension inserted into Torque Transmitting Member 31 (which here is Leveling Extension 46-M2)” from an unraised surface of its Cone 42 to Extension Raising Surface 42-S2. Leveling Extension Ramp 44 should be able to bend/flex as required as the diameter of the conical surface where it is positioned is changed. In FIG. 148, Leveling Extension Ramp 44 is positioned on a conical surface of infinite diameter (straight surface), because of time limitations.

Regarding item d), Member Width Clearance Support 43-M2-S1 (which is shown in FIGS. 143 to 145) is shaped on the bottom surface of Leveling Extension 43-M2. Ideally, it should be shaped so that it can support its Leveling Extension 43-M2 as much as possible on the surface of Cone 42 that is not covered by Extension Raising Surface 42-S2, without interfering with Extension Raising Surface 42-S2 for all transmission diameters of Cone 42. The ideal shape of Member Width Clearance Support 43-M2-S1 can be determined through experimentation.

Member Width Clearance Support 43-M2-S1 is useful because of the required Member Width Clearances 42-S3 (without a Member Width Clearance 42-S3, the tail-end of Torque Transmitting Member Section 43-M1 will interfere with the Extension Raising Surface 42-S2 adjacent to it).

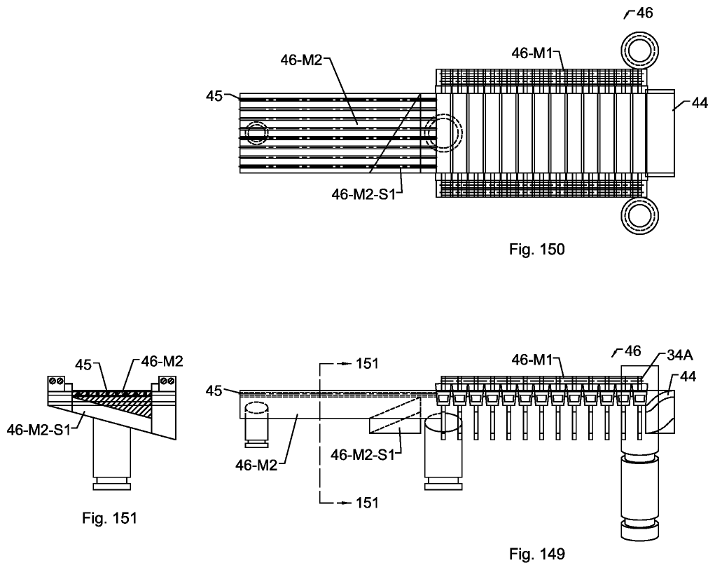

Non-Torque Transmitting Member 46 is shown in FIGS. 149 and 151; it is identical to Non-Torque Transmitting Member 35 described previously, except for the following: a) a Leveling Extension Ramp 44 is fixed to its Leading Reinforcement Plate 34A (which is the Reinforcement Plate through which a Leveling Extension enters and exits Non-Torque Transmitting Member 46); b) its Leveling Extension (which here is labeled as Leveling Extension 46-M2) is attached so that its top-surface is level with the “resting surfaces for the Transmission Belt Teeth of its Non-Torque Transmitting Member Section (which here is labeled as Non-Torque Transmitting Member Section 46-M1)”; c) its Leveling Extension has Reinforcement Wires 45, so that the Neutral-Axis of said Leveling Extension is almost equal across its width; and d) its Leveling Extension has a Member Width Clearance Support 46-M2-S1.

The purposes of modifications a) to d) of the previous paragraph are identical to the purposes of modifications a) to d) for Torque Transmitting Member 43; as such details regarding modifications a) to d) provided previously for Torque Transmitting Member 43, are also applicable for Non-Torque Transmitting Member 46.

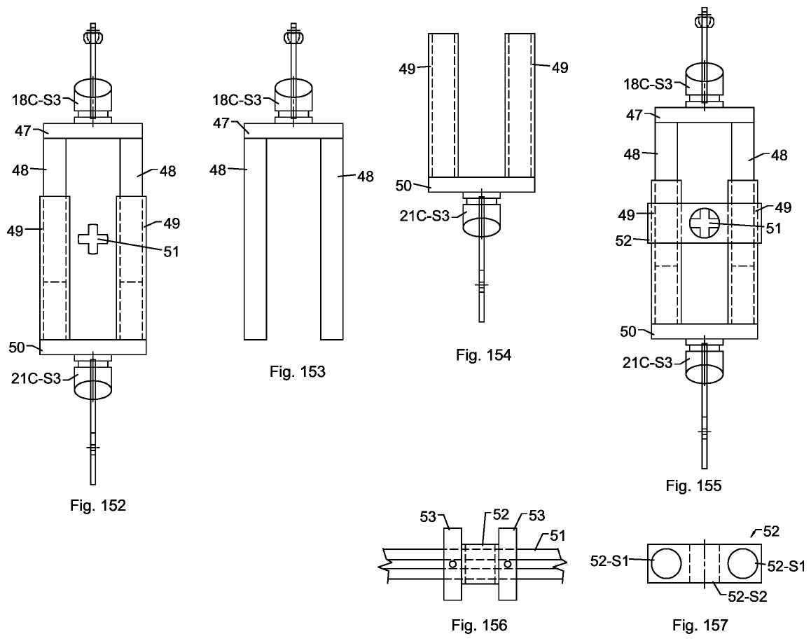

### Slider Rods and Insertion Sleeves for Maintaining the Normality and the Axial Position of Two Oppositely Positioned Locking Ring Pins (FIGS. 152 to 157)

In order to maintain the normality of two oppositely position Locking Ring Pins, at least one Slider Rod can be attached to one Locking Ring Pin; and at least one Insertion Sleeve, into which said Slider Rod will be inserted, can be attached to the oppositely position Locking Ring Pin. The Slider Rod and Insertion Sleeve should be positioned so they do not interfere with the Spline of their Cone as their Reinforcement Plates are slid from one end of their Cone to the other end of their Cone.

Per the previous paragraph, FIG. 152 shows a Locking Ring Pin 18C-S3 to which a Base Plate 47 is fixed; to Base Plate 47 two Slider Rods 48 are fixed in a manner so that they do not interfere with their Spline 51. Each Slider Rod 48 slides in an Insertion Sleeve 49. Each Insertion Sleeve 49 is fixed to a Base Plate 50, which is fixed to Locking Ring Pin 21C-S3. Here Slider Rods 48 can slide in and out of their Insertion Sleeves 49 as the Transmission Diameter of their Cone is changed. FIGS. 153 and 154 shows the mentioned attachments for Locking Ring Pin 18C-S3 and Locking Ring Pin 21C-S3 before assembly.

If it is desired to fix the axial position of Insertion Sleeves 49 relative to Spline 51, then a Spline Sleeve 52 (see FIGS. 155 to 157) can be used. Spline Sleeve 52 has two Insertion Sleeve Holes 52-S1, into which Insertion Sleeves 49 can be slideably inserted. And Spline Sleeve 52 also has a Spline Hole 52-S2, into which Spline 51 can be slideably inserted. In order to fix Spline Sleeve 52 axially relative to Spline 51, Spline Sleeve 52 can be sandwiched by two Shaft Collars 53, which each has a set-screw for axially fixing it to Spline 51.

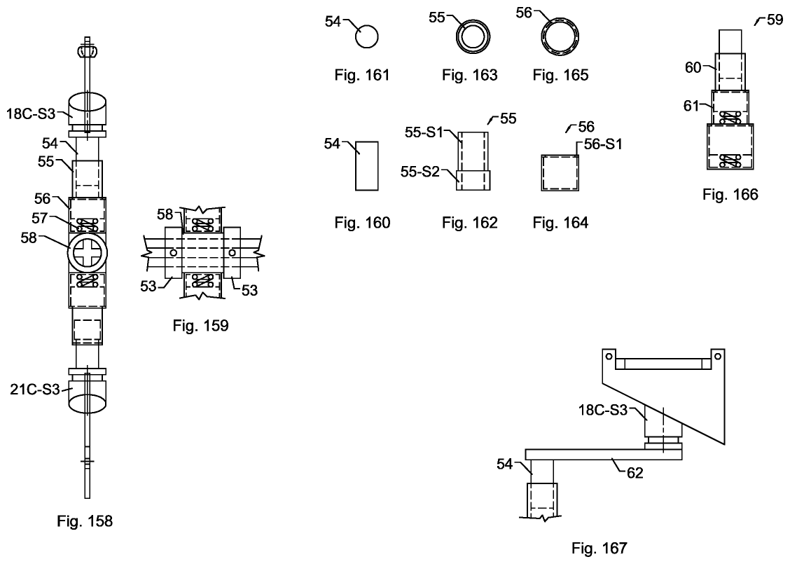

### Telescopes for Maintaining the Normality and the Axial Position of Two Oppositely Positioned Locking Ring Pins (FIGS. 158 to 167)

Another method for maintaining the normality of two oppositely position Locking Ring Pins is to use two oppositely positioned telescopes that are each fixed to a Spline Sleeve 58. The axial position of Spline Sleeve 58 relative to the Spline to which it is inserted can be fixed in the same manner that the axial position of Spline Sleeve 52 is fixed relative to its Spline, which is through two sandwiching Shaft Collars 53 (see FIG. 159).

FIG. 158 show the method of this section, here each telescope comprises of a Top Member 54 (see FIGS. 160 and 161), which is fixed to its Locking Ring Pin 18C-S3 or 21C-S3. Top Member 54 is inserted into an Intermediate Member 55. Intermediate Member 55 has a Top Shape 55-S1 and a Bottom Shape 55-S2, which has a larger diameter than Top Shape 55-S1 (see FIGS. 162 and 163). Intermediate Member 55 is inserted into Bottom Member 56 (see FIGS. 164 and 165). Bottom Member 56 has a Cover 56-S1, which has a hole which is large enough to allow Top Shape 55-S1 to slide through it, but small enough to prevent Bottom Shape 55-S2 from exiting Bottom Member 56. In order to ensure that Intermediate Member 55 does not move during the rotation of its Cone, a Spring 57, which is not absolutely required, pushes Intermediate Member 55 towards Cover 56-S1 of Bottom Member 56.

FIG. 166 shows a Telescope 59, which uses two Intermediate Members (which are Intermediate Members 60 and 61) instead of one. FIG. 166 shows that all Intermediate Members can be shaped identically (by having a Top Shape and Bottom Shape) regardless of how many Intermediate Members are used. The Top Member and the Bottom Member can also have the same shape regardless of how many Intermediate Members are used.

FIG. 167 shows a Locking Ring Pin 18C-S3 that is connected to a Top Member 54 of a Telescope through the use of an Offset Bar 62. Offset Bar 62 can be used to avoid any interferences between the “Spline Sleeve and Shaft Collars of the Telescope used for the Locking Ring Pin of the Trailing End of a Torque Transmitting Member or Non-Torque Transmitting Member”, the “Spline Sleeve and Shaft Collars of the Telescope used for the Locking Ring Pin of the Trailing End of the Leveling Extension of said Torque Transmitting Member or Non-Torque Transmitting Member”, and the “Spline Sleeve and Shaft Collars of Leading End Torque Transmitting Member Reinforcement Plate 63 or Leading End Non-Torque Transmitting Member Reinforcement Plate 67 of said Torque Transmitting Member or Non-Torque Transmitting Member.

Note, since the axial position of the “Trailing End of a Leveling Extension” is also maintained by its Torque Transmitting Member or Non-Torque Transmitting Member, Shaft Collars for maintaining the axial position of the Spline Sleeve for the “Trailing End of a Leveling Extension” is optional, but preferred to help ensure the straightness of its Torque Transmitting Member or Non-Torque Transmitting Member.

Also Offset Bar 62 and Top Member 54 of a Telescope can be fixed to its Locking Ring Pin through gluing, screwed-connection, etc.

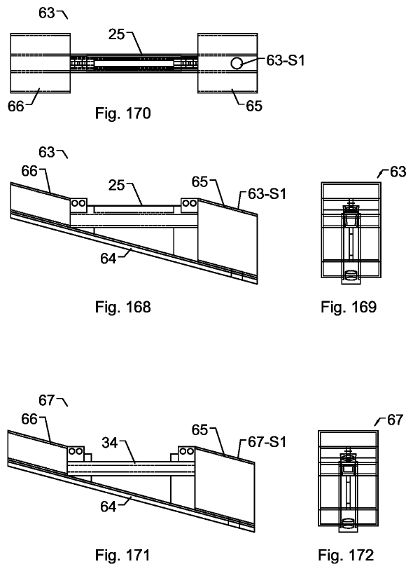

### “Leading End Torque Transmitting Member Reinforcement Plate 63” and “Leading End Non-Torque Transmitting Member Reinforcement Plate 67” (FIGS. 168 to 176)

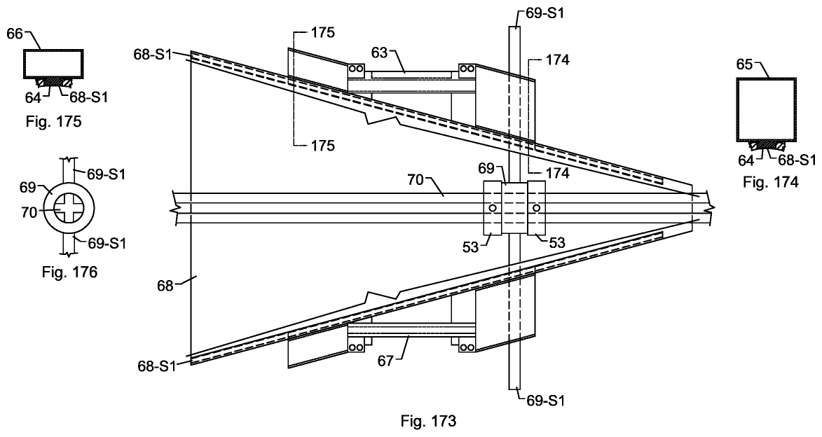

A “Leading End Torque Transmitting Member Reinforcement Plate 63” is shown in FIGS. 168 to 170, it comprises of a “Reinforcement Plate 25” to which a Slider Base 64 is attached to the base of its Right Leg 25-S3, and Left Leg 25-S4 (see FIG. 107). Slider Base 64 slides in a Slotted Cut 68-S1 of its Cone 68 (see FIGS. 173 to 175), and the engagement between Slider Base 64 and Slotted Cut 68-S1 is used to transfer torque from “Leading End Torque Transmitting Member Reinforcement Plate 63” to Cone 68.

In order to increase the “rotational resistance” to supplement the “bending resistance” of Slider Base 64 to resist the moment due to the tension of its Transmission Belt, Slider Base 64 extends to the right and to the left of its “Reinforcement Plate 25”. Because of the taper of its Cone 68, increasing the length of Slider Base 64 will also increase the height difference between the lowest point and highest point of Slider Base 64, which in turn will increase the “rotational resistance” of Slider Base 64. A Reinforcement Tube 66 is used to strengthen the extension of Slider Base 64 to the left of “Reinforcement Plate 25”; and a Reinforcement Tube 65 is used to strengthen the extension of Slider Base 64 to the right of “Reinforcement Plate 25”.

In order to maintain the axial position of “Leading End Torque Transmitting Member Reinforcement Plate 63” relative to its Spline 70 (see FIG. 173), “Leading End Torque Transmitting Member Reinforcement Plate 63” has a Hole 63-S1, which extends all the way through from the top-surface of its Reinforcement Tube 65 to the bottom surface of its Slider Base 64.

A “Leading End Non-Torque Transmitting Member Reinforcement Plate 67” is shown in FIGS. 171 to 172, it comprises of a “Reinforcement Plate 34” to which a Slider Base 64 is attached to the base of its Left Leg 34-S4 and Right Leg 34-S3 (see FIG. 123). Slider Base 64 slides in a Slotted Cut 68-S1 of its Cone 68 (see FIG. 173). Like for “Leading End Torque Transmitting Member Reinforcement Plate 63”, for “Leading End Non-Torque Transmitting Member Reinforcement Plate 67” a Reinforcement Tube 66 is also used to strengthen the extension of Slider Base 64 to the left of “Reinforcement Plate 34”; and a Reinforcement Tube 65 is also used to strengthen the extension of Slider Base 64 to the right of “Reinforcement Plate 34”.

And like for “Leading End Torque Transmitting Member Reinforcement Plate 63”, in order to maintain the axial position of “Leading End Non-Torque Transmitting Member Reinforcement Plate 67” relative to its Spline 70 (see FIG. 173), “Leading End Non-Torque Transmitting Member Reinforcement Plate 67” has a Hole 67-S1, which extends all the way through from the top-surface of its Reinforcement Tube 65 to the bottom surface of its Slider Base 64.

FIGS. 173 to 175 show how “Leading End Torque Transmitting Member Reinforcement Plate 63” and “Leading End Non-Torque Transmitting Member Reinforcement Plate 67” are secured to their Cone 68 by inserting them into two opposite Slotted Cuts 68-S1.

FIGS. 173 and 176 show a Spline Sleeve 69, which is inserted into Spline 70. Spline Sleeve 69 has two oppositely positioned Rods 69-S1. One Rod 69-S1 is inserted into Hole 63-S1 of “Leading End Torque Transmitting Member Reinforcement Plate 63”, so that it can control the axial position of “Leading End Torque Transmitting Member Reinforcement Plate 63”. And the other Rod 69-S1 is inserted into Hole 67-S1 of “Leading End Non-Torque Transmitting Member Reinforcement Plate 67”, so that it can control the axial position of “Leading End Non-Torque Transmitting Member Reinforcement Plate 67”.

The axial position of Spline Sleeve 69 relative to its Spline 70 can be fixed in the same manner that the axial position of Spline Sleeve 52 is fixed relative to its Spline, which is through two sandwiching Shaft Collars 53.

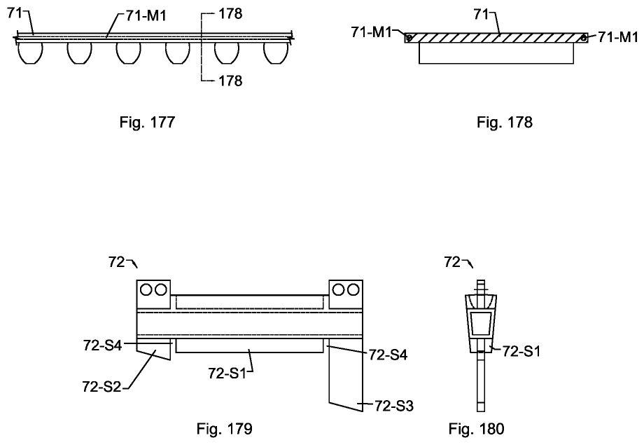

### Reinforcement Plate 72 for a Flanged Leveling Extension (FIGS. 177 to 180)

Described in this section is a Reinforcement Plate 72 that can be used with a Flanged Leveling Extension. The flanges of a Flanged Leveling Extension can be used to provide additional resting support for a Flanged Transmission Belt. Here bending of the flanges of a Flanged Transmission Belt is resisted by the longitudinal-tension in the flanges of said Flanged Transmission Belt, since bending of said flanges will increase the diameter of said flanges relative to the diameter of the other portion of said Flanged Transmission Belt. As such, it is recommended that the flanges of a Flanged Transmission Belt have reinforcement wires. FIGS. 177 and 178 show a Flanged Transmission Belt 71, for which its flanges each have a Reinforcement Wire 71-M1.

FIGS. 179 and 180 show a Reinforcement Plate 72, which is identical to Reinforcement Plate 25 described earlier, except that it has a Bottom Extension 72-S1, and its Left Leg and Right Leg (which are labeled as Left Leg 72-S2 and Right Leg 72-S3) are longer. These modification are made so that two Side Channels 72-S4 are shaped as shown. Side Channels 72-S4 are used for the insertion of Leveling Extension Flange Supports 75-S2, described below.

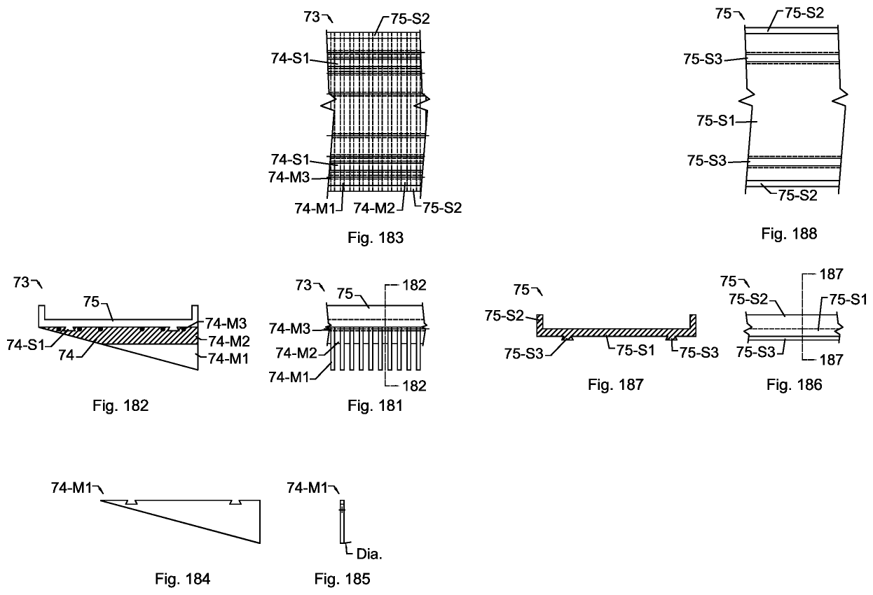

### Flanged Leveling Extension—Leveling Extension 73 (FIGS. 181 to 188)

A Leveling Extension 73 that can be used with Reinforcement Plate 72 is shown in FIGS. 181 to 183. It comprises of a Leveling Extension Base 74, which sits on the surface of its Cone; and Transmission Belt Rest 75, which sits on top of Leveling Extension Base 74.

Leveling Extension Base 74 comprises of Supporting Plates 74-M1 that are joined by Elastomer Members 74-M2, which are bonded to Supporting Plates 74-M1. Supporting Plates 74-M1 are also joined together by Reinforcement Wires 74-M3, which are bonded to Supporting Plates 74-M1. This setup is selected so that some sufficient resistance that “maintains the substantial normality of Supporting Plates 74-M1 relative to their Leveling Extension Base 74” is provided when an axial-bending-moment is applied to the Supporting Plates 74-M1.

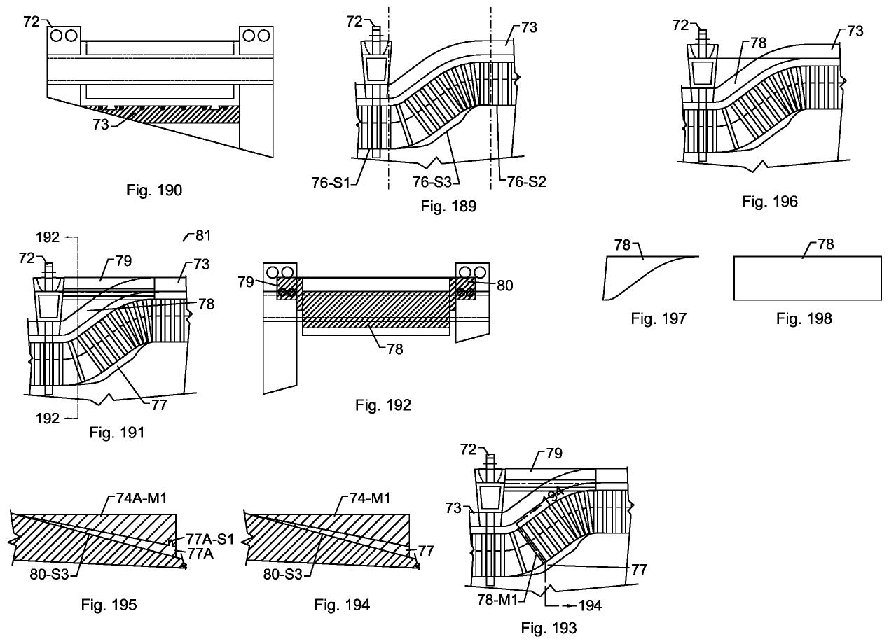

A Supporting Plate 74-M1 is shown in FIGS. 184 and 185. The bottom surface of a Supporting Plate 74-M1 is rounded (refer to “Dia.” label in FIG. 185); this is so that the Supporting Plates 74-M1 can smoothly slide up their Ramp Surface 76-S3 (see FIG. 189), which has a section that has a concave surface. Ideally the diameter of the bottom surface of the Supporting Plates 74-M1 should be smaller than the diameter of the concave surface of Ramp Surface 76-S3, but as large as possible in order to minimize Hertzian contact stresses.

Transmission Belt Rest 75 of Leveling Extension 73, which is also shown separately in FIGS. 186 to 188, should be made out of a flexible elastomer. It has two Leveling Extension Flange Supports 75-S2 that are joined by a Base 75-S1 (see FIGS. 186 to 188). And in order to maintain the alignment of Leveling Extension Base 74 relative to Transmission Belt Rest 75, and prevent Transmission Belt Rest 75 from separating from Leveling Extension Base 74, Base 75-S1 has Protrusions 75-S3 that are inserted into matching Indentations 74-S1 of Leveling Extension Base 74. Indentations 74-S1 are shaped into both, Supporting Plates 74-M1 and Elastomer Members 74-M2 of Leveling Extension Base 74.

### Leveling Extension Ramp Guide 81

Described in in this section is a Leveling Extension Ramp Guide 81 that guides a Leveling Extension from a Base Surface 76-S1 of a Cone 76 to a Raised Surface 76-S2 of said Cone 76. Between Base Surface 76-S1 and Raised Surface 76-S2, a Ramp Surface 76-S3 is shaped. Cone 76 is shown in FIG. 214; and Base Surface 76-S1, Raised Surface 76-S2, and Ramp Surface 76-S3 are shown in FIG. 189. In FIG. 189, vertical dash-dot lines are used to show the partition between the surfaces of Cone 76. And in FIG. 189, the surfaces of Cone 76 have an infinite diameter (straight surface), because of time limitations.

Cone 76 and the Leveling Extension Ramp Guide 81 of this section can be used with a Torque Transmitting Member 43 and a Non-Torque Transmitting Member 46, for which each their Leveling Extension Ramp 44 have been removed.

Leveling Extension Ramp Guide 81 comprises of the following parts: a Ramp Leveling Base 77, a Ramp Tooth Resting Filler 78, a Left Flange Filler 79, and a Right Flange Filler 80. All parts of said Leveling Extension Ramp Guide 81 should be made out of a flexible elastomer. Note for clarity, Ramp Tooth Resting Filler 78, Left Flange Filler 79, and Right Flange Filler 80 are not shown in FIG. 189; but these parts, as well as all other parts of Leveling Extension Ramp Guide 81 are shown in either or both FIGS. 191 and 192.

Ramp Leveling Base 77 (see FIGS. 193 and 194) is used to provide a resting base for the Supporting Plates 74-M1 of Leveling Extension 73 that are positioned at an angle (not Normal) relative to the conical surfaces of Cone 76. Positioning a Supporting Plate 74-M1 at an angle relative to the conical surfaces of its Cone 76, as required for the Supporting Plates 74-M1 that are positioned on Ramp Surface 76-S3, changes the taper of the bottom surface of said Supporting Plates 74-M1; while for continuity, the taper of Ramp Surface 76-S3 should match the taper of Base Surface 76-S1 and the taper of Raised Surface 76-S2 (which are both conical surfaces of Cone 76). In order to compensate for the difference in taper between “the bottom surfaces of the Supporting Plates 74-M1 that are positioned on Ramp Surface 76-S3” and “the surface of Ramp Surface 76-S3 they are resting on”, Ramp Leveling Base 77 is positioned between the bottom surfaces of these Supporting Plates 74-M1 and the surface of Ramp Surface 76-S3 (see FIGS. 193 and 194).

Ramp Leveling Base 77 is sheet of flexible elastomer that is resting on Ramp Surface 76-S3 and provides a level resting surface for all Supporting Plates 74-M1 that are positioned at an angle (not Normal) relative to the conical surfaces of Cone 76. The shape of Ramp Leveling Base 77 can be easily determined by experimentation and/or mathematics.

The radial position and radial alignment of Ramp Leveling Base 77 are constraint by the end surfaces of Ramp Surface 76-S3 (see vertical dash-dot lines of FIG. 189). The axial alignment of Ramp Leveling Base 77 relative to the bottom surfaces of its Supporting Plates 74-M1 can be constrained by the friction between “the engaging surfaces of Ramp Leveling Base 77” and “the bottom surfaces of its Supporting Plates 74-M1”; or alternately and preferably through the engagement of a Protrusion 77A-S1 of a Ramp Leveling Base 77A with complementary indentations of Supporting Plates 74A-M1 (see FIG. 195).

The Transmission Belt resting surfaces of a “section of a Leveling Extension 73 that is resting on Ramp Surface 76-S3” are not providing a proper resting place for its Transmission Belt. In order to fix this, a Ramp Tooth Resting Filler 78, a Left Flange Filler 79, and a Right Flange Filler 80 are used.

Ramp Tooth Resting Filler 78 (see FIGS. 191, 192, and 196) is bonded/glued to the front end of its Leading End Torque Transmitting Member Reinforcement Plate (in FIGS. 191, 192, and 196; a Reinforcement Plate 72 is used as the Leading End Torque Transmitting Member Reinforcement Plate; in order to be able to transmit torque, and in order to maintain and control its axial position, the relevant items of Leading End Torque Transmitting Member Reinforcement Plate 63 can be added to Reinforcement Plate 72).

Ramp Tooth Resting Filler 78 (see FIGS. 197 and 198) is an elastomer/flexible member that is shaped so that its top surface provides a proper resting place for the teeth of its Transmission Belt, while its bottom surface is resting on top of its Leveling Extension 73. The ideal/acceptable shape of Ramp Tooth Resting Filler 78 can be easily determined by experimentation and/or mathematics.

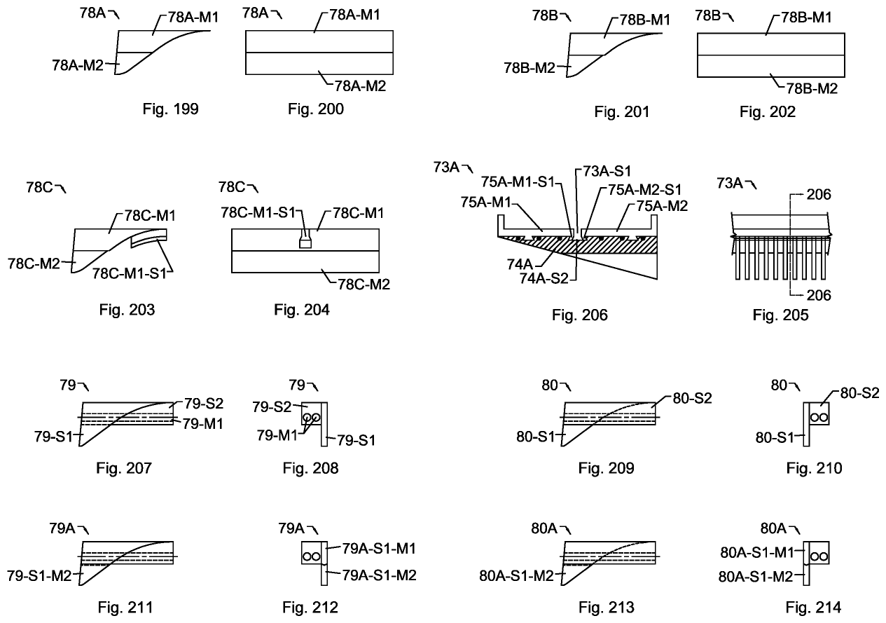

The rear-end of Ramp Tooth Resting Filler 78 has some considerable thickness, which affects the bending flexibility of Ramp Tooth Resting Filler 78. It is desirable to use a stiff elastomer for Ramp Tooth Resting Filler 78, in order to minimize “the deflection of the surface of Ramp Tooth Resting Filler 78 that is supporting the teeth of a Transmission Belt” due to the load applied by said teeth. A thinner Ramp Tooth Resting Filler 78 will allow for the usage of a stiffer elastomer, since a thinner Ramp Tooth Resting Filler 78 has more bending flexibility than a thicker elastomer. In order to allow for the usage of stiffer elastomer, a Ramp Tooth Resting Filler 78A (see FIGS. 199 and 200) can be used instead of Ramp Tooth Resting Filler 78. Ramp Tooth Resting Filler 78A is divided vertically into a Top Ramp Tooth Resting Filler Member 78A-M1 and Bottom Ramp Tooth Resting Filler Member 78A-M2. Top Ramp Tooth Resting Filler Member 78A-M1 and Bottom Ramp Tooth Resting Filler Member 78A-M2 are each thinner than Ramp Tooth Resting Filler 78, and can bend independently.

FIGS. 201 and 202 show a slightly modified Ramp Tooth Resting Filler 78A, which is labeled as Ramp Tooth Resting Filler 78B. Ramp Tooth Resting Filler 78B can also be used instead of Ramp Tooth Resting Filler 78. Ramp Tooth Resting Filler 78B is divided vertically into a Top Ramp Tooth Resting Filler Member 78B-M1 and Bottom Ramp Tooth Resting Filler Member 78B-M2. The only difference between Ramp Tooth Resting Filler 78A and Ramp Tooth Resting Filler 78B is that Bottom Ramp Tooth Resting Filler Member 78B-M2 is slightly shorter than Bottom Ramp Tooth Resting Filler Member 78A-M2; this modification might give a better fit, since the bottom half of a Ramp Tooth Resting Filler 78 has to compress (and shorten) as Ramp Tooth Resting Filler 78 is bend, and dividing Ramp Tooth Resting Filler 78 vertically and allowing each division to bend independently will force less compression on bottom said division.

FIGS. 203 and 204 show a Ramp Tooth Resting Filler 78C. Ramp Tooth Resting Filler 78C is divided vertically into a Top Ramp Tooth Resting Filler Member 78C-M1 and Bottom Ramp Tooth Resting Filler Member 78C-M2. Ramp Tooth Resting Filler 78C is identical to Ramp Tooth Resting Filler 78B, except that it has a Hook 78C-M1-S1 at the front-end of its Top Ramp Tooth Resting Filler Member 78C-M1. Hook 78C-M1-S1 is inserted into a Groove 73A-S1 of its Leveling Extension 73A (see FIG. 206); so that the front-end of Ramp Tooth Resting Filler 78C is radially fixed relative to its Leveling Extension 73A. This is necessary so that the front-end of Ramp Tooth Resting Filler 78C will not interfere with the teeth of its Transmission Belt during engagement.

Leveling Extension 73A of the previous paragraph is shown in FIGS. 205 and 206. It is basically identical to Leveling Extension 73, except that it has a Groove 73A-S1. In order to shape Groove 73A-S1 into Leveling Extension 73A, Leveling Extension 73A has the following modification over Leveling Extension 73: a) Transmission Belt Rest 75 is divided into a Left Transmission Belt Rest 75A-M1 and Right Transmission Belt Rest 75A-M2; the inner-ends of the Left Transmission Belt Rest 75A-M1 and Right Transmission Belt Rest 75A-M2 form Groove 73A-S1; and in order to prevent said inner ends from separating from their Leveling Extension Base 74A, Left Transmission Belt Rest 75A-M1 has a Hook 75A-M1-S1 and Right Transmission Belt Rest 75A-M2 has a Hook 75A-M2-S1; and b) Leveling Extension Base 74A has an additional groove, which is Groove 74A-S2, over Leveling Extension Base 74.

Left Flange Filler 79 and a Right Flange Filler 80 are bonded/glued to the front end of their Leading End Torque Transmitting Member Reinforcement Plate, see FIGS. 191 and 192 (note: in FIG. 191, a Reinforcement Plate 72 is used as the Leading End Torque Transmitting Member Reinforcement Plate).

Left Flange Filler 79 (see FIGS. 207 and 208) is an elastomer/flexible member that has Filler Shape 79-S1, which is shaped so that its top surface provides a proper/adequate resting place for a flange of its Transmission Belt, while its bottom surface is resting on top of a Leveling Extension Flange Support 75-S2 of its Leveling Extension 73. The shape of Filler Shape 79-S1 can be easily determined by experimentation and/or mathematics.

In order to provide sufficient lateral and vertical stiffness to Filler Shape 79-S1, a Stiffener Shape 79-S2 is shaped to the left of Filler Shape 79-S1 (note: here to the left means “to the left when Flange Filler 79 is viewed from the front”). Stiffener Shape 79-S2 has two Reinforcement Wires 79-M1, which can be omitted if Stiffener Shape 79-S2 can be made sufficiently stiff without said Reinforcement Wires 79-M1.

Right Flange Filler 80 (see FIGS. 209 and 210) is identical to Left Flange Filler 79, except that its Stiffener Shape 80-S2 is shaped to the right, instead of to the left, of its Filler Shape 80-S1.

For the same reason Ramp Tooth Resting Filler 78 can be divided vertically into two thinner members that can bend independently, Left Flange Filler 79 and a Right Flange Filler 80 can also each be divided vertically into two thinner members that can bend independently.

FIGS. 211 and 212 show a Left Flange Filler 79A, which is identical to Left Flange Filler 79, except that here Filler Shape 79-S1 is vertically divided into a Top Filler Shape 79A-S1-M1 and Bottom Filler Shape 79A-S1-M2. In order to maintain the alignment of Bottom Filler Shape 79A-S1-M2 relative to Top Filler Shape 79A-S1-M1, the mating surfaces of Top Filler Shape 79A-S1-M1 and Bottom Filler Shape 79A-S1-M2 have the shape of a protrusion and indentation.

FIGS. 213 and 214 show a Right Flange Filler 80A, which is identical to Right Flange Filler 80, except that here Filler Shape 80-S1 is vertically divided into a Top Filler Shape 80A-S1-M1 and Bottom Filler Shape 80A-S1-M2. In order to maintain the alignment of Bottom Filler Shape 80A-S1-M2 relative to Top Filler Shape 80A-S1-M1, the mating surfaces of Top Filler Shape 80A-S1-M1 and Bottom Filler Shape 80A-S1-M2 have the shape of a protrusion and indentation.

### Cone 76

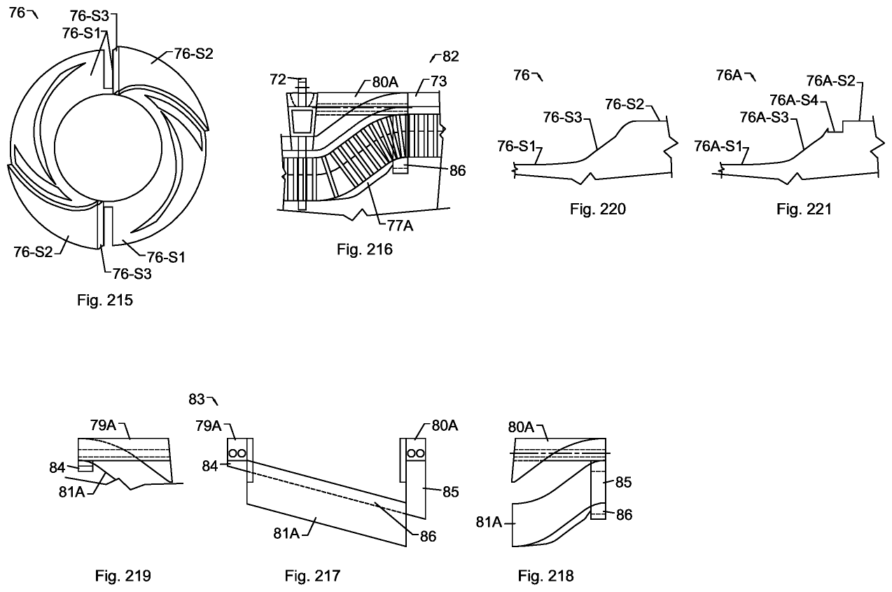

Cone 76 described in the previous section is shown in FIG. 215. Cone 76 is identical to Cone 42 described previously, except that each Leveling Extension Ramp Clearance 42-S1 is replaced with a Ramp Surface 76-S3. Base Surfaces 76-S1 are the unraised surfaces of Cone 76, which include the cuts for the Torque Transmitting Member and the Non-Torque Transmitting Member. Raised Surfaces 76-S2 are the raised surfaces of Cone 76 and correspond to Extension Raising Surfaces 42-S2 of Cone 42 (although slightly differently shaped because of Ramp Surfaces 76-S3).

### Leveling Extension Ramp Guide 82

An alternate to Leveling Extension Ramp Guide 81, which is labeled as Leveling Extension Ramp Guide 82, is shown in FIG. 216. Leveling Extension Ramp Guide 82 is identical to the Leveling Extension Ramp Guide 81 described in the previous section except that here Ramp Leveling Base 77, Left Flange Filler 79, and a Right Flange Filler 80 are replaced with a Guiding Member 83 (see FIGS. 217 to 219). Guiding Member 83 comprises of a Ramp Leveling Base 77A that is connect by “a Left Strap 84 to a Left Flange Filler 79A”, and by “a Right Strap 85 to Right Flange Filler 80A”; and a Strap Connector 86, which connects Left Strap 84 to Right Strap 85, and supports the front-end of Ramp Leveling Base 77A.

Left Flange Filler 79A is basically identical to Right Flange Filler 80; and Right Flange Filler 80A is basically identical to Left Flange Filler 79. The reason for the “left-right swap” is because in FIG. 217, Guiding Member 83 is viewed from the rear; and in FIG. 192, Reinforcement Plate 72 is viewed from the front.

For Leveling Extension Ramp Guide 82, the front-ends of Left Flange Filler 79A and Right Flange Filler 80A are held in place by either Left Strap 84 or Right Strap 85, so that they will not interfere with their Transmission Belt during re-engagement. Depending on the dimensions of the CVT, this might or might not be necessary; as can be easily be verified through experimentation.

In order to account for Strap Connectors 86, Ramp Surfaces 76-S3 of Cone 76 have to be slightly modified. Shown in FIG. 220 are all unique surfaces (unique in terms of distance from center to surface) of Cone 76, which are: Base Surface 76-S1, Raised Surface 76-S2, and Ramp Surface 76-S3. A Cone 76A, for which a section at an infinite diameter (straight surface) is shown in FIG. 221, is a slightly modified Cone 76 that accounts for Strap Connectors 86 so that it can be used for Leveling Extension Ramp Guide 82.

Cone 76A is identical to Cone 76; except that it has an Indentation 76A-S4 shaped between its Ramp Surface 76A-S3 and its Raised Surface 76A-S2. A Cone 76A, like a Cone 76, has two opposite sets of Base Surfaces 76A-S1, Raised Surface 76A-S2, and Ramp Surface 76A-S3; and as such, it also has two oppositely positioned Indentation 76A-S4. In each Indentation 76A-S4, a Strap Connector 86 is positioned.

### Improved Ramp Tooth Resting Filler—Ramp Tooth Resting Filler 78D

Ramp Surface 76-S3 (see FIGS. 189 and 215) is to be used to raise “the base surface of a conical surface” for different conical diameters (smallest transmission diameter to largest transmission diameter); note: in FIG. 187 a straight surface is shown for simplicity. In order to provide the same raising height for all conical diameters, the length of Ramp Surface 76-S3 should be the same or substantially the same for all conical diameters.

Since the length of Ramp Surface 76-S3 is the same for all conical diameters, the top surface of Ramp Tooth Resting Filler 78 has to “stretch lengthwise” more-and-more as the conical diameter where it is positioned is decreased. Since more bending will result in a larger length difference between the bottom surface and the top surface of a bended member. In order to avoid having to stretch Ramp Tooth Resting Filler 78, Ramp Tooth Resting Filler 78D can be used.

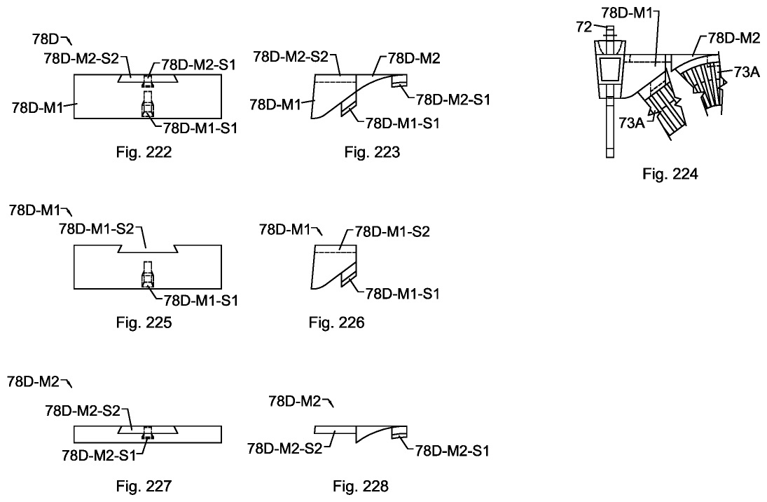

Ramp Tooth Resting Filler 78D is shown in FIGS. 222 and 223. It comprises of a Rear Member 78D-M1 (which is also shown in FIGS. 225 and 226) and a Front Member 78D-M2 (which is also shown in FIGS. 227 and 228), which can be separated lengthwise as required.

The rear-end of Rear Member 78D-M1 is fixed to its Leading End Torque Transmitting Member Reinforcement Plate (in FIG. 224, a Reinforcement Plate 72 is used as the Leading End Torque Transmitting Member Reinforcement Plate). And the front-end of Rear Member 78D-M1 is held in place through the engagement of its Hook 78D-M1-S1 with Groove 73A-S1 of its Leveling Extension 73A (see FIGS. 225, 226, 206, and 224).

The rear-end of Front Member 78D-M2 has a Tongue 78D-M2-S2 that can slide lengthwise relative to Groove 78D-M1-S2 of Rear Member 78D-M1, but cannot separate radially relative to Groove 78D-M1-S2 (see FIGS. 225 to 228). And the front-end of Front Member 78D-M2 is held in place through the engagement of its Hook 78D-M2-S1 with Groove 73A-S1 of its Leveling Extension 73A (see FIGS. 227, 228, 206, and 224).

Non-Torque Transmitting Member with Bumps

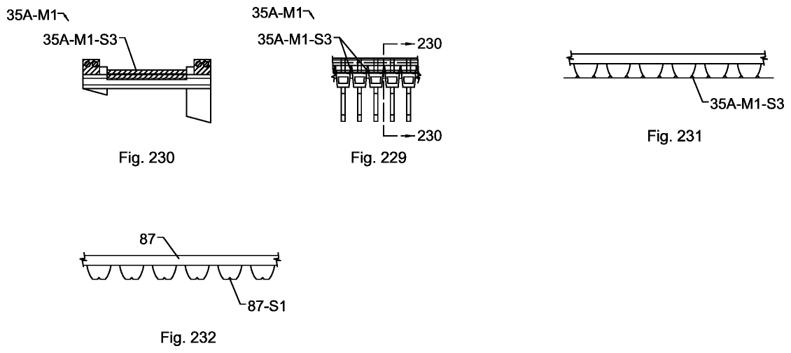

FIGS. 229 and 230 show a Non-Torque Transmitting Member Section 35A-M1; which is identical to Non-Torque Transmitting Member Section 35-M1, except that it has Bumps 35A-M1-S3. Bumps 35A-M1-S3 can be used to minimize engagement inaccuracies due to stretching of the Transmission Belt, unintended Transmission Diameter variations, etc.

If Bumps 35A-M1-S3 are used with a regular Transmission Belt than the Transmission Diameter of its Cone has to be changed in “2-teeth steps” in order to ensure that Bumps 35A-M1-S3 are properly positioned so as to help maintain the position of its Transmission Belt (see FIG. 231). If it is desired to change the Transmission Diameter of its Cone in only “1-tooth steps”, then a Transmission Belt 87 shown in FIG. 232 can be used. Transmission Belt 87 has Cuts 87-S1 for Bumps 35A-M1-S3.

Non-Torque Transmitting Member Section 35A-M1 is preferably used in a CVT for which the tension in its Transmission Belts are reduced during Transmission Diameter change, such as a CVT 6 of U.S. Pat. No. 9,651,123.

### Method for Extending the Transmission Ratio

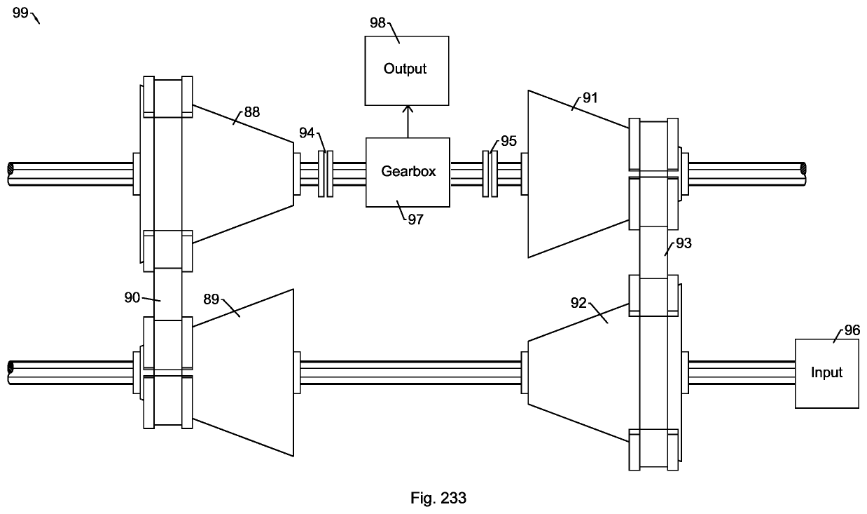

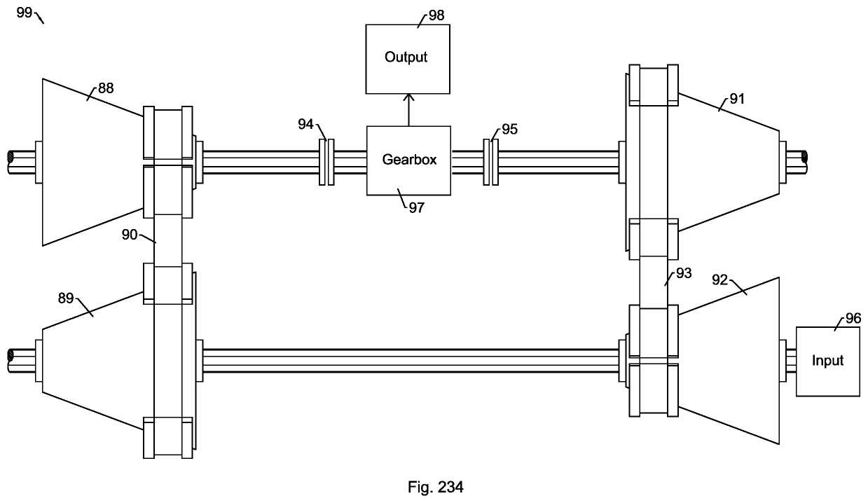

FIGS. 233 and 234 show a Transmission 99 that uses two CVTs that are coupled directly or indirectly to a common Input Spline, which is connected to Input 96. The Output Spline of each CVT is engaged or disengaged through either Clutch 94 or Clutch 95 with a Gearbox 97; only one CVT is engaged with Gearbox 97 at a time. Gearbox 97 is then connected to the Output 98 of Transmission 99. If desired the input and outpu t can be reversed.

For Transmission 99, one CVT comprises of a Cone 88 that is coupled by a Transmission Belt 90 to a Cone 89. And the other CVT comprises of a Cone 91 that is coupled by a Transmission Belt 93 to a Cone 92. Here the apex of the cones on the Input Spline point in the same direction, and the apex of the cones on the Output Splines also point in the same direction.

For Transmission 99, in order to ensure that the Transmission Ratio of one CVT can be extended by the other CVT, the Transmission Belts of the CVTs move in opposite directions relative to their cones. So that when one CVT is at its largest Transmission Ratio, the other CVT is at its smallest Transmission Ratio and vice-versa. Through this configuration, the gearbox through its gearing can be used to extend the Transmission Ratio, by changing the direction the Transmission Belts are moved and switching to the currently not engaged CVT when one CVT has reached its end (maximum or minimum Transmission Ratio).

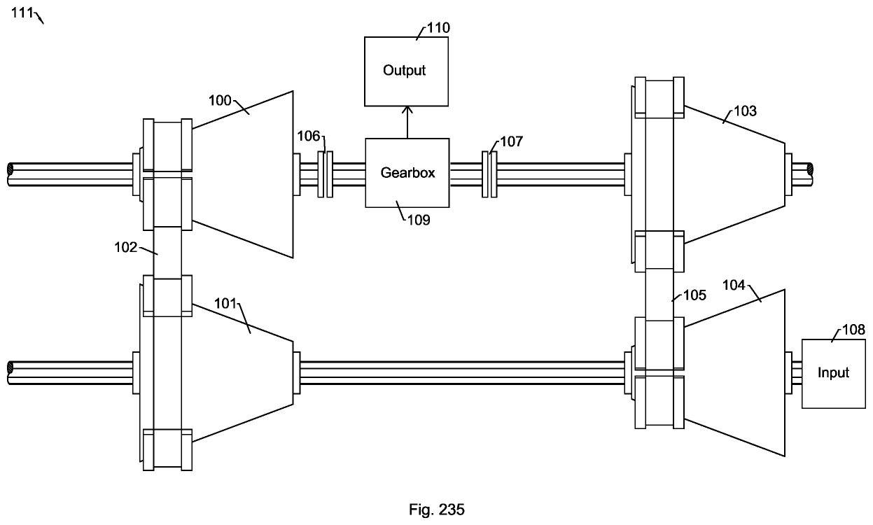

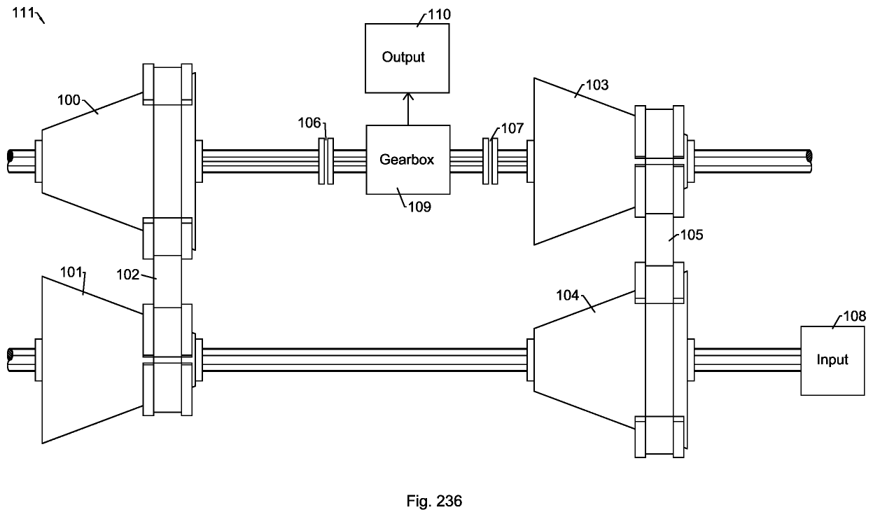

FIGS. 235 and 236 show a Transmission 111 that uses two CVTs that are coupled directly or indirectly to a common Input Spline, which is connected to Input 108. The Output Spline of each CVT is engaged or disengaged through either Clutch 106 or Clutch 107 with a Gearbox 109; only one CVT is engaged with the Gearbox 109 at a time. The Gearbox 109 is then connected to the Output 110 of Transmission 111. If desired the input and output can be reversed.

For Transmission 111, one CVT comprises of a Cone 100 that is coupled by a Transmission Belt 102 to a Cone 101. And the other CVT comprises of a Cone 103 that is coupled by a Transmission Belt 105 to a Cone 104. Here the apex of the cones on the Input Spline point in opposite directions, and the apex of the cones on the Output Splines also point in opposite directions.

For Transmission 111, in order to ensure that the Transmission Ratio of one CVT can be extended by the other CVT, the Transmission Belts of the CVTs move in the same direction relative to their cones. So that when one CVT is at its largest Transmission Ratio, the other CVT is at its smallest Transmission Ratio and vice-versa. Through this configuration, the gearbox through its gearing can be used to extend the Transmission Ratio, by changing the direction the Transmission Belts are moved and switching to the currently not engaged CVT when one CVT has reached its end (maximum or minimum Transmission Ratio).

### Preferred Embodiment of the Invention (Best Mode)

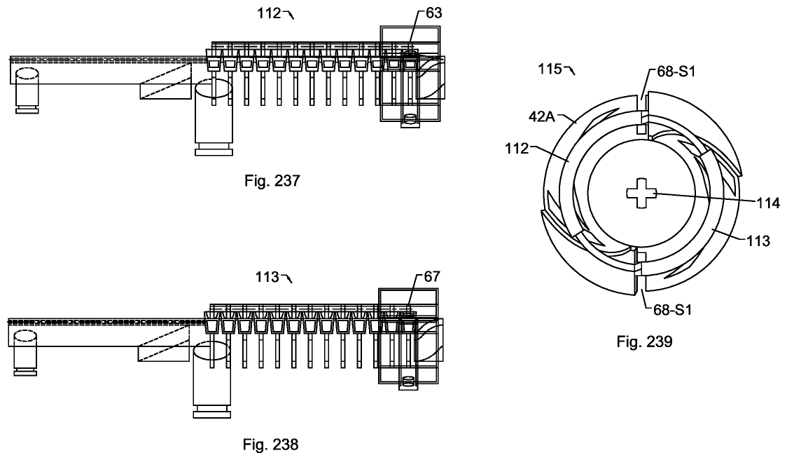

The preferred Torque Transmitting Member of the invention is a Torque Transmitting Member 112, which is shown in FIG. 237. Torque Transmitting Member 112 is identical to Torque Transmitting Member 43 (see FIGS. 143 to 145); except that for Torque Transmitting Member 112, Leading End Reinforcement Plate 25A is replaced with “Leading End Torque Transmitting Member Reinforcement Plate 63”.

The preferred Non-Torque Transmitting Member of the invention is a Non-Torque Transmitting Member 113, which is shown in FIG. 238. Non-Torque Transmitting Member 113 is identical to Non-Torque Transmitting Member 46 (see FIGS. 149 to 151); except that for Non-Torque Transmitting Member 113, Leading End Reinforcement Plate 34A is replaced with “Leading End Non-Torque Transmitting Member Reinforcement Plate 67”.

The preferred Cone Assembly of the invention is a Cone Assembly 115, which is shown in FIG. 239. Cone Assembly 115 uses a Cone 42A, which is identical to Cone 42 (see FIG. 142), except that: a) its Torque Transmitting Member Leading End Cut 24-A1 and its Non-Torque Transmitting Member Leading End Cut 24-B1 (see FIG. 106) are each replaced with a Slotted Cut 68-S1 (see FIGS. 173 to 175); and that b) Cone 42A has a Spline Profile 114, which is used to transfer torque from Cone 42A to its Spline.

Attached to Cone 42A are a Torque Transmitting Member 112 and a Non-Torque Transmitting Member 113. The axial position relative to their Spline and the normality of the Trailing End Locking Ring Pins of Torque Transmitting Member 112, Non-Torque Transmitting Member 113, and their Leveling Extensions are each maintained using Telescopes, Slider Sleeves, and sandwiching Shaft Collars as described in the “Telescopes for maintaining the normality and the axial position of two oppositely positioned Locking Ring Pins” section.

“Leading End Torque Transmitting Member Reinforcement Plate 63” of Torque Transmitting Member 112, and “Leading End Non-Torque Transmitting Member Reinforcement Plate 67” of Non-Torque Transmitting Member 113 are each inserted into a Slotted Cut 68-S1 of its Cone 42A. And the axial position of “Leading End Torque Transmitting Member Reinforcement Plate 63” of Torque Transmitting Member 83 and

“Leading End Non-Torque Transmitting Member Reinforcement Plate 67” of Non-Torque Transmitting Member 84, relative to their Spline, are maintained by a Spline Sleeve 69 and sandwiching Shaft Collars 53 as described in the “Leading End Torque Transmitting Member Reinforcement Plate 63” and “Leading End Non-Torque Transmitting Member Reinforcement Plate 67” section.

The Transmission Diameter of Cone Assembly 115 is changed by changing the axial position of its Cone 42A relative to its Spline, which also changes the axial position of Cone 42A relative to its Torque Transmitting Member 112 and Non-Torque Transmitting Member 113.

A Cone Assembly that transfers its main torque in the opposite direction of Cone Assembly 115 can be obtained by making a mirror image of Cone Assembly 115 and all its parts.

### CONCLUSION, RAMIFICATIONS, AND SCOPE

While my above description contains many specificities, these should not be construed as limitations on the scope, but rather as an exemplification of one or several embodiment(s) thereof. Many other variations are possible.

Accordingly, the scope should be determined not by the embodiment(s) illustrated, but by the appended claims and their legal equivalents.

I claim:

1. A cone for a CVT that uses commercially available transmission belts.
